(19) United States
(12) Patent Application Publication
(10) Pub. No.: US 2016/0093172 A1
(43) Pub. Date: Mar. 31, 2016

(54) GAMING MACHINE

(71) Applicants: Universal Entertainment Corporation, Tokyo (JP); Aruze Gaming America, Inc., Las Vegas, NV (US)

(72) Inventors: Kenta KITAMURA, Tokyo (JP); Hiromoto YAMAUCHI, Tokyo (JP); Susumu MIO, Tokyo (JP)

(21) Appl. No.: 14/854,206

(22) Filed: Sep. 15, 2015

(30) Foreign Application Priority Data
Sep. 25, 2014 (JP) 2014-195811

(51) Int. Cl. G07F 17/32

(52) U.S. Cl. CPC G07F 17/3286

(57) ABSTRACT

A gaming machine includes: a display device; a storage device configured to store payout data indicative of relation between symbols and payouts; a controller configured to modify a setting of the group of reel strips, at a time of the second game so that the symbol arrays used in the second game leads to a higher expectation value for a payout determined based on a single set of the payout data, as compared with the symbol arrays used in the base game; and an input device for entering a selection of selectable targets displayed on the display device, the selectable targets including a selectable target corresponding to success and a selectable target corresponding to fail. When a payout is determined in the second game and the selectable target corresponding to success is selected through the input device, the controller executes a process of upgrading the payout through a predetermined calculation.

### CROSS REFERENCE TO RELATED APPLICATION

The present application claims priority from Japanese Patent Application No. 2014-195811, which was filed on Sep. 25, 2014, the disclosure of which is herein incorporated by reference in its entirety.

### BACKGROUND OF THE INVENTION

### Field of the Invention

An example of a known slot machine is disclosed by U.S. Laid-Open Patent Application No. 2011/0250947. This slot machine operates in such a way that, when a player inserts a coin, bill or the like into an insertion slot of a slot machine and presses a spin button, symbols are scroll-displayed on a symbol display area provided on the front surface of a cabinet, and then the symbols are automatically stopped. Various prizes such as a bonus are established based on how the symbols are stopped.

In gaming machines such as the known slot machine above, when a trigger condition is established in a normal game, shifting from the normal game to a bonus game is achieved. As such, the gaming machines allow players to play highly entertaining games. In other words, providing highly entertaining games has been an important point in the gaming machines.

### BRIEF SUMMARY OF THE INVENTION

An object of the present invention is to provide a highly-entertaining gaming machine.

An aspect of the present invention is a gaming machine configured to use a group of reel strips with different symbol arrays, in a base game and a second game triggered by the base game, comprising: a display device configured to display a plurality of types of symbols arranged on the reel strips; a storage device configured to store payout data indicative of relation between symbols and payouts, which data is used for determining a payout, based on the symbols rearranged on the reel strips in the display device; a controller configured to modify a setting of the group of reel strips, at a time of the second game so that the symbol arrays used in the second game leads to a higher expectation value for a payout determined based on a single set of the payout data, as compared with the symbol arrays used in the base game; and an input device for entering a selection of selectable targets displayed on the display device, the selectable targets including a selectable target corresponding to success and a selectable target corresponding to fail, wherein, when a payout is determined in the second game and the selectable target corresponding to success is selected through the input device, the controller executes a process of upgrading the payout through a predetermined calculation.

With the above-described structure, a group of reel strips that causes a higher expectation value for the payout is used in the second game triggered by the base game. This allows use of the same set of payout data as that used in the base game for determining an initial payout which could be upgraded depending on the result of selection made for success or fail. As the result, there is realized a highly entertaining game capable of raising the expectation degree without modifying the game content itself.

Further, the gaming machine of the above aspect of the present invention may be adapted so that the second game may use a group of reel strips including a reel strip on which the same type of symbols are arranged.

With the above-described structure, a group of reel strips including a reel strip on which the same type of symbols are arranged is used in the second game. This achieves, in the gaming machine, an entertainment characteristic such that an initial payout could be upgraded, while using the same payout data used in the base game.

Further, the gaming machine of the above aspect of the present invention may be adapted so that selection of the selectable targets including the selectable target corresponding to success and the selectable target corresponding to fail is repeated a predetermined number of times, as long as the selectable target selected through the input device is the selectable target corresponding to success.

With the above-described structure, selection of the selectable targets including the selectable target corresponding to success and the selectable target corresponding to fail is repeated a predetermined number of times, as long as the selectable target selected through the input device is the selectable target corresponding to success. This achieves, in the gaming machine, an entertainment characteristic such that a payout could be further upgraded.

The present invention realizes a highly entertaining game.

### BRIEF DESCRIPTION OF THE SEVERAL VIEWS OF THE DRAWING

FIG. 1 is an explanatory diagram of a gaming machine.

FIG. 2 is an explanatory diagram showing a function flow of the gaming machine.

FIG. 3 is a perspective view of a slot machine in the gaming machine.

FIG. 4 is an electrical block diagram of the gaming machine.

FIG. 5 is an explanatory diagram of an LED data table.

FIG. 6 is an explanatory diagram of a spin table.

FIG. 7A is an explanatory diagram of a symbol table.

FIG. 7B is an explanatory diagram of a symbol table.

FIG. 8 is an explanatory diagram of a symbol table.

FIG. 9A is an explanatory diagram of a symbol table.

FIG. 9B is an explanatory diagram of a symbol table.

FIG. 10 is an explanatory diagram of a payout table.

FIG. 11 is an explanatory diagram of a wheel bonus.

FIG. 12 is an explanatory diagram of a wheel bonus random determination table.

FIG. 13 is an explanatory diagram of a generated bonus random determination table.

FIG. 14 is an explanatory diagram of a multiplying factor random determination table.

FIG. 15 is an explanatory diagram of a wild reel random determination table.

FIG. 16 is an explanatory diagram of a scattering wild random determination table.

FIG. 17 is an explanatory diagram of an additional game count random determination table.

FIG. 18 is an explanatory diagram of a wild reel random determination table.

FIG. 19 is an explanatory diagram of a scattering wild random determination table.

FIG. 20 is an explanatory diagram of a big bubble bonus payout amount random determination table.

FIG. 21A is an explanatory diagram of a repeated stroke count random determination table.

FIG. 21B is an explanatory diagram of a repeated stroke count random determination table.

FIG. 22 is an explanatory diagram of a swimming mermaid bonus payout amount random determination table.

FIG. 23 is an explanatory diagram of a sorting pattern.

FIG. 24 is an explanatory diagram of a pop-the-bubble bonus payout amount random determination table.

FIG. 25 is an explanatory diagram of a 3-choice table.

FIG. 26 is an explanatory diagram of a seashell content table.

FIG. 27 is an explanatory diagram of a mystery feature occurrence random determination table.

FIG. 28 is an explanatory diagram of a feature random determination table.

FIG. 29 is a front view of a control panel.

FIG. 30 is an explanatory diagram showing a button arrangement on the control panel.

FIG. 31 is an explanatory diagram showing a button arrangement on the control panel.

FIG. 32 is an explanatory diagram showing an operation status of the control panel.

FIG. 33 is an explanatory diagram showing an operation status of the control panel.

FIG. 34 is an explanatory diagram showing an operation status of the control panel.

FIG. 35 is an explanatory diagram showing an operation status of the control panel.

FIG. 36 is an explanatory diagram showing an operation status of the control panel.

FIG. 37 is an explanatory diagram showing an operation status of the control panel.

FIG. 38 is an explanatory diagram showing an operation status of the control panel.

FIG. 39 is an explanatory diagram showing an operation status of the control panel.

FIG. 40 is an explanatory diagram showing an operation status of the control panel.

FIG. 41 is an explanatory diagram showing an operation status of the control panel.

FIG. 42 is an explanatory diagram showing an operation status of the control panel.

FIG. 43 is an explanatory diagram showing an operation status of the control panel.

FIG. 44 is an explanatory diagram showing an operation status of the control panel.

FIG. 45 is an explanatory diagram showing an operation status of the control panel.

FIG. 46 is an explanatory diagram showing an operation status of the control panel.

FIG. 47 is an explanatory diagram showing an operation status of the control panel.

FIG. 48 is an explanatory diagram showing an operation status of the control panel.

FIG. 49 is an explanatory diagram showing an operation status of the control panel.

FIG. 50 is an explanatory diagram of a game screen.

FIG. 51 is an explanatory diagram of a game screen.

FIG. 52 is an explanatory diagram showing how the reels are decelerated.

FIG. 53 is an explanatory diagram of bet lines.

FIG. 54 is an explanatory diagram of a bet line box.

FIG. 55 is an explanatory diagram showing a relation between a reel position and a reel segment number.

FIG. 56 is an explanatory diagram showing a relation between a payline number and each reel.

FIG. 57 is an explanatory diagram of bet lines.

FIG. 58 is an explanatory diagram of bet lines.

FIG. 59 is an explanatory diagram of reels on a game screen.

FIG. 60 is an explanatory diagram of reels on a game screen.

FIG. 61 is an explanatory diagram of reels on a game screen.

FIG. 62 is an explanatory diagram of a game screen.

FIG. 63 is an explanatory diagram of a game screen.

FIG. 64 is an explanatory diagram of a game screen.

FIG. 65 is an explanatory diagram of a win meter.

FIG. 66 is an explanatory diagram of a table indicating a bet multiplying factor and the number of seconds.

FIG. 67 is an explanatory diagram of a system font area.

FIG. 68A is an explanatory diagram of a language switching touch button.

FIG. 68B is an explanatory diagram of a language switching touch button.

FIG. 68C is an explanatory diagram of a language switching touch button.

FIG. 68D is an explanatory diagram of a language switching touch button.

FIG. 68E is an explanatory diagram of a language switching touch button.

FIG. 68F is an explanatory diagram of a language switching touch button.

FIG. 68G is an explanatory diagram of a language switching touch button.

FIG. 68H is an explanatory diagram of a language switching touch button.

FIG. 69 is an explanatory diagram showing the lighting state of the language switching touch button.

FIG. 70 is an explanatory diagram of the language switching touch button.

FIG. 71 is an explanatory diagram of a sound volume switching touch button.

FIG. 72 is an explanatory diagram of an audit screen.

FIG. 73 is an explanatory diagram of an audit screen.

FIG. 74 is an explanatory diagram of an audit screen.

FIG. 75 is an explanatory diagram of a display language.

FIG. 76 is an explanatory diagram of an audit screen.

FIG. 77 is an explanatory diagram of a help screen.

FIG. 78 is an explanatory diagram of a help screen.

FIG. 79 is an explanatory diagram showing a relationship between the control panel and the buttons.

FIG. 80 is an explanatory diagram of the control panel.

FIG. 81 is an explanatory diagram of a payout table in the help screen.

FIG. 82 is an explanatory diagram of a time of starting the wheel bonus.

FIG. 83 is an explanatory diagram of a time of starting the wheel bonus.

FIG. 84 is an explanatory diagram of a time of starting the wheel bonus.

FIG. 85 is an explanatory diagram of a fixed payout bonus.

FIG. 86 is an explanatory diagram of a mermaid dream bonus.

FIG. 87 is an explanatory diagram of a mermaid dream bonus.

FIG. 88 is an explanatory diagram of a mermaid dream bonus.

FIG. 89 is an explanatory diagram of a mermaid dream bonus.

FIG. 90 is an explanatory diagram of a mermaid dream bonus.

FIG. 91 is an explanatory diagram of a mermaid dream bonus.

FIG. 92 is an explanatory diagram of a mermaid dream bonus.

FIG. 93 is an explanatory diagram of a mermaid dream bonus.

FIG. 94 is an explanatory diagram of a mermaid dream bonus.

FIG. 95 is an explanatory diagram of a mermaid dream bonus.

FIG. 96 is an explanatory diagram of a mystery mermaid free game.

FIG. 97 is an explanatory diagram of a mystery mermaid free game.

FIG. 98 is an explanatory diagram of a mystery mermaid free game.

FIG. 99 is an explanatory diagram of a mystery mermaid free game.

FIG. 100 is an explanatory diagram of a mystery mermaid free game.

FIG. 101 is an explanatory diagram of a mystery mermaid free game.

FIG. 102 is an explanatory diagram of a mystery mermaid free game.

FIG. 103 is an explanatory diagram of a mystery mermaid free game.

FIG. 104 is an explanatory diagram of a big bubble bonus.

FIG. 105 is an explanatory diagram of a big bubble bonus.

FIG. 106 is an explanatory diagram of a big bubble bonus.

FIG. 107 is an explanatory diagram of a big bubble bonus.

FIG. 108 is an explanatory diagram of a swimming mermaid bonus.

FIG. 109 is an explanatory diagram of a swimming mermaid bonus.

FIG. 110 is an explanatory diagram of a swimming mermaid bonus.

FIG. 111 is an explanatory diagram of a swimming mermaid bonus.

FIG. 112 is an explanatory diagram of a swimming mermaid bonus.

FIG. 113 is an explanatory diagram of a swimming mermaid bonus.

FIG. 114 is an explanatory diagram of a swimming mermaid bonus.

FIG. 115 is an explanatory diagram of a swimming mermaid bonus.

FIG. 116 is an explanatory diagram of a swimming mermaid bonus.

FIG. 117 is an explanatory diagram of a pick-the-bubble bonus.

FIG. 118 is an explanatory diagram of a pick-the-bubble bonus.

FIG. 119 is an explanatory diagram of a pick-the-bubble bonus.

FIG. 120 is an explanatory diagram of a pick-the-bubble bonus.

FIG. 121 is an explanatory diagram of a pick-the-bubble bonus.

FIG. 122 is an explanatory diagram of a pick-the-bubble bonus.

FIG. 123 is an explanatory diagram of a pick-the-bubble bonus.

FIG. 124 is an explanatory diagram of a pick-the-bubble bonus.

FIG. 125 is an explanatory diagram of a pick-the-bubble bonus.

FIG. 126 is an explanatory diagram of a seashell-pick bonus.

FIG. 127 is an explanatory diagram of a seashell-pick bonus.

FIG. 128 is an explanatory diagram of a seashell-pick bonus.

FIG. 129 is an explanatory diagram of a seashell-pick bonus.

FIG. 130 is an explanatory diagram of a seashell-pick bonus.

FIG. 131 is an explanatory diagram showing a relation among credit won, an effect, and the number of display seconds.

FIG. 132A is an explanatory diagram of a total win signboard after the free game.

FIG. 132B is an explanatory diagram of a total win signboard after the free game.

FIG. 132C is an explanatory diagram of a total win signboard after the free game.

FIG. 133 is an explanatory diagram showing a relation between each bonus and increment rate.

FIG. 134 is a flowchart of a normal game running process.

FIG. 135A is a flowchart of a wheel bonus running process.

FIG. 135B is a flowchart of a wheel bonus running process.

FIG. 136 is a flowchart of a mermaid dream bonus running process.

FIG. 137 is a flowchart of a mystery mermaid bonus running process.

FIG. 138 is a flowchart of a big bubble bonus running process.

FIG. 139 is a flowchart of a swimming mermaid bonus running process.

FIG. 140 is a flowchart of a pop-the-bubble bonus running process.

FIG. 141 is a flowchart of a seashell-pick bonus running process.

FIG. 142 is a flowchart of a mystery feature running process.

FIG. 143A is an explanatory diagram of a gamble game.

FIG. 143B is an explanatory diagram of a gamble game.

FIG. 143C is an explanatory diagram of a gamble game.

FIG. 143D is an explanatory diagram of a gamble game.

FIG. 143E is an explanatory diagram of a gamble game.

FIG. 143F is an explanatory diagram of a gamble game.

FIG. 143G is an explanatory diagram of a gamble game.

FIG. 144 is a flowchart of the gamble game.

FIG. 145 is an explanatory diagram of screens in the gamble game.

FIG. 146 is an explanatory diagram of an operation process of the gamble game.

FIG. 147 is an explanatory diagram of an operation process of the gamble game.

FIG. 148 is an explanatory diagram of an operation process of the gamble game.

FIG. 149 is an explanatory diagram of an operation process of the gamble game.

### DETAILED DESCRIPTION OF THE INVENTION

The following will describe a gaming machine of the present invention with reference to figures.

(Outline of Gaming Machine)

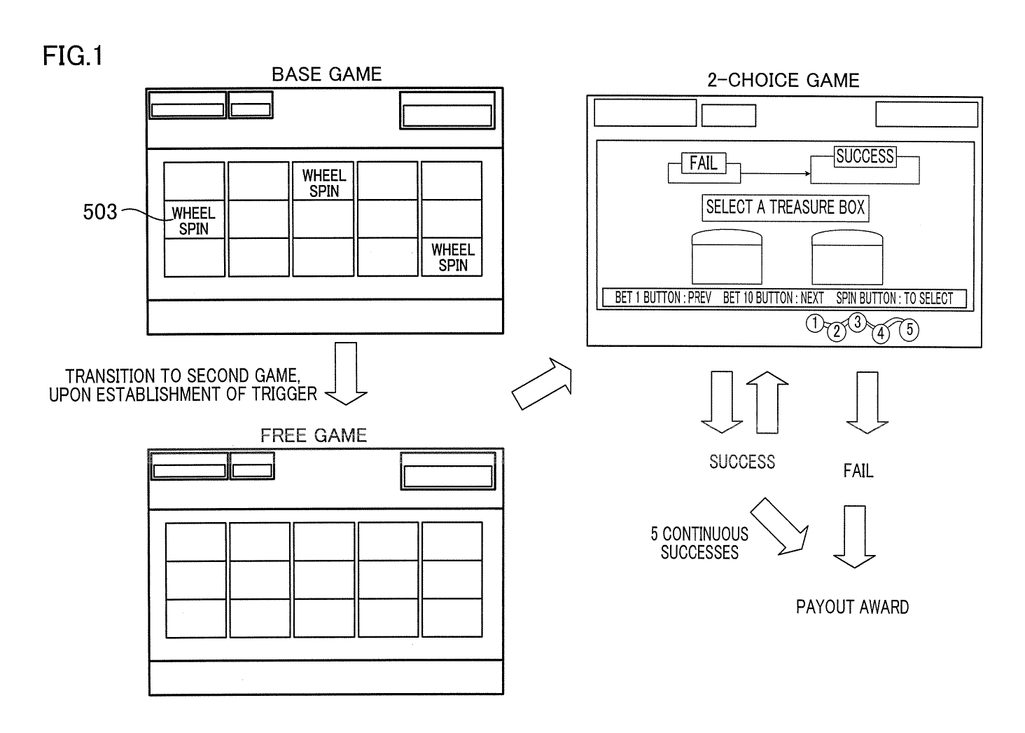

As shown in FIG. 1, a slot machine serving as a gaming machine 1 of an embodiment related to the present invention is configured to use a group of reel strips with different symbol arrays for a base game (normal game) and a second game triggered in the base game.

The slot machine includes: a lower image display panel 141 (display device) configured to display a plurality of types of symbols 502 arranged on the reel strips; a storage device configured to store payout data indicative of relation between symbols and payouts, which data is used for determining a payout, based on the symbols rearranged on the reel strips on the lower image display panel 141; a game controller configured to modify a setting of the group of reel strips, at a time of the second game so that the symbol arrays used in the second game leads to a higher expectation value for a payout determined based on a single set of the payout data, as compared with the symbol arrays used in the base game; and a touch panel 69 (input device) for entering a selection of selectable targets displayed on the lower image display panel 141, the selectable targets including a selectable target corresponding to success and a selectable target corresponding to fail,

The slot machine 1 is configured to run a base game. In the present embodiment, the base game is a slot game in which a plurality of symbols 502 are rearranged. However, the base game is not limited to this, and the base game may be any given game which is independently runnable in a gaming terminal such as a slot machine 1.

The rearrangement of the symbols in the slot game is performed on the lower image display panel 141. The slot game includes: a process of running the base game in which symbols are rearranged on a lower image display panel 141 and a normal payout according to the symbols rearranged is awarded, on condition that a bet of a gaming value is placed; and a process of making a transition to a second game, when the symbols rearranged in the base game meet a predetermined condition, i.e., when a trigger condition is met.

In the slot machine 1, the transition to the second game occurs when the trigger is established in the base game. The second game is constituted by a free game using a group of reel strips with symbol arrays different from those used in the base game, and a 2-choice game which involves making selection out of selectable targets displayed on the lower image display panel 141 including a selectable target corresponding to success, and a selectable target corresponding to fail.

The game controller is configured to modify a setting of the group of reel strips, at a time of the second game so that the symbol arrays used in the second game leads to a higher expectation value for a payout determined based on a single set of the payout data, as compared with the symbol arrays used in the base game. Specifically, the second game uses a group of reel strips including a reel strip on which only wild symbols are arranged. The slot machine 1 runs a free game once. In the free game, the group of reel strips set in the second game is used and a payout is determined by rearranging the symbols on the lower image display panel 141.

After that, the slot machine 1 runs the 2-choice game. In the 2-choice game, a selectable target corresponding to success and a selectable target corresponding to fail are displayed on the lower image display panel 141. An input for selecting one of the selectable targets is received through the touch panel 69. When the selectable target of success is selected through the touch panel 69, the game controller upgrades the payout through a predetermined calculation.

Further, when the selectable target of success is selected, the slot machine 1 runs another 2-choice game. In other words, the slot machine 1 repeats the 2-choice game a predetermined number of times, as long as the selectable target of success is selected. In the present embodiment, the predetermined number of times is five times. The 2-choice game ends when the selectable target of fail is selected, or when the selectable target of success is selected five times in a row. When the 2-choice game ends, the slot machine 1 awards the current payout.

The game controller executes the following steps of (a1) to (a6). In the step (a1), the transition to the second game occurs when the trigger condition is satisfied in the base game. The step (a2) modifies a setting of the group of reel strips, at a time of the second game so that the symbol arrays used in the second game leads to a higher expectation value for a payout determined based on a single set of the payout data, as compared with the symbol arrays used in the base game. In the step (a3), the group of reel strips set in the step (a2) is used and a payout is determined by rearranging the symbols on the lower image display panel 141. In the step (a4), a selectable target corresponding to success and a selectable target corresponding to fail are displayed on the lower image display panel 141. In the step (a5), when the selectable target of success is selected through the touch panel 69, the payout is upgraded through a predetermined calculation. The step (a6) awards the payout.

With the above-described structure, a group of reel strips that causes a higher expectation value for the payout is used in the second game triggered by the base game. This allows use of the same set of payout data as that used in the base game for determining an initial payout which could be upgraded depending on the result of selection made for success or fail. As the result, there is realized a highly entertaining game capable of raising the expectation degree without modifying the game content itself.

(Outline of Gaming Machine: Definitions)

The slot machine 1 above is a kind of gaming machine. Although the present embodiment deals with the slot machine 1 as an example of the gaming machine, the disclosure is not limited to this and any type of gaming machine configured to independently run any base game, and when a trigger condition is satisfied, causes transition to the second game and run a slot game involving a group of reel strips with symbol arrays different from those used in the base game.

The “base game” in the present embodiment is run by the slot machines 1. The base game is a slot game of rearranging a plurality of symbols. Note that the base game is not limited to slot game: The base game may be any type as long as it is independently runnable at gaming terminals such as slot machines 1. In other words, the base game is a game in contrast to the common game. For example, a normal game described later is a type of the base game.

The rearrangement of the symbols in the slot game is performed on the lower image display panel 141. The slot game includes: a process of running the normal game in which symbols are rearranged on a lower image display panel 141 and a normal payout according to the symbols rearranged is awarded, on condition that a bet of a gaming value is placed; and a process of making a transition to a bonus game including the second game, when the symbols rearranged in the normal game meet a predetermined condition, i.e., when a trigger condition is met.

Symbols are constituted by a specific symbol 503 and a normal symbol 502. In other words, “symbol” is a superordinate concept to the specific symbol 503 and the normal symbol. The specific symbol 503 includes a wild symbol 503b and a trigger symbol 503a. Each of the wild symbols 503b is a symbol substitutable for any type of symbols. Each of the trigger symbols 503a is a symbol which triggers at least a bonus game. For example, the trigger symbol 503a functions as a trigger to shift the normal game to various types of the bonus game. In the present embodiment, the trigger condition is established based on the trigger symbol 503a.

The trigger symbol 503a may function as a trigger of increase in the number of the specific symbols 503 in the bonus game, i.e., increase in the number of the specific symbols 503 of at least one of the trigger symbol 503a and the wild symbol 503b. Furthermore, the trigger symbol 503a may function as a trigger of increase in the number of times to the bonus game is run (game count). For example, the trigger symbol 503a of the present embodiment causes the establishment of the retrigger condition which triggers the increase in the number of times the free game is run (game count) in the bonus game.

The gaming value is electrically valuable information such as electronic money and the like. It is to be noted that the gaming value in the disclosure is not limited to these, and for example a game medium such as a medal, a token, a coin or the like can be adopted. Further, the ticket is not particularly limited and for example, a later-described ticket with a barcode is also used. Alternatively, the gaming value may be a game point not including valuable information.

The “bonus game” is described as the second game; however, the present invention is not limited to this, and the bonus game may be any type of game as long as it provides more advantageous gaming condition than the normal game. Other types of the bonus game may be additionally employed as long as the gaming state is advantageous for the player, i.e., the gaming state is more advantageous than that of the normal game. For example, the bonus game may be a game that provides a player with a chance of winning more gaming values than the normal game or a game that provides a player with a higher chance of winning gaming values than the normal game. Alternatively, the bonus game may be a game that consumes fewer amounts of gaming values than the normal game. In the bonus game, these games may be provided alone or in combination.

The “free game” is a game runnable with a bet of fewer gaming values than the normal game. Note that “bet of fewer amounts of gaming values” encompasses a bet of zero gaming value. The “free game” therefore may be a game runnable without a bet of a gaming value, which free game awards an amount of gaming values based on symbols rearranged. In other words, the “free game” may be a game which is started without consumption of a gaming value. To the contrary, the “normal game” is a game runnable on condition that a gaming value is bet, which normal game awards an amount of gaming value based on the symbols rearranged. In other words, the “normal game” is a game which starts with consumption of a gaming value.

The expression “rearrange” in this specification means dismissing an arrangement of symbols, and arranging symbols once again. The term “arrangement” indicates a state in which the symbols are visually recognizable by an external player. More specifically, “rearrangement” is a state in which, after the symbols on the reels are variably displayed as the reels rotate, the variable display of the symbols stops as the rotation of the reels stops, and the symbols stop in the display window.

(Functional Flow of Gaming Machine 300: Slot Machine)

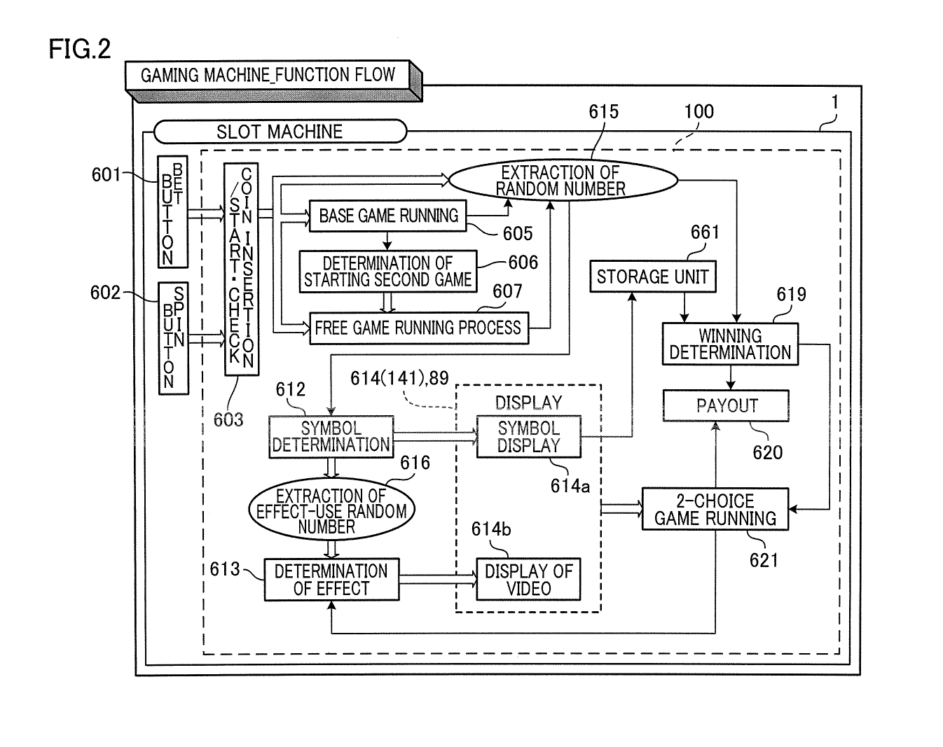

The following describes basic functions of the slot machine related to the embodiment of the present invention, with reference to FIG. 2. FIG. 2 is a diagram showing functional flow of the slot machine related to the embodiment of the present invention.

As shown in FIG. 2, the slot machine 1 includes: a bet button 601, a spin button 602, and a display 614 (lower image display panel 141 and the like of FIG. 1), and includes a game controller 100 configured to control each of these units. The BET button 601 and the spin button 602 are kinds of input devices.

The BET button 601 above has a function of receiving a bet amount input by the player. The spin button 602 has a function of receiving an instruction to start a game such as a normal game in response to an operation by the player, i.e., a start operation. The display 614 has a function of displaying still image information such as various symbols, numbers, and characters and moving image information such as effect video. Furthermore, the display 614 has a touch panel 69 as an input device, and has a function of receiving various instructions input by a pressing operation by the player. The display 614 has a symbol display region 614a and an image display region 614b. The symbol display region 614a displays a reel screen including the symbols shown in FIG. 1. The video display region 614b displays a 2-choice game involving selectable targets shown in FIG. 1. The image display region 614b displays various types of effect image information (including the common indication effect and the individual indication effect) executed during a game, by means of moving images and still images.

Although in the present embodiment, the symbol display region 614a and the image display region 614b are provided on the same screen on the lower image display panel 141, the disclosure is not limited to this arrangement.

The game controller 100 includes: a coin insertion/start-check unit 603; a normal game running unit 605; a second game start determining unit 606; a free game running unit 607; a random number sampling unit 615; a symbol determining unit 612; an effect-use random number sampling unit 616; an effect determining unit 613; a winning determining unit 619; and a payout unit 620; and a 2-choice game running unit 621.

The base game running unit 605 has a function of running a base game on condition that the bet button 601 is operated. The second game start determining unit 606 determines whether to run a second game, based on a combination of the symbols rearranged in the base game. That is to say, the second game start determining unit 606 has a function of determining that a second game is obtained when a trigger symbol 503a or the like is rearranged in a predetermined condition, and shifting the process to the free game running unit 607 so that a second game is run from the next unit game.

It is noted that “unit game” is a series of operations from the start of the receiving of a bet to a state in which an award can be established. For example, a unit game in the normal game includes a single bet time for receiving a bet, a single game time of rearranging stopped symbols, and a single payout time of a payout process of awarding a payout. Note that a unit game in a normal game is referred to as a unit normal game.

The symbol determining unit 612 has functions of: determining symbols to be rearranged with reference to a random number from the random number sampling unit 615; rearranging the determined symbols on the symbol display region 614a of the display 614; outputting rearrangement information of the symbols to the winning determining unit 619; and outputting an effect specifying signal to the effect-use random number sampling unit 616 based on the state of the rearrangement of the symbols.

The effect-use random number sampling unit 616 has a function of sampling an effect random number when receiving an effect instruction signal from the symbol determining unit 612 and a function of outputting the effect random number to the effect determining unit 613. The effect determining unit 613 has functions of: determining an effect by using the effect-use random number; outputting image information on the determined effect to the image display region 614b of the display 614; and outputting image information of selectable targets in the 2-choice game to the video display region 614b of the display 614.

The winning determining unit 619 has functions of: determining whether a winning is achieved when information on symbols rearranged and displayed on the display 614 is given; calculating an amount of payout based on a winning combination formed when it is determined that a winning has been achieved; outputting to the payout unit 620 a payout signal which is based on the payout amount; and outputting to the 2-choice game running unit 621 a payout signal which is based on the payout amount in the free game as the payout. The payout unit 620 has a function of paying out a gaming value to the player, in the form of a credit and the like.

The free game running unit 607 has a function of determining a payout, by running once the free game which requires no operation of the bet button 601.

The 2-choice game running unit 621 includes: a function to receive a payout signal as the payout of the free game from the winning determining unit 619; a function of displaying a selectable target corresponding to success and a selectable target corresponding to fail in the video display region 614b on the display 614; a function of receiving an entry of selection through the touch panel 69; a function of increasing the payout when the selectable target corresponding to success is selected; and a function of outputting a payout signal based on the payout to the payout unit 620.

In addition to the above, the slot machine 1 includes a not-shown storage unit 661 (storage device) which stores payout data. The payout data indicates the relation between the symbols and the payouts, and is for determining a payout based on the symbols rearranged on the group of reel strips, in the symbol display region 614a of the display 614. The storage unit 661 is a device capable of storing data in a rewritable manner, e.g., a hard disk device and a memory.

(Operations of Slot Machine 10)

The operations of the slot machine 1 having the functional blocks above will be described.

(Operations of Slot Machine 1)

The slot machine 1 is configured to run a base game. More specifically, to begin with, a base game process (e.g., base game) is executed. That is, a series of operations below are executed.

(Coin-Insertion/Start-Check)

First, the slot machine 1 checks whether or not a BET button 601 has been pressed by a player, and subsequently checks whether or not a spin button 602 has been pressed by the player.

(Symbol Determination)

Next, when a spin button unit 602 has been pressed by the player, the slot machine 1 extracts a random number for symbol determination, and determines symbols to be displayed for the player at the time of stopping the scroll of the symbol array, for respective video reels displayed on a display unit 614.

(Symbol Display)

Then the slot machine 1 starts the scroll of the symbol array of each video reel, and stops the scroll so that the determined symbols are displayed for the player.

(Winning Determination)

Subsequently, as the scroll of the symbol array of each video reel is stopped, the slot machine 1 determines whether the combination of the symbols displayed for the player is a combination related to winning.

(Payout)

When the combination of the symbols displayed for the player is a combination related to winning, the slot machine 1 offers, to the player, benefit according to the combination.

For example, when a combination of symbols related to a payout of coins has been displayed, the slot machine 1 pays out an amount of credit corresponding to the combination of symbols to the player.

Next, whether the trigger condition is established is determined. When the trigger is established, there will be a transition to a second game execution process. On the other hand, when the trigger is not established, the base game is run again.

(Free Game)

When the transition to the second game occurs, the slot machine 1 runs the free game once. The flow of the free game is the same as that of the base game except in that the free game does not require operation of the bet button 601 and awards no payout to the player. Further, unlike the base game, the free game uses a group of reel strips including a reel strip having only wild symbols.

(2-Choice Game)

When a payout is determined in the free game, the slot machine 1 runs a 2-choice game. First, a selectable target corresponding to success and a selectable target corresponding to fail are displayed on the display 614. An input for selecting any of the selectable targets is received by the touch panel 69.

Next, the slot machine 1 determines whether or not the selectable target of success is selected through the touch panel 69. When the selectable target of success is selected through the touch panel 69, the payout is upgraded through a predetermined calculation. Then, the 2-choice game is run for another time. In other words, the 2-choice game is repeated a predetermined number of times, as long as the selectable target of success is selected. In the present embodiment, the predetermined number of times is five times. The 2-choice game ends when the selectable target of fail is selected, or when the selectable target of success is selected five times in a row.

When the 2-choice game ends, the slot machine 1 awards the current payout to the player.

### (Mechanical Structure of Slot Machine)

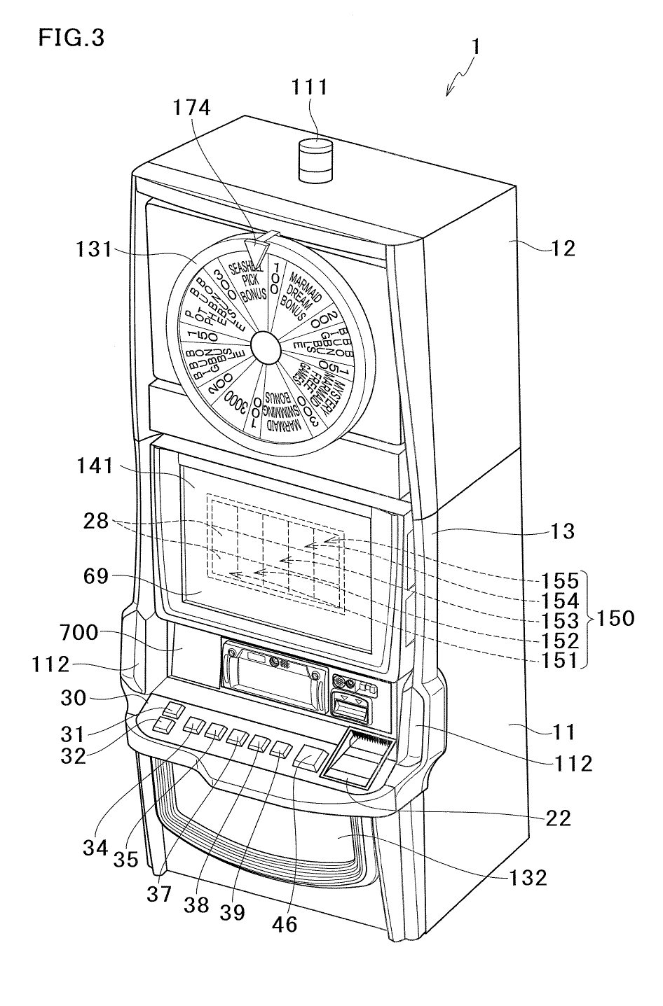

Referring to FIG. 3, the overall structure of the slot machine 1 will be described.

Electrically valuable information such as electronic money is used as a game medium in the slot machine 1. In the present embodiment, in particular, credit-related data such as cash data stored in an IC card is used.

The slot machine 1 includes a cabinet 11, a top box 12 installed on the upper side of the cabinet 11, and a main door 13 provided at the front surface of the cabinet 11.

On the main door 13, a symbol display device termed lower image display panel 141 is provided. The symbol display device is formed by a transparent liquid crystal panel. The screen displayed on the lower image display panel 141 has a display window 150 at the central portion. The display window 150 is constituted by 15 display blocks 28 forming a matrix of 5 columns and 3 rows. The three display blocks 28 of each column form pseudo reels 151 to 155. On each of the pseudo reels 151 to 155, three display blocks 28 move downward with changes in speed, so that the symbols 501 on the display blocks 28 are vertically rotated (variably displayed) and then stopped, in other words, the symbols are rearranged. The details of the display screen on the lower image display panel 141 will be given later.

While the present embodiment deals with the slot machines 1 which are so-called video slot machines, a mechanical reel may replace partially some pseudo reels 151 to 155 in the slot machines 1 of the present invention.

On the front surface of the symbol display device is provided a touch panel 69. The touch panel 69 allows a player to input various instructions by touching the display screen of the lower image display panel 141. The input signal is transmitted from the touch panel 69 to the main CPU 71.

Below the lower image display panel 141 is provided a control panel 30. The control panel 30 is provided with buttons, a bill entry 22, and the like. Details of the control panel 30 will be given later.

On the front side of the top box 12 is a rotatable disc-shaped wheel 131. A surface of the wheel 131 is parted into 16 areas. Above the wheel is a pointer 174 that points any of the areas on the wheel 131. The wheel 131 rotates when the bonus trigger is established, and stops in such a manner that the pointer 174 points an area corresponding to a type of bonus selected out of 7 types of bonuses. It should be noted that the top box 12 is configured to display a wheel 131 in the form of image.

Further, the top box 12 is provided with a lamp 111. To the main door 13 is provided a speaker 112. The slot machine 1 produces effects by displaying images, outputting sounds, and outputting the light.

On the lower front surface of the main door 13, i.e., below the control panel 30, a belly glass 132 having thereon a drawing of a character of the slot machine 1 and the like is provided. Between the lower image display panel 141 and the control panel 30, the PTS terminal 700 is attached. In the PTS terminal 700, devices having a microphone function, a camera function, a speaker function, a display function and the like form a single unit. More specifically, the PTS terminal 700 includes an LCD, a human body detection camera, a microphone, a bass reflex speaker, or the like. The human body detection camera makes it possible to detect the presence of a player by the camera function. The microphone is used for the player's participation in a game by voice and the authentication of a player by voice recognition. The speaker produces sound effects in games and outputs notification sound when an IC card is left inserted. Furthermore, the speaker outputs notification sound when an inserted IC card is not authenticated.

In addition to the above, the PTS terminal 700 is provided with an LED and a card slot. The LED emits light with plural colors to notify the remaining number of IC cards in a card stacker. The card slot has a mechanism of allowing IC cards to be inserted and ejected. The IC card has a display region. The IC card is completely inside the machine when the player is playing games, and is ejected to expose the display region at the time of the settlement. This allows the player to recognize the credit-related data such as updated cash data. Alternatively, the IC card may be arranged to expose the display portion not to be completely inserted, even when the player is playing games. This allows the player to always recognize the update of the credits during games.

When it is confirmed by the human body detection camera that no player is present at the time of the settlement of the credits, the IC card is drawn into and stored in the card stacker. With this arrangement, for example, the IC card is not left inserted for a long time, even if the player left the machine without taking the IC card after recognizing that the remaining credits on the display portion are small.

(Electrical Structure of Slot Machine)

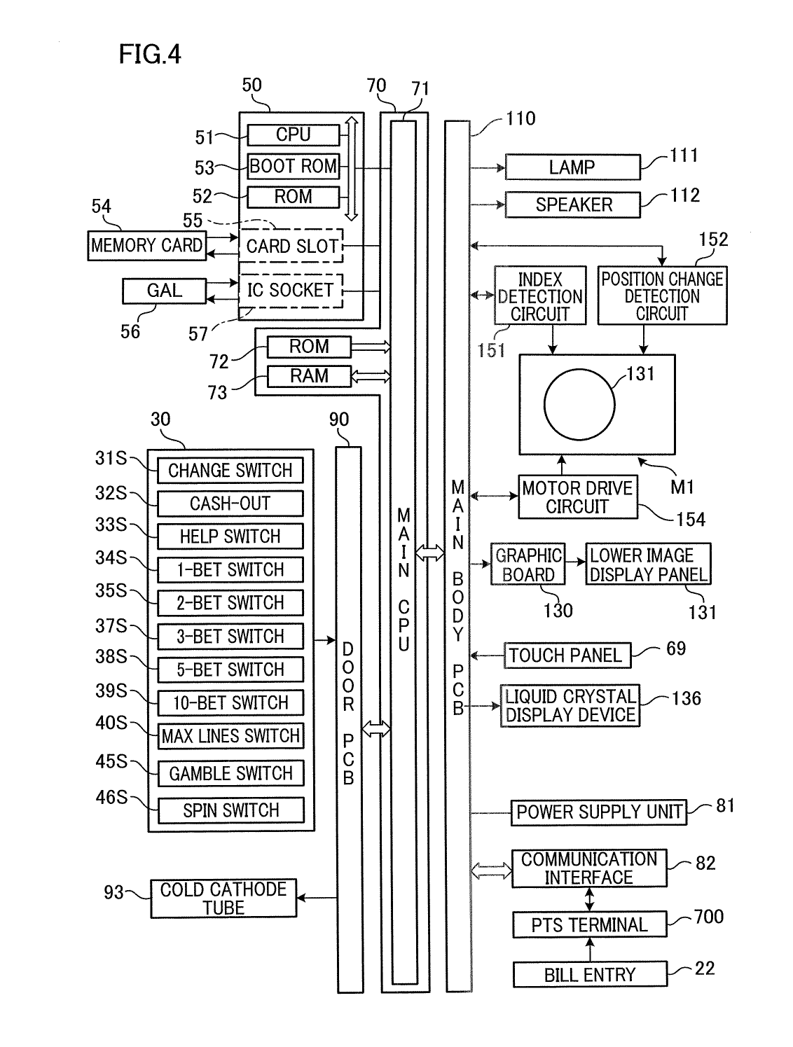

Now, referring to FIG. 4, the structure of a circuit in the slot machine 1 will be described.

A gaming board 50 is provided with: a CPU 51; a ROM 52, and a boot ROM 53, which are mutually connected by an internal bus; a card slot 55 corresponding to a memory card 54; and an IC socket 57 corresponding to a GAL (Generic Array Logic) 56.

The memory card 54 includes an involatile memory, and stores a game program and a game system program. The game program includes a program related to game progression and a program for producing effects by images and sounds. The game program further includes a symbol determination program. The symbol determining program is a program for determining symbols to be rearranged on the display blocks 28.

Further, the card slot 55 is configured so that the memory card 54 can be inserted thereinto and removed therefrom, and is connected to a motherboard 70 by an IDE bus. The type and contents of the game to be played on the slot machine 1 can be changed by drawing out the memory card 54 from the card slot 53S, writing another game program into the memory card 54, and inserting the memory card 54 into the card slot 53S.

The GAL 56 is a type of PLD (Programmable Logic Device) having a fixed OR array structure. The GAL 56 is provided with a plurality of input ports and output ports, and predetermined input into the input port causes output of the corresponding data from the output port.

Further, the IC socket 57 is configured so that the GAL 56 can be inserted thereinto and removed therefrom, and is connected to the motherboard 70 by a PCI bus. The contents of the game to be played on the slot machine 1 can be changed by replacing the memory card 54 with another memory card 54 having another program written therein or by rewriting the program written into the memory card 54 as another program.

The CPU 51, the ROM 52 and the boot ROM 53 mutually connected by the internal bus are connected to the motherboard 70 by a PCI bus. The PCI bus enables a signal transmission between the motherboard 70 and the gaming board 50, and power supply from the motherboard 70 to the gaming board 50.

The ROM 52 stores an authentication program. The boot ROM 53 stores a pre-authentication program, a program (boot code) to be used by the CPU 51 for activating the preliminary authentication program, and the like.

The authentication program is a program (falsification check program) for authenticating the game program and the game system program. The preliminary authentication program is a program for authenticating the aforementioned authentication program. The authentication program and the preliminary authentication program are written along a procedure (authentication procedure) for proving that the program to be the subject has not been falsified.

The motherboard 70 is constituted by a commercial general-purpose mother board (printed circuit board on which basic components for personal computers are mounted) and is provided with a main CPU 71, a ROM (Read Only Memory) 72, a RAM (Random Access Memory) 73, and a communication interface 82. This motherboard 70 is equivalent to the game controller 100 of the present embodiment.

The ROM 72 includes a memory device such as a flash memory, and stores a program such as BIOS (Basic Input/Output System) to be executed by the main CPU 71, and permanent data. When the BIOS is executed by the main CPU 71, processing for initializing predetermined peripheral devices is conducted. Further, through the gaming board 50, processing of loading the game program and the game system program stored in the memory card 54 is started. In the present invention, the ROM 72 may be or may not be rewritable.

The RAM 73 stores data used for the operation of the main CPU 71 and programs such as the symbol determining program. For example, when the processing of loading the aforementioned game program, game system program or authentication program is conducted, the RAM 73 can store the program. The RAM 73 is provided with working areas used for operations when these programs are executed. Examples of the areas include: an area that stores the game counter, the bet amount, the payout amount, the credit amount and the like; and an area that stores symbols (code numbers) randomly determined.

The communication interface 82 is for communicating with the PTS device 700 or a not-shown external controller. The PTS device 700, upon reception of an input signal from the bill entry 22, transmits credit data contained in the input signal to the main CPU 71 via the communication interface 82. Further, when an IC card is inserted into the card insertion slot, the PTS device 700 transmits credit data stored in the IC card to the main CPU 71 via the communication interface 82. The PTS device 700 also writes credit data into the IC card inserted into the card insertion slot, based on a control signal received from the main CPU 71 via the communication interface 82.

Further, the motherboard 70 is connected with a later-described door PCB (Printed Circuit Board) 90 and a main body PCB 110 by respective USBs. Further, the motherboard 70 is connected to the power supply unit 81. When the power is supplied from the power supply unit 81 to the motherboard 70, the main CPU 71 of the motherboard 70 is activated, and then the power is supplied to the gaming board 50 through the PCI bus so as to activate the CPU 51.

The door PCB 90 and the main body PCB 110 are connected with input devices such as a switch and a sensor, and peripheral devices the operations of which are controlled by the main CPU 71.

The door PCB 90 is connected with a control panel 30, and a cold cathode tube 93.

The control panel 30 is provided with a change switch 31S, a cash-out switch 32S, a help switch 33S, a 1-bet switch 34S, a 2-bet switch 35S, a 3-bet switch 37S, a 5-bet switch 38S, a 10-bet switch 39S, a max-bet switch 40S, a gamble switch 45S, and a spin switch 46S which correspond to the above mentioned buttons, respectively. Each of the switches outputs a signal to the main CPU 71 upon detection of press of the button corresponding thereto by the player.

The cold cathode tube 93 functions as a backlight installed on the rear face sides of the lower image display panel 141, and lights up based on a control signal output from the main CPU 71.

The main body PCB 110 is connected with the lamp 111, the speakers 112, a graphic board 130, a liquid crystal display device 136, and the touch panel 69.

The lamp 111 turns on based on a control signal outputted from the main CPU 71. The speakers 112 output BGM sound or the like in accordance with a control signal output from the main CPU 71.

The graphic board 130 controls displaying of images on the lower image display panel 141 based on a control signal output from the main CPU 71. The graphic board 130 is provided with the VDP (Video Display Processor) configured to generate image data, the video RAM configured to store the image data generated by the VDP, and the like. It is to be noted that the image data used for generating image data by the VDP is included in the game program that has been read from the memory card 54 and stored into the RAM 73.

The touch panel 69 detects a position on the lower image display panel 141 touched by a finger or the like of the player, and outputs a signal corresponding to the detected position to the main CPU 71.

The liquid crystal display device 136 displays an image based on the control signal output from the main CPU 71. The touch panel 137 detects a position on the liquid crystal display device 136 touched by a finger or the like of the player, and outputs a signal corresponding to the detected position to the main CPU 71.

Further, the main body PCB 110 is connected to an index detection circuit 151, a position change detection circuit 152, and a motor driving circuit 154. The index detection circuit 151, the position change detection circuit 152, and the motor driving circuit 154 are connected to the reel device M1.

The motor driving circuit 154 is connected to a stepping motor configured to rotate the wheel 131. Further, the motor driving circuit 154 includes an FPGA (Field Programmable Gate Array) and a driver. The FPGA is an electronic circuit such as a programmable LSI, and functions as a control circuit of the stepping motor. The driver functions as an amplifying circuit for pulses to be input to the stepping motor.

The index detection circuit 151 is configured to detect the position of the rotating wheel 131, and is further capable of detecting stepping out of the wheel 131.

The position change detection circuit 152 is configured to detect a change in the stop position of the wheel 131 after the rotation of the wheel 131 is stopped. For example, due to an external action such as cheating, if the stop position is changed so that the pointer points out an area corresponding to a type of bonus which was not actually selected, the position change detection circuit 152 detects that change in the stop position of the wheel 131. The position change detection circuit 152 is configured to detect a change in the stop position of the wheel 131, for example, by detecting not-shown fins which is arranged on the inner side of the wheel 131 at predetermined intervals.

It should be noted that the method of exciting the stepping motor is not particularly limited, and 1-2 phase excitation system or a 2 phase excitation system are adoptable. Further, a DC motor may be adopted in place of the stepping motor. In cases of adopting a DC motor, the main body PCB 110 is connected to a deviation counter, a D/A converter, a servo amplifier in this order, and the DC motor is connected to the server amplifier. Further, the rotational position of the DC motor is detected by the rotary encoder, and the rotary encoder supplies the current rotational position of the DC motor in the form of data to the deviation counter.

(PTS Terminal 700)

The PTS terminal 700 is incorporated in a PTS system. The PTS terminal 700 attached to the slot machine 1 is arranged to be able to communicate with the game controller 100 of the slot machine 1 and the not-shown bill validation controller.

The PTS terminal 700 conducts sound and image effects in games and updates the credit data, based on the communications with the game controller 100. Furthermore, the PTS terminal 700 sends credit data to the bill validation controller, which is required at the time of the settlement.

Further, the PTS terminal 700 is connected to and in communication with a management server. The PTS terminal 700 and the management server are connected with each other by two lines, namely, a normal communication line and an additional function communication line.

The PTS terminal 700 exchanges, via the normal communication line, data such as cash data, identification code data, member information of a player. On the other hand, via the additional function communication line, the PTS terminal 700 conducts communications concerning newly-added functions. In the present embodiment, the PTS terminal 700 conducts, by the additional function communication line, communications concerning an exchange function, an IC card function, a biometric function, a camera function, and an RFID (Radio Frequency Identification) function of individual identification by radio waves.

(Symbols, Combinations, or the Like)

The symbols, which are displayed on pseudo reels 151 to 155 of the slot machine 1, form a symbol array. Each symbol constituting the symbol array has one of code numbers 0 to 19 or more. Each symbol array is a combination of the symbols such as a wild symbol, a specific symbol 503, and a normal symbol.

The three successive symbols in the symbol array are, as shown in FIG. 3, displayed (provided) at the upper stage, the middle stage, and the lower stage of the display region of each of the pseudo reels 151 to 155, so that a symbol matrix of 5 columns and 3 rows is formed on the display window 150. The symbols forming the symbol matrix start to scroll at least when a game starts in response to the pressing of the spin button 46. After a predetermined time elapses from the start of the scroll, the scroll of the symbols stops (rearrangement).

In addition to the above, for the symbols, various winning combinations are set in advance. A winning combination indicates that an award is established. A winning combination is a combination in which symbols having stopped on a payline L is advantageous for the player. By the word advantageous, it means for example an amount of credit according to a winning combination being increased, or a state in which a bonus game is started.

The winning combination in the present embodiment is a combination in which a predetermined number or more of symbols of at least one type are rearranged on an activated payline L. When a particular type of symbols is set as a scatter symbol, a winning combination is established when a predetermined number or more of such scatter symbols are rearranged, no matter whether a payline L is activated or not.

The way of determining whether or not a winning is established is “Left-to-Right”, i.e., the determination proceeds from the left end to the right end when viewed from the player's view point. In other words, the determination is carried out in the sequence of stopping the pseudo reels 151 to 155.

(LED Data Table)

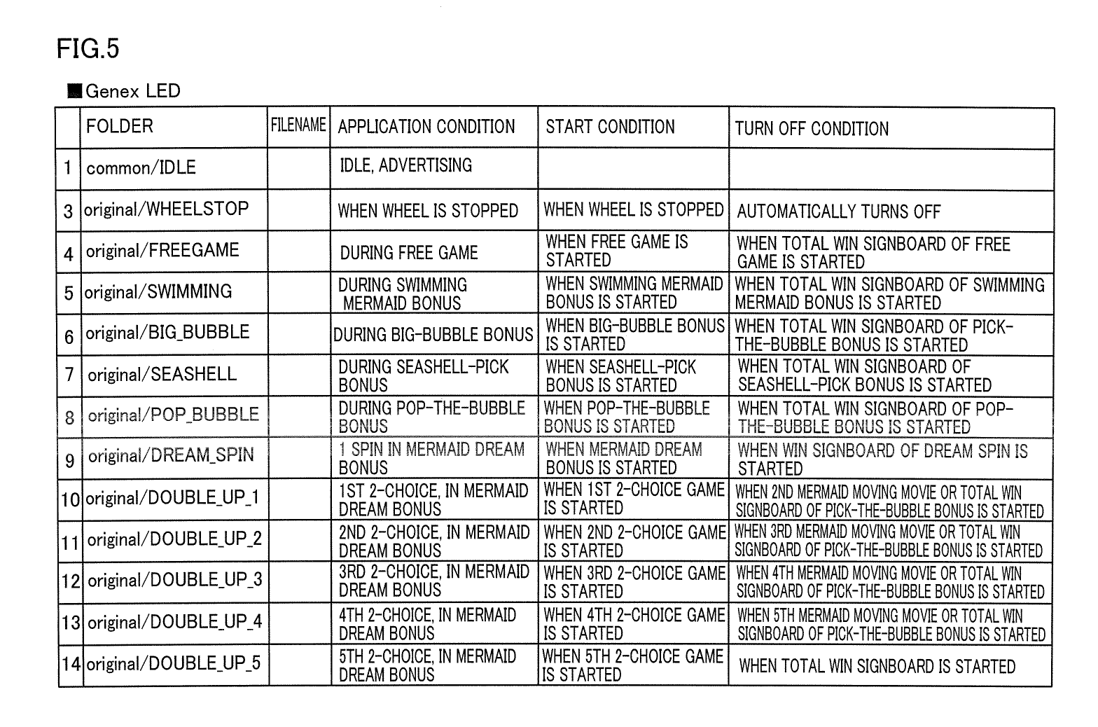

FIG. 5 shows an LED data table for use in managing a condition for controlling the turn-on/off of LED on the slot machine 1. The slot machine 1 reproduces LED data under the control of a program, based on the data table.

More specifically, the LED data table includes number fields, folder fields, application part fields, start condition fields, and deletion condition fields. The folder field, the application part field, the start condition field, and the deletion condition field associated with a number field “1” store “Common/IDLE”, “IDLE, Advertising”, “-”, and “-”, respectively. The folder field, the application part field, the start condition field, and the deletion condition field associated with a number field “3” store “Original/WHEELSTOP”, “When Wheel Stopped”, “When Wheel Stopped”, and “Automatically turns off”, respectively.

The folder field, the application part field, the start condition field, and the deletion condition field associated with a number field “4” store “Original/FREEGAME”, “During FREEGAME”, “When Free game starts”, and “When total win signboard of free game starts”, respectively. The folder field, the application part field, the start condition field, and the deletion condition field associated with a number field “5” store “Original/SWIMMING”, “During Swimming Mermaid bonus”, “When swimming mermaid bonus starts”, and “When total win signboard of swimming mermaid bonus starts”, respectively. Other fields are arranged as shown in FIG. 5.

(Spin Table)

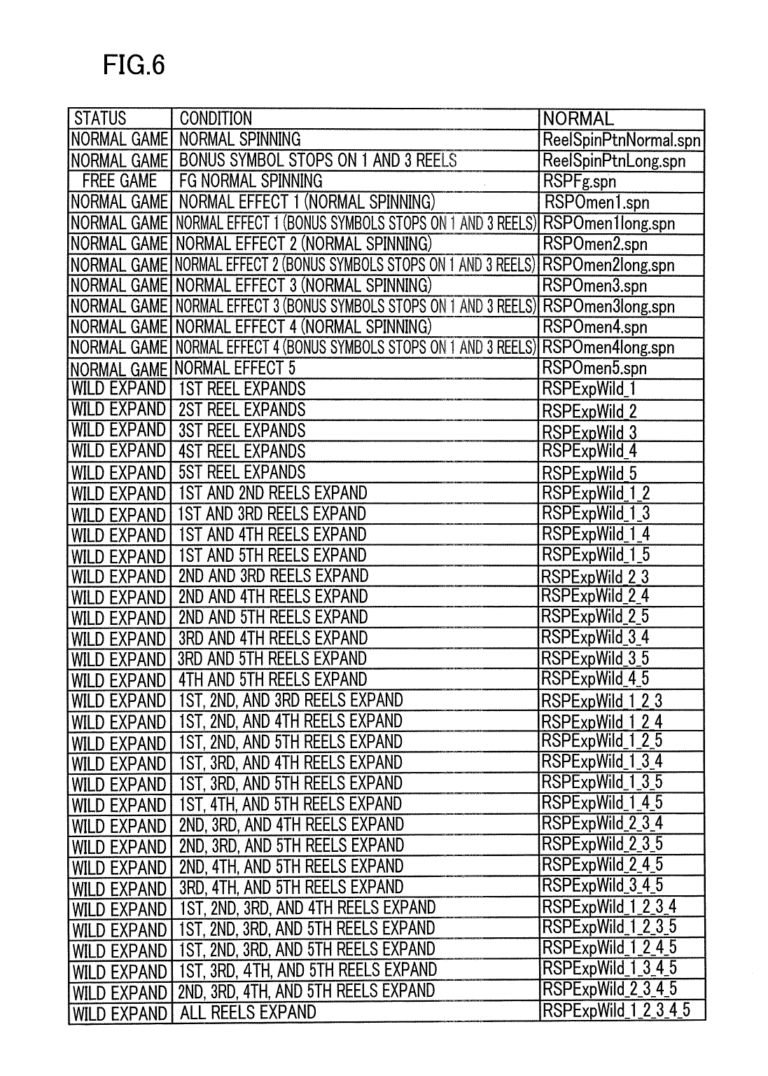

FIG. 6 shows a spin table of sets of spin data used in different gaming states of the slot machine 1. The spin table includes status fields, condition fields, normal fields.

The condition field and the normal field associated with the status field “normal game” store “Normal Spinning” and “ReelSpinPtnNormal.spn”, respectively. The condition field and the normal field associated with the status field “normal game” store “Stop bonus symbol on reels 1 and 3” and “ReelSpinPtnLong.spn”, respectively. The condition field and the normal field associated with the status field “free game” store “free game normal spinning” and “RSPFg.spn”, respectively. Other fields are arranged as shown in FIG. 6.

(Symbol Data Table)

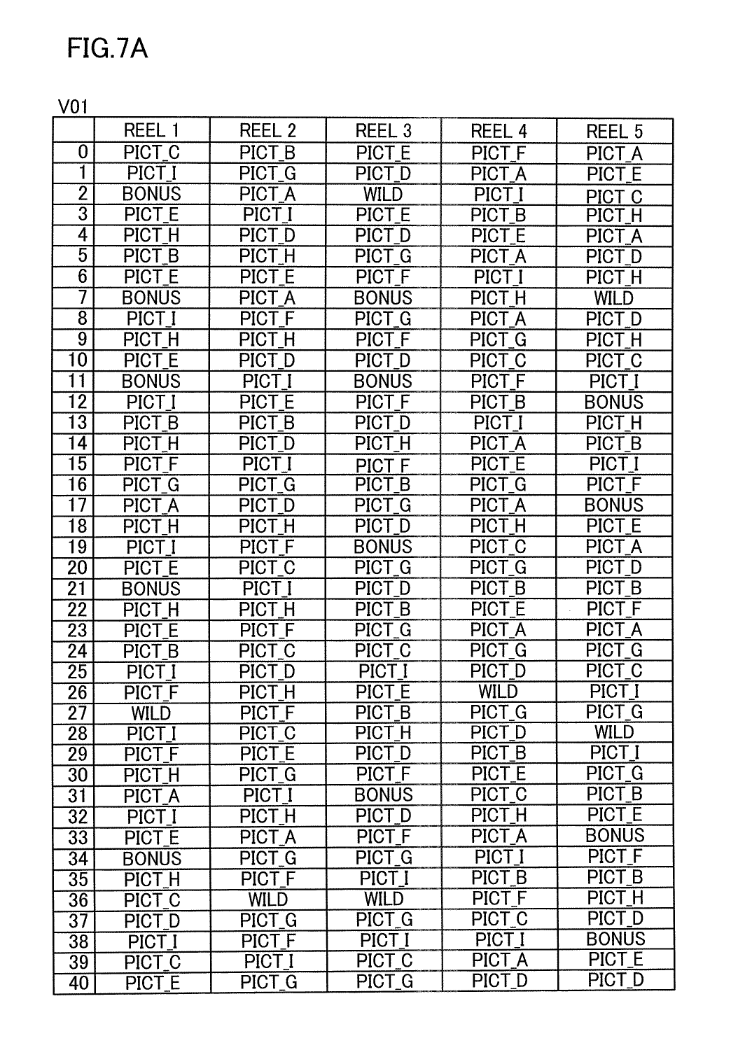

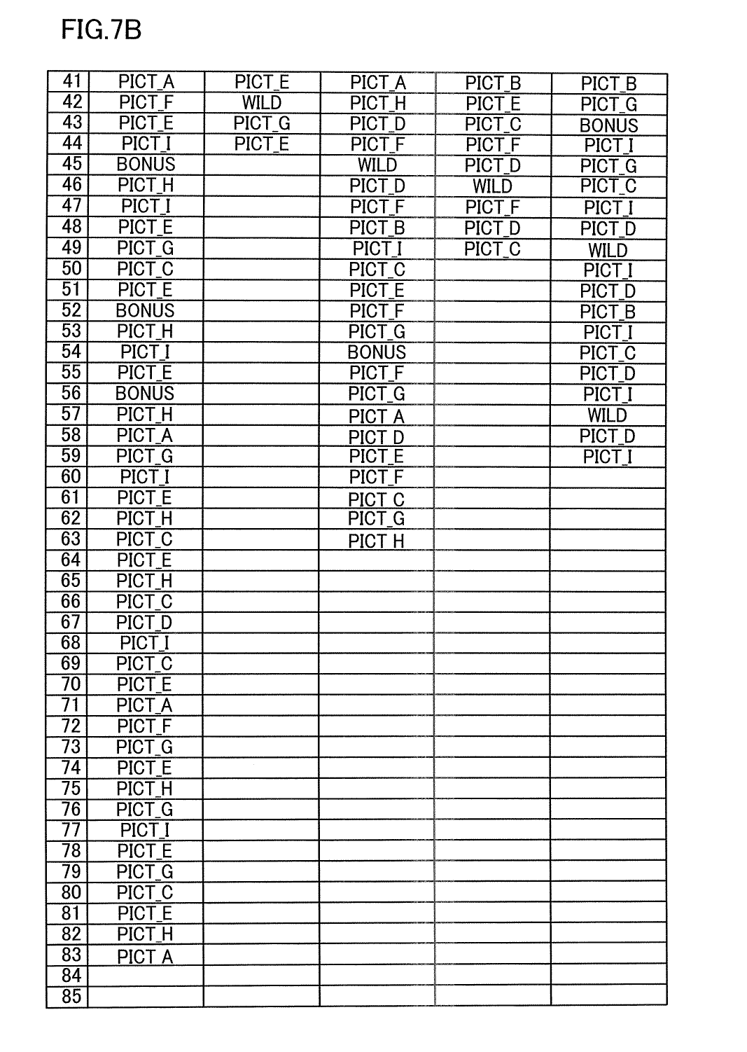

FIG. 7 to FIG. 9 each show a symbol table which is a table for use when determining symbols to be rearranged. In the symbol table, symbols on the display blocks 28 in each symbol array are associated with code numbers, and numerical ranges defined by dividing a numerical range of 0 to 65535 are associated with the respective code numbers.

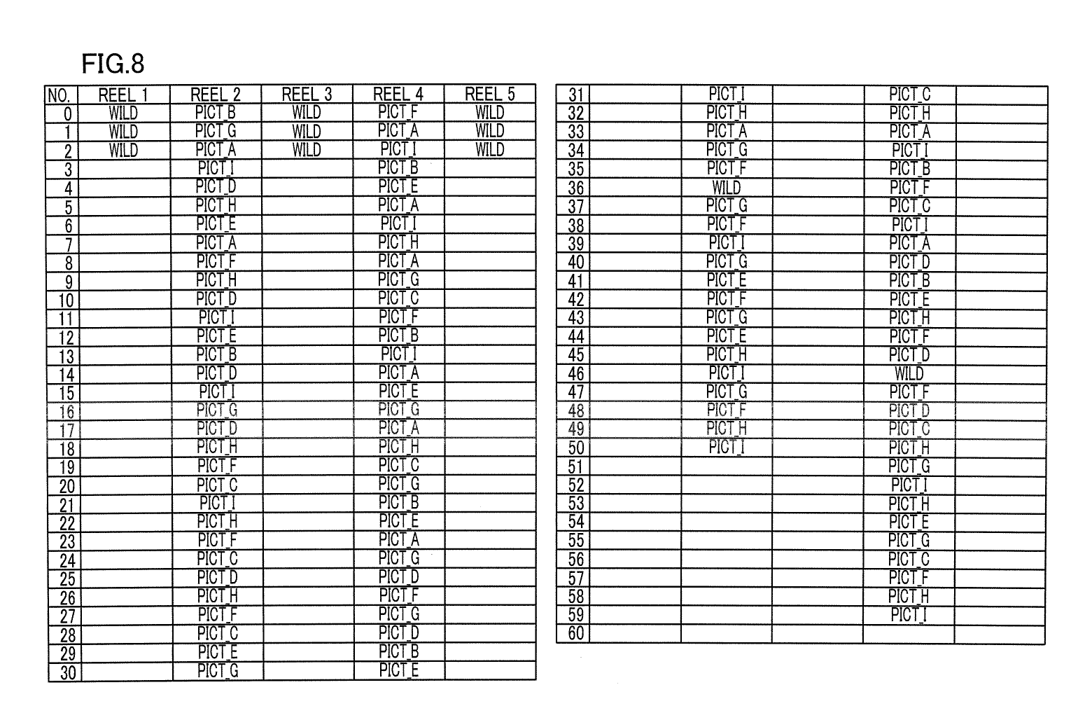

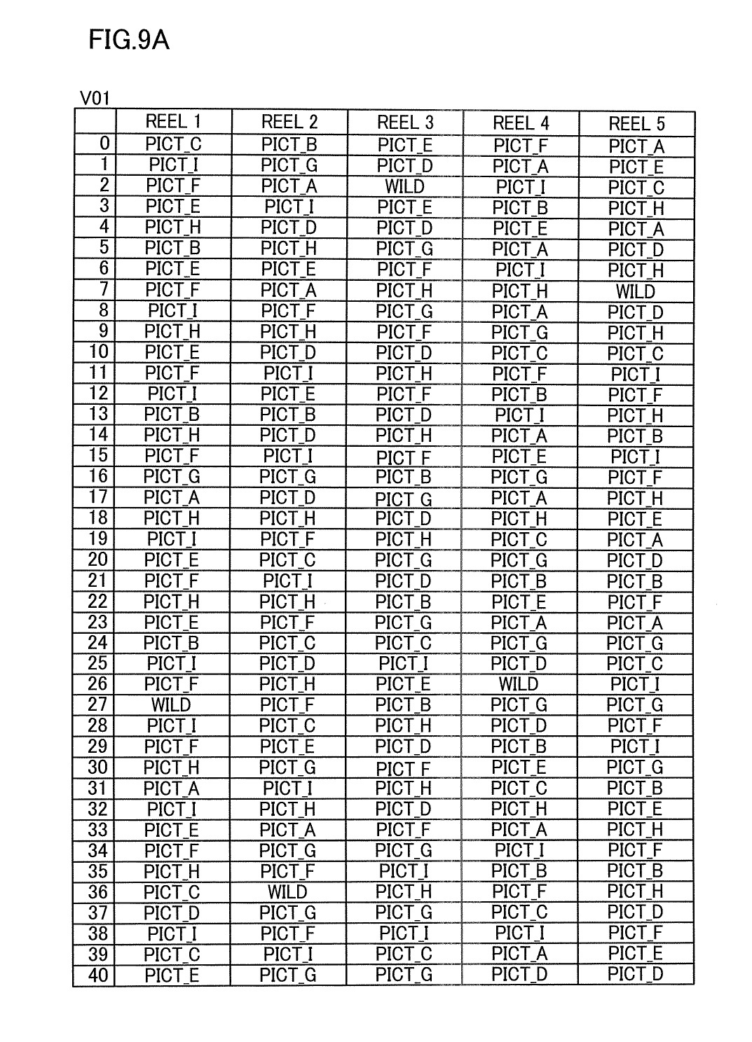

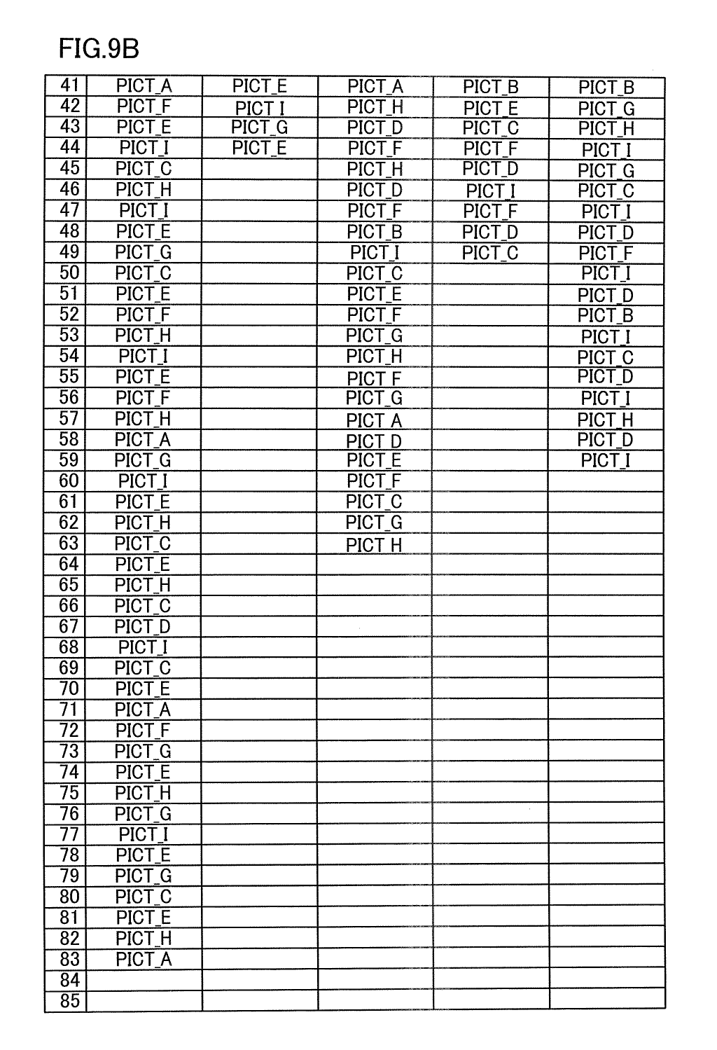

The symbol tables shown in FIG. 7A and FIG. 7B are each a table selected in the base game (normal game). The symbol table shown in FIG. 8 is a table selected in the free game in a mermaid dream bonus which is a type of wheel bonus. The symbol tables shown in FIG. 9A and FIG. 9B are each a table selected in the mystery mermaid free game which is a type of wheel bonus.

It should be noted that the symbol table may be equally or unequally divided. When unequally divided, it is possible to adjust the probabilities of wining for the respective types of the symbols by determining the ranges of the random numbers. In this regard, the ranges corresponding to the “BONUS” of the trigger symbol 503a of the specific symbol 503 and the “WILD” of the wild symbol 503b may be arranged to be narrower than the ranges of the other types of the symbols. In this case, results of games can be easily adjusted in accordance of the progress of the games, by arranging valuable types of the symbols to be less likely to be won.

For example, when a random number randomly selected for the first column is “10000”, the symbol having the code number associated with the random number range including the selected random number is chosen as the target of rearrangement on the pseudo reel 151 of the first column. On the other hand, when, for example, a random number for the fourth column is “40000”, the symbol having the code number associated with the random number range including the selected random number is chosen as the target of rearrangement on the pseudo reel 154 of the fourth column.

(Payout Table)

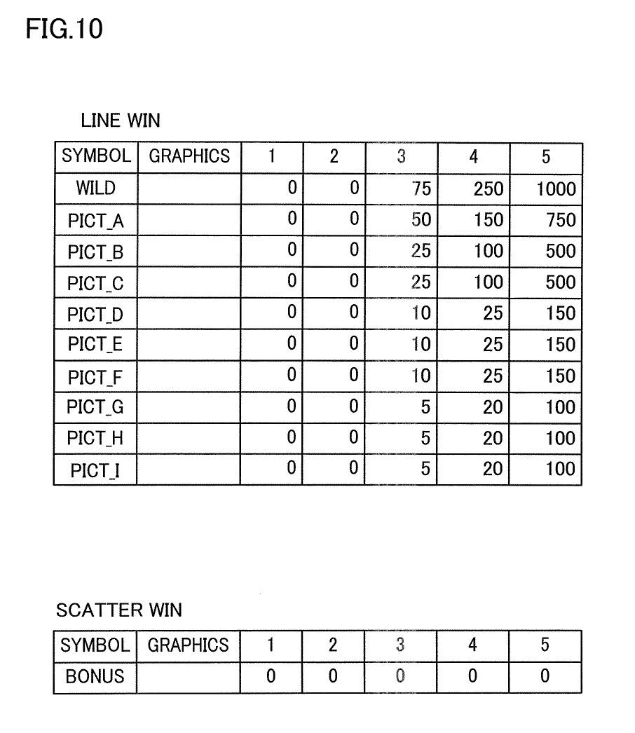

The following describes a payout table with reference to FIG. 10. The payout table shown in FIG. 10 specifies the symbol combination related to winning (symbol count) and the amount of credit awarded. In the slot machine 1, a win is achieved when the scroll of the symbol arrays of the pseudo reels 151 to 155 is stopped and a combination of symbols displayed on a payline matches with a combination of symbols defined in the payout table. In accordance with the type of win, a benefit will be given to the player in the form of awarding credit and the like. It is noted that a win is not established (i.e. the game is lost) when the combination of symbols displayed on the payline does not match with any of the combinations of symbols specified by the payout table.

In the present embodiment, basically, a line win is established when a 3-, 4-, or 5-of-a-kind combination of any one of the following kinds of symbols occurs on a payline: “WILD”, “PICT_A”, “PICT_B”, “PICT_C”, “PICT_D”, “PICT_E”, “PICT_F”, “PICT_G”, “PICT_H”, and “PICT_I”. It should be noted that, for the “WILD” symbol, any of the following types of symbols is substituted: “PICT_A”, “PICT_B”, “PICT_C”, “PICT_D”, “PICT_E”, “PICT_F”, “PICT_G”, “PICT_H”, and “PICT_I”.

Further, the payout table shown in FIG. 10 specifies the amount of credit awarded when the normal game is run, with a minimum bet amount of 50. When a normal game is run with a bet amount other than 50, the amount of credit to be awarded will be a value resulting from multiplying the amount of credit to be awarded shown in FIG. 10, by a multiplier factor of the amount bet with respect to 50.

Therefore, for example, when the normal game is run with a bet of 50 and when the “PICT_A” occurs in three positions on a pay line, a winning occurs and credit of 50 is awarded. Further, when the normal game is run with a bet of 500 and when the “PICT_A” occurs in five positions on a pay line, a winning occurs and credit of 7500 (=750×10) is awarded. In the following the multiplier factor of the bet amount with respect to the bet of 50 is hereinafter also referred to as “bet multiplier”.

Further, when “BONUS” symbol which is a trigger symbol for a wheel bonus (trigger symbol 503a) is rearranged in three or more positions in the display window 150, a “bonus trigger” is determined as the winning combination, and there will be a transition to the wheel bonus. More specifically, the “BONUS” symbol rearranged on first reel 151 to fifth reel 155 may be rearranged in any of the upper stage, the middle stage, and the lower stage of the display window (does not have to be on a pay line). For example, when the “BONUS” symbol is rearranged in the lower stage of the first reel 151, in the middle stage of the third reel 153, and in the upper stage of the fifth reel 155, the winning combination will be a “bonus trigger”.

Further, if no “BONUS” symbol is rearranged on the third reel 153, the winning combination may be a “mystery feature trigger” which leads to occurrence of a mystery feature. In other words, the mystery feature may occur when the “BONUS” symbol is not rearranged in any of the upper stage, the middle stage, and the lower stage of the third reel 153, in the display window.

(Wheel Bonus)

The following describes a wheel bonus.

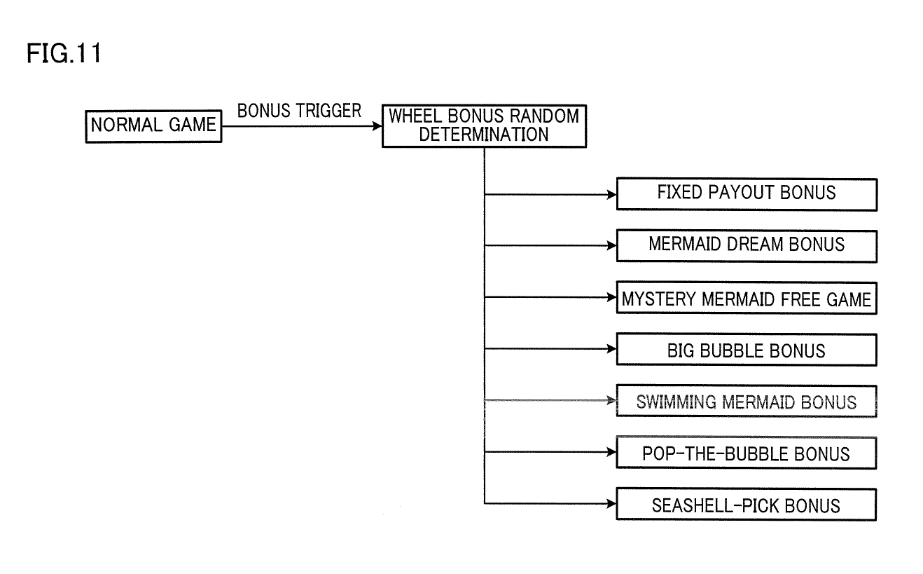

The slot machine 1 of the present embodiment is configured so that rearrangement of “BONUS” symbol (trigger symbol 503a) in three or more positions in the display window 150 during a base game establishes a bonus trigger condition, thus leading to a transition to the wheel bonus. This wheel bonus is constituted by seven types of bonuses: i.e., a fixed payout bonus, a mermaid dream bonus, a mystery mermaid free game, a big bubble bonus, a swimming mermaid bonus, a pop-the-bubble bonus, and a seashell-pick bonus, as shown in FIG. 11.

When the transition to the wheel bonus occurs, the wheel 131 (see FIG. 3) rotates counter clockwise, and then stops so that the pointer 174 indicates an area corresponding to the bonus determined. This way, the player is able to which type of bonus is determined by visually confirming the area indicated by the pointer 174.

The fixed payout bonus awards any of the following five types of payout: “100”, “150”, “200”, “300”, and “3000”.

In the mermaid dream bonus, a payout is determined by running once a free game (dream spin) at the beginning, followed by a 2-choice game (double treasure chance) which is a game of selecting one of two treasure boxes. When the content of the selected treasure box is success, the payout is doubled. Specifically, a single round of free game is first run, and the payout is determined. It should be noted that this free game is a slot game for rearranging a plurality of symbols 502, using a symbol table shown in FIG. 8. The free game is a game run without a bet of gaming value.

Next, a treasure box (selectable target) corresponding to success and a treasure box (selectable target) corresponding to fail are displayed on the lower image display panel 141. The payout is doubled when the player selects, via the touch panel 69, the treasure box corresponding to success. This further enables selection of one of another two treasure boxes. As long as the player selects the treasure box corresponding to success, two treasure boxes are displayed on the lower image display panel 141, thus enabling another selection making. However, once the treasure box corresponding to fail is selected, the mermaid dream bonus is ended, and the payout at the time point is awarded. It should be noted that the selection making of one of the two treasure boxes is enabled up to five times at the most. Thus, the mermaid dream bonus ends either when the treasure box corresponding to fail is selected, or when the treasure box corresponding to success is selected five times in a row.

The mystery mermaid free game runs a free game a plurality of number of times, and awards seven types of generated bonuses in each round of free game. It should be noted that this free game is a slot game for rearranging a plurality of symbols 502, using a symbol table shown in FIG. 9A and FIG. 9B. Although the free game in the mystery mermaid free game is a game run without a bet of a gaming value, it is different from the free game run in the mermaid dream bonus.

The generated bonuses awarded in each time free game is run are: “payout rate”, “wild reel”, “scattering wild”, “additional game count”, “payout rate & wild reel”, “payout rate & scattering wild”, and “wild reel & scattering wild”. The “payout rate” multiplies the payout of the free game. The “wild reel” replaces any of the five pseudo reels 151 to 155 with a wild reel. The wild reel is a reel such that the wild symbol is displayed in all of the upper stage, the middle stage, and the lower stage of the display region. The “scattering wild” displays in a scattering manner a plurality of wild symbols in any of 15 display blocks 28. Note that the “wild reel” is also referred to as “expand wild”.

The “additional game count” increments the game count of the free game. It should be noted that the game count in the mystery mermaid free game at the beginning is 7 times. The “payout rate & wild reel” causes “payout rate” and the “wild reel” at the same time. The “payout rate & scattering wild” causes “payout rate” and the “scattering wild” at the same time. The “wild reel & scattering wild” causes “wild reel” and the “scattering wild” at the same time. When the “wild reel” and the “scattering wild” occurs at the same time, the wild symbol is not scattered in the reel changed to the wild reel.

That is, the slot machine 1 is a gaming machine configured to run a game which awards a payout according to symbols rearranged, including a symbol display device configured to display a plurality of types of symbols arranged on a group of reel strips; and a controller programmed to execute the following processes (a1) to (a4). Namely these processes are: (a1) running a normal game in which symbols are rearranged in the symbol display device, (a2) running a free game when a predetermined condition is established, in which game the symbols are rearranged in the symbol display device, (a3) generating at least one bonus out of a plurality of types of bonuses, during the free game, and (a4) awarding the payout.

Further, in the slot machine 1, the bonus multiplies the payout. Further, in the slot machine 1, the bonus rearranges a single kind of symbol in one or more positions in the group of reel strips. Further, in the slot machine 1, the bonus replaces a plurality of symbols out of those rearranged on the symbol display device, with a specific symbol. Further, in the slot machine 1, the bonus increments the game count of the free game.

In the big bubble bonus, a bubble displayed on the lower image display panel 141 is enlarged with repeated stroke of the spin button 46. It should be noted that the payout is determined at the time of starting the big bubble bonus. Therefore, the determined payout is awarded to the player at the end, irrespective of the game content.

In the swimming mermaid bonus, the mermaid displayed on the lower image display panel 141 is controlled by pressing the spin button 46 to fetch coins. It should be noted that the payout is determined at the time of starting the swimming mermaid bonus. Therefore, the determined payout is awarded to the player at the end, irrespective of the game content.

The pop-the-bubble bonus is constituted by a game of picking countless number of bubbles displayed on the lower image display panel 141, with operation on the touch panel (time challenge); and a game of selecting any of three bubbles displayed on the lower image display panel 141 (bubble surprise). By the wording “pick”, it means touching a bubble displayed, by means of input through the touch panel 69. It should be noted that the payout is determined at the time of starting the pop-the-bubble bonus. Therefore, the player is given an award which is the determined payout plus a payout corresponding to the bubble selected out of the three bubbles, irrespective of the game content. Specifically, a first payout is determined at the time of starting the bonus. Then, the game of picking the bubbles out of the countless number of bubbles is run, and the payouts corresponding to the picked bubbles are added up to make a second payout. That is, the difference between the first payout and the second payout is the payout the player has missed. After that, the game of selecting any of the three bubbles is run, and a third payout corresponding to the bubble picked is determined. Then, a total payout is calculated by adding, to the third payout, the value resulting from subtracting the second payout from the first payout. This total payout is then awarded to the player.

That is, the slot machine 1 is a gaming machine configured to run a game which awards a payout according to symbols rearranged, including a symbol display device configured to variably display and rearrange symbols; a display device configured to perform video effect display; an input device configured to receive an input from a player; and a controller programmed to execute the following processes (a1) to (a9). Namely these processes are: (a1) running a normal game in which symbols are rearranged in the symbol display device, (a2) determining a first payout, when a predetermined condition is established, (a3) displaying on the display device a plurality of first selectable targets corresponding to a plurality of types of payouts, respectively, (a4) causing the input device to receive a plurality of input operations selecting any of the first selectable targets, within a time limit, (a5) adding up payouts corresponding to selected first selectable targets to yield a second payout, (a6) displaying on the display device a predetermined number of second selectable targets corresponding to a plurality of types of third payouts, upon elapse of the time limit, (a7) causing the input device to receive an input operation of selecting any of the second selectable targets, (a8) calculating a total payout by adding a value resulting from subtracting the second payout from the first payout to the third payout corresponding to the selected second selectable target, and (a9) awarding the total payout.

The seashell-pick bonus is a game of picking any of 15 seashells displayed on the lower image display panel 141 so as to obtain a payout or an additional pick. By the wording “pick”, it means touching a seashell displayed, by means of input through the touch panel 69. The seashells are associated with a plurality of types of credit and additional number of picks. The number of picks at the start of the game is three times.

(Mystery Feature)

In the slot machine 1 of the present embodiment, the mystery feature trigger condition may be established, thus leading to occurrence of mystery feature, when the “BONUS” symbol (trigger symbol 503a) is not displayed on the third reel 153, in the base game. The mystery feature is constituted by three types of features: which are “payout rate”, “wild reel”, and “scattering wild”. These features are basically the same as the generated bonuses of “payout rate”, “wild reel”, and “scattering wild” which occur in the mystery mermaid free game which is one of the wheel bonuses. However, the “scattering wild” is not executed when there is a wild symbol to be rearranged, in the display block 28. It should be noted that the “wild reel” is also referred to as “wild expand feature”.

(Wheel Bonus Random Determination Table)

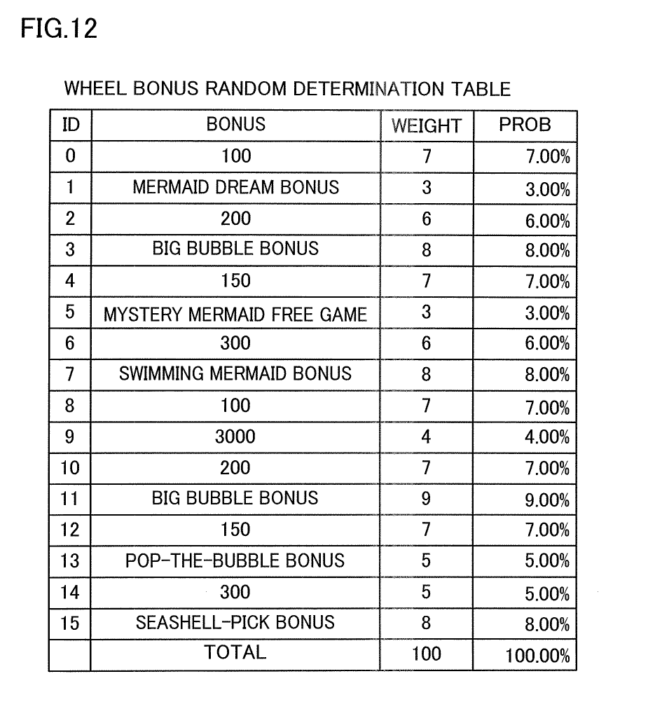

When there is a transition to the wheel bonus in the present embodiment, a wheel bonus selection process is executed, in which any one of seven types of bonuses is selected, by using a wheel bonus random determination table shown in FIG. 12. In the wheel bonus random determination table, a weight is set for: five types of fixed payouts (100, 150, 200, 300, 3000) in “fixed payout bonus”, “mermaid dream bonus”, “mystery mermaid free game”, “big bubble bonus”, “swimming mermaid bonus”, “pop-the-bubble bonus”, and “seashell-pick bonus”. The weights indicate the probabilities of the seven types of bonuses being selected in the wheel bonus selection process. In the present embodiment, weights for the seven types of bonuses are made different from one another. For example, the probability of “mermaid dream bonus” being selected is 3%, while the probability of “seashell-pick bonus” being selected is 8%.

(Possible Bonus Random Determination Table)

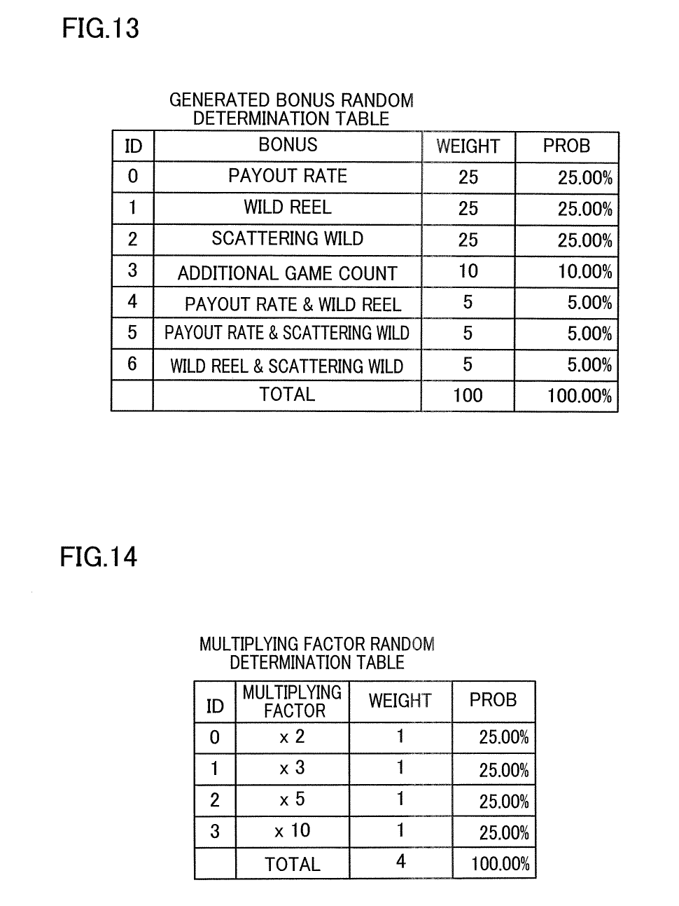

In the mystery mermaid free game which is a type of the wheel bonus, a generated bonus selection process is executed, in which process any one of the seven types of generated bonuses is selected by using a generated bonus random determination table shown in FIG. 13. In the generated bonus random determination table, a weight is set for the seven types of generated bonuses: i.e., “payout rate”, “wild reel”, “scattering wild”, “additional game count”, “payout rate & wild reel”, “payout rate & scattering wild”, and “wild reel & scattering wild”. The weights indicate the probabilities of the seven types of generated bonuses being selected in the generated bonus selection process. In the present embodiment, weights for the seven types of generated bonuses are made different from one another. For example, the probability of “payout rate” being selected is 25%, while the probability of “wild reel & scattering wild” being selected is 5%.

(Multiplying Factor Random Determination Table)

When the “payout rate” is selected as the generated bonus in the mystery mermaid free game, a multiplying factor selection process is executed, in which any one of four multiplying factors for a payout of a free game is selected by using a multiplying factor random determination table shown in FIG. 14. The multiplying factor random determination table is a table in which weights are set for the four multiplying factors, i.e., “×2”, “×3”, “×5”, and “×10”. The weights indicate the probabilities of the four multiplying factors being selected in the multiplying factor selection process. In the present embodiment, the same weight is set for the four multiplying factors. Thus, the probability of any of the four multiplying factors being selected is 25%.

(Wild Reel Random Determination Table)

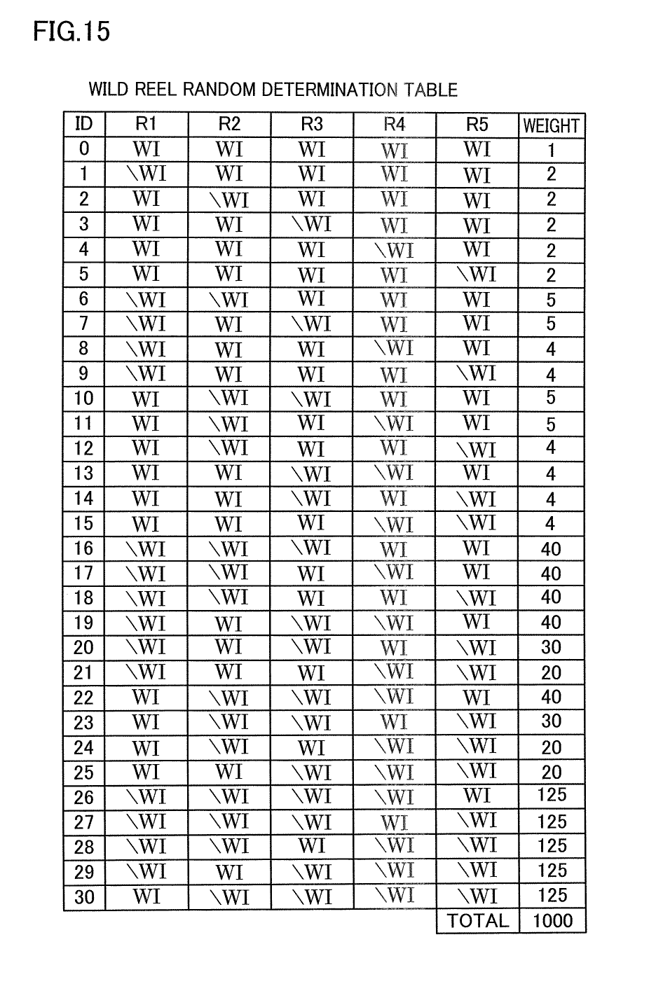

When the “wild reel” or the “payout rate & wild reel” is selected as the generated bonus in the mystery mermaid free game, a wild reel selection process is executed, in which a reel to be changed to the wild reel during the free game is selected by using the wild reel random determination table shown in FIG. 15. The wild reel random determination table is a table in which weights are set for 31 combinations, i.e., No. 0 to No. 30. In each combination, either one of “WI” and “-” is assigned to five pseudo reels 151 to 155. The “WI” indicates the reel is changed to a wild reel. The “-” indicates the reel is not changed to a wild reel. The weights indicate the probabilities of the 31 combinations being selected in the wild reel selection process. In the present embodiment, weights for the 31 combinations are made different from one another. For example, the weight of “No. 0” being selected is 1, while the weight of the “No. 30” being selected is 125.

(Scattering Wild Random Determination Table)

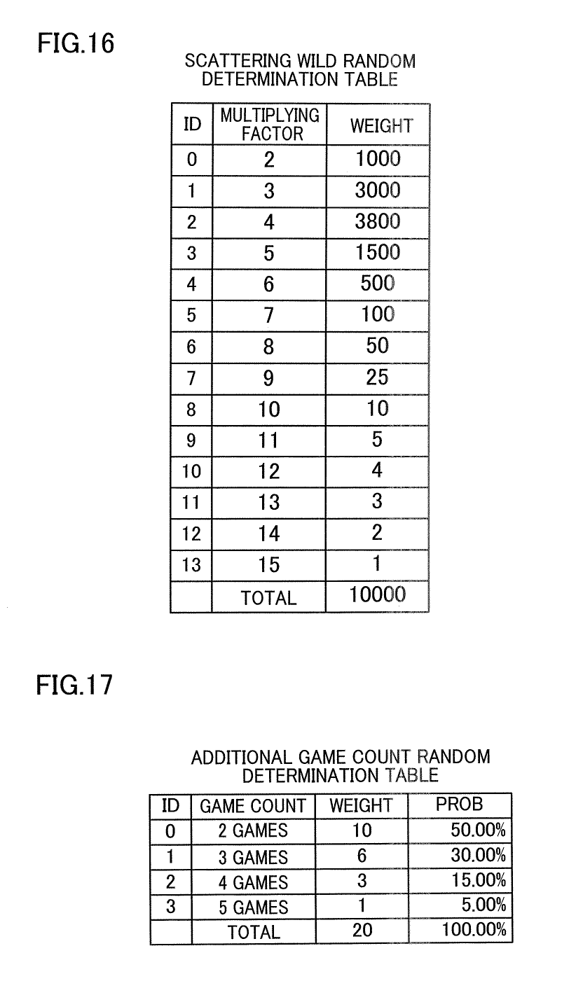

When the “scattering wild” or the “payout rate & scattering wild” is selected as the generated bonus in the mystery mermaid free game, a scattering wild count selection process is executed, in which the count of wild symbols to be scattered in the 15 display blocks 28 during the free game is selected by using the scattering wild random determination table shown in FIG. 16. The scattering wild random determination table is a table in which weights are set for 14 different counts, i.e., “2” to “15”. The weights indicate the probabilities of the 14 different counts being selected in the scattering wild count selection process. In the present embodiment, weights for the 14 different counts are made different from one another. For example, the weight of “2” being is 1000, while the weight of the “15” is 1.

(Additional Game Count Random Determination Table)

When the “additional game count” is selected as the generated bonus in the mystery mermaid free game, an additional game count selection process is executed, in which any one of four game counts which are the number of the additional free games is selected by using an additional game count random determination table shown in FIG. 17. The additional game count random determination table is a table in which weights are set for 4 different additional game counts, i.e., “2 games”, “3 games”, “4 games”, and “5 games”. The weights indicate the probabilities of the 4 different additional game counts being selected in the additional game count selection process. In the present embodiment, the weights for the four different additional game counts are made different from one another. For example, the probability of “2 games” being selected is 50%, while the probability of “5 games” being selected is 5%.

(Wild Reel Random Determination Table and Scattering Wild Random Determination Table)

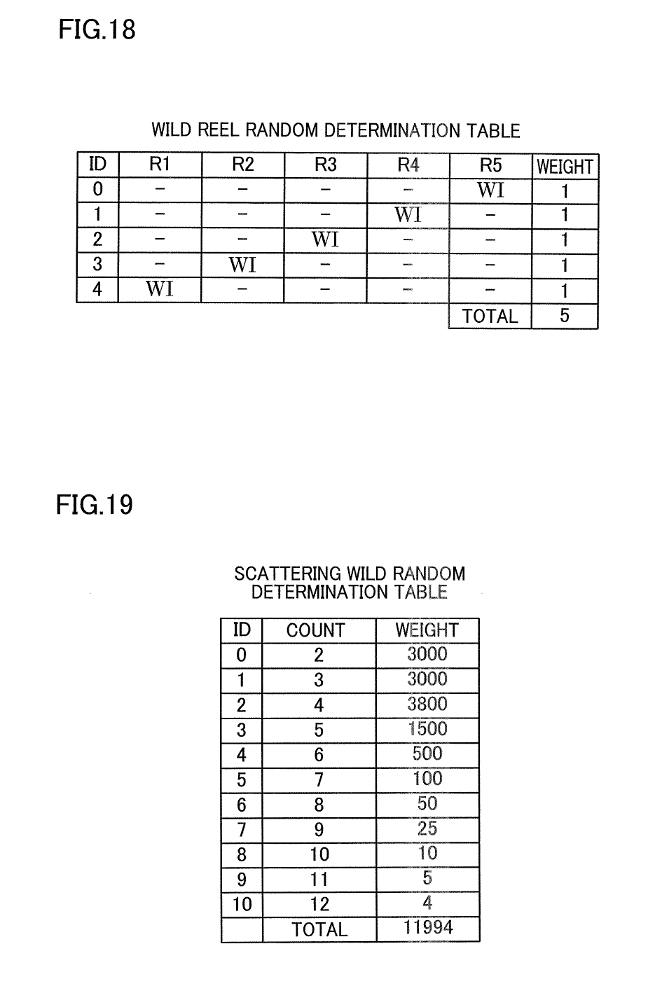

When the “wild reel & scattering wild” is selected as the generated bonus in the mystery mermaid free game, the wild reel selection process of selecting a reel to be changed to the wild reel during the free game, and a wild count selection process of selecting the count of wild symbols to be scattered in the 15 display blocks 28 during the free game are executed by using the wild reel random determination table shown in FIG. 18 and the scattering wild count random determination table shown in FIG. 19.

The wild reel random determination table is a table in which weights are set for 5 combinations, i.e., No. 0 to No. 4. In each combination, either one of “WI” and “-” is assigned to five reels. The “WI” indicates the reel is changed to a wild reel. The “-” indicates the reel is not changed to a wild reel. The weights indicate the probabilities of the 5 combinations being selected in the wild reel selection process. The present embodiment deals with a case where the same weight is set for the 5 combinations.

The scattering wild random determination table is a table in which weights are set for 11 different counts, i.e., “2” to “10”. The weights indicate the probabilities of the 11 different counts being selected in the scattering wild count selection process. In the present embodiment, weights for the 11 different counts are made different from one another. For example, the weight of “2” being is 3000, while the weight of the “12” is 4.

(Big Bubble Bonus Payout Amount Random Determination Table)

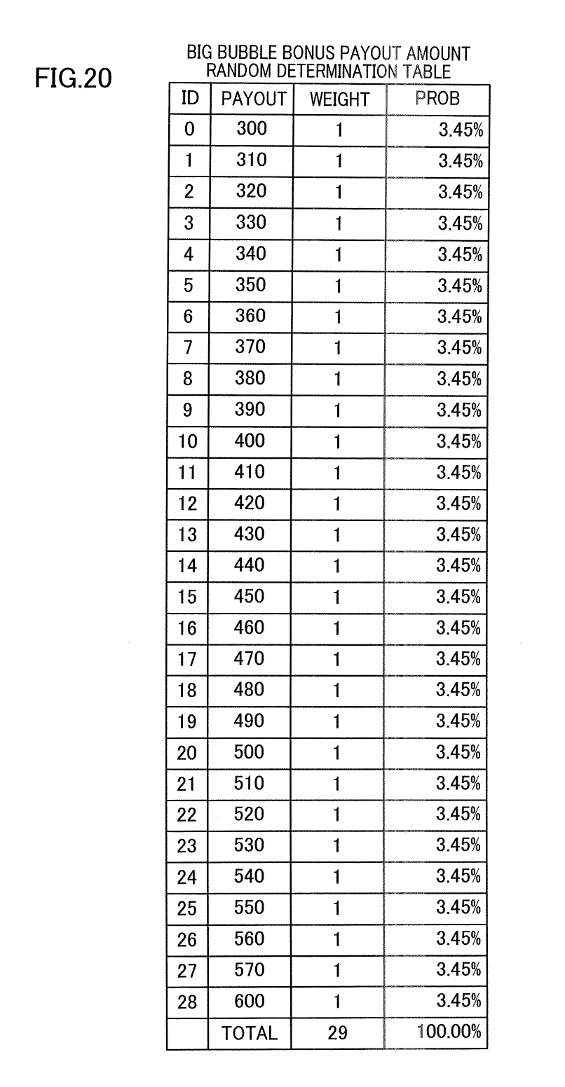

In the big bubble bonus which is a type of the wheel bonus, a payout amount determination process for determining a payout amount is executed by using a big bubble bonus payout amount random determination table shown in FIG. 20. The big bubble bonus payout amount random determination table is a table in which weights are set for 29 payout amounts, i.e., “300” to “600”. The weights indicate the probabilities of the 29 payout amounts being selected in the payout amount determination process. In the present embodiment, the same weight is set for the 29 payout amounts.

(Repeated Stroke Count Random Determination Table)

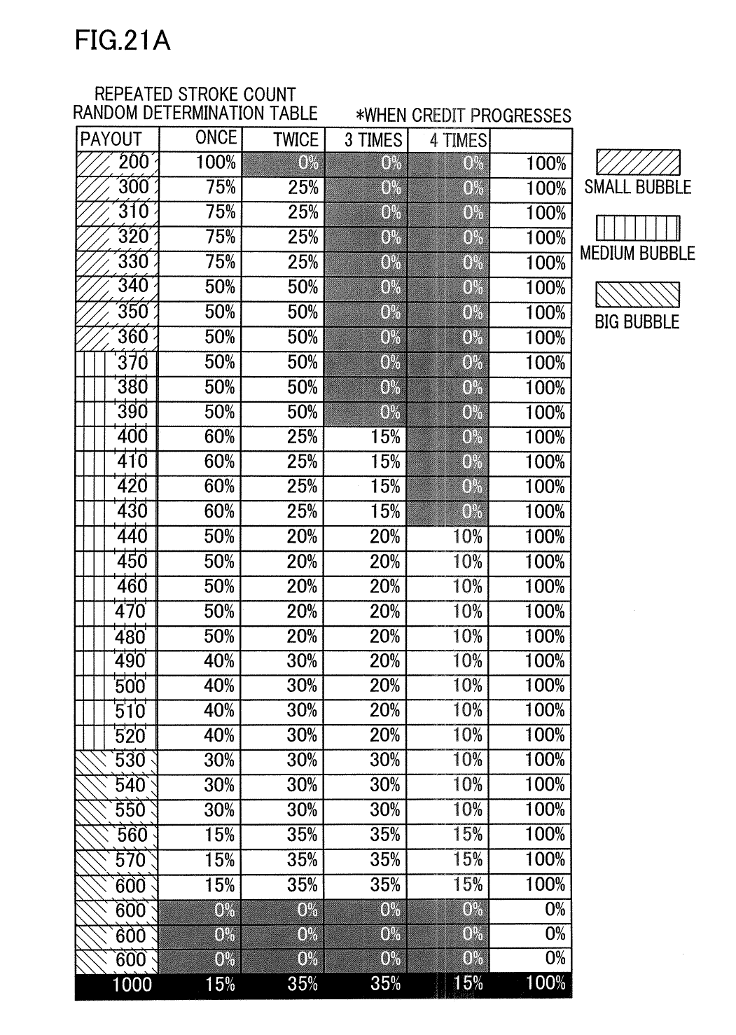

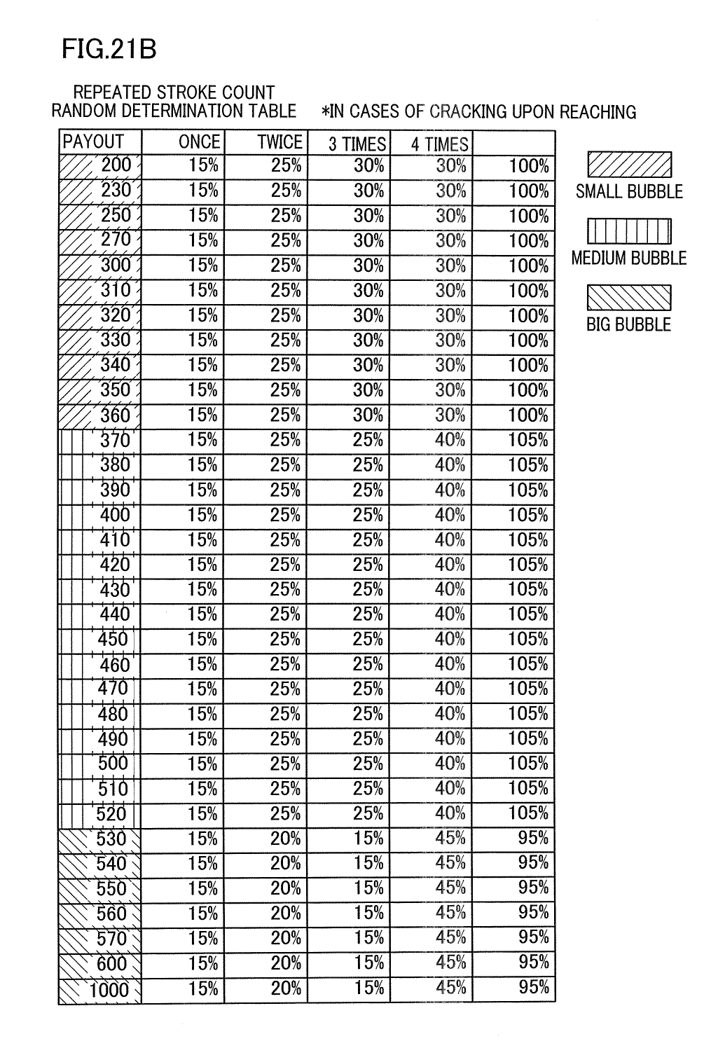

In the big bubble bonus, a repeated stroke count selection process is executed, in which the number of repeatedly stroking the spin button 46 necessary for increasing the credit is determined by using a repeated stroke count random determination table shown in FIG. 21A. Further, the repeated stroke count selection process is executed, in which the number of repeatedly stroking the spin button 46 necessary for cracking the bubble is determined by using a repeated stroke count random determination table shown in FIG. 21B. The two repeated stroke count random determination tables are each a table in which the probabilities for repeated stroke counts of 1 to 4 are set for payout amounts of “200” to “600”. For example, where the payout amount is “300”, the probability of credit increasing is 75% and the probability of the bubble cracking is 15%, when the count of repeated stroke is 1. For example, where the payout amount is “500”, the probability of a bubble inflating is 40% and the probability of the bubble cracking is 15%, when the count of repeated stroke is 1.

(Swimming Mermaid Bonus Payout Amount Random Determination Table)

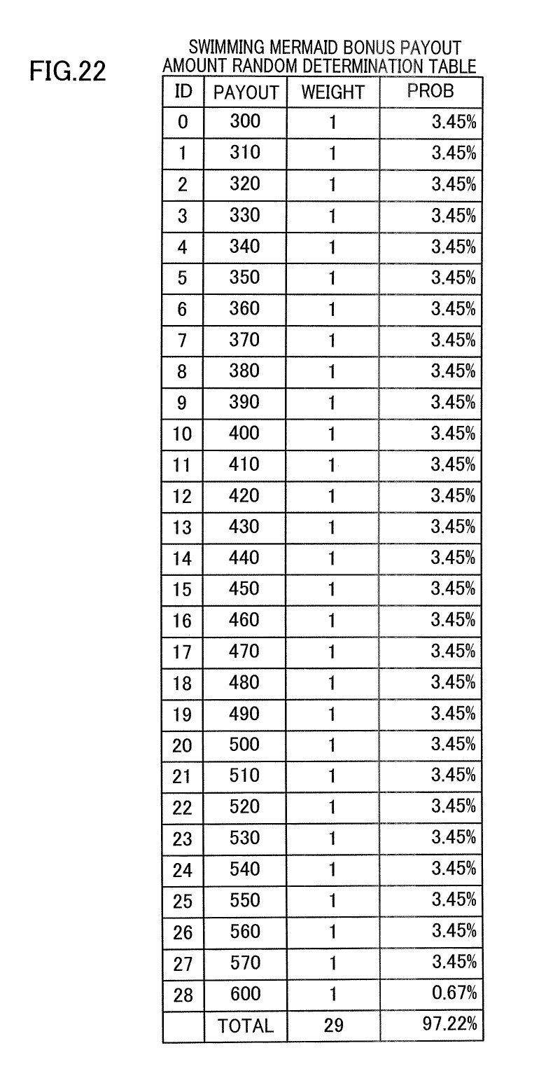

In the swimming mermaid bonus which is a type of the wheel bonus, a payout amount determination process for determining a payout amount is executed by using a swimming mermaid bonus payout amount random determination table shown in FIG. 22. The swimming mermaid bonus payout amount random determination table is a table in which weights are set for 29 payout amounts, i.e., “300” to “600”. The weights indicate the probabilities of the 29 payout amounts being selected in the payout amount determination process. In the present embodiment, the weights for the 29 payout amounts are made different from one another. For example, the probability of “300” being selected is 3.45%, while the probability of “600” being selected is 0.67%.

(Sorting Patterns)

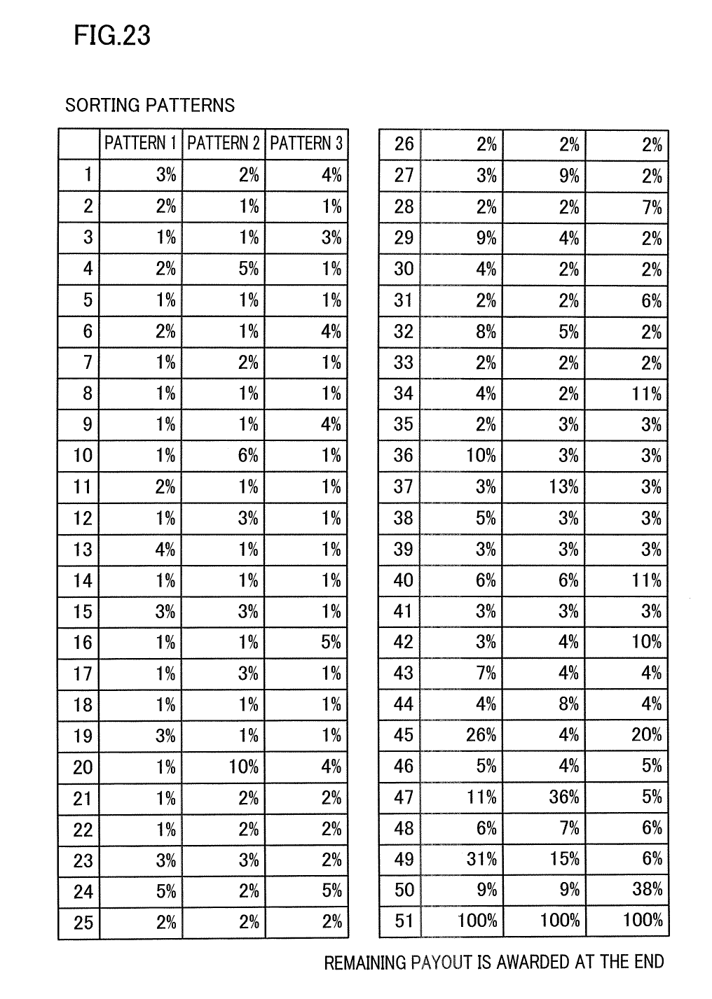

In the swimming mermaid bonus, the sorting patterns shown in FIG. 23 are used to determine a pattern of increase in the credit. It should be noted that these sorting patterns are also used in the pop-the-bubble bonus. There are three types of sorting patterns, and the percentage of credit to be increased every time the mermaid gets a coin is sorted to the first coin to the treasure box at the end. The credit increases every time the mermaid gets a coin, according to the sorting pattern, and the remaining amount of the payout determined is decreased. For example, when the pattern is pattern 1, the credit obtained by getting the first coin is 3% of the payout amount (remaining amount) determined. It should be noted that the digit in the one's place is rounded down, and if the digit in the ten's place is 0 as the result of rounding down, the credit will be 5. For example, where the remaining amount is 650 and the 10% of it is sorted, 650×12% is 78. The digit in the one's place of 78 is rounded down, resulting in credit of 70. Further, where the remaining amount is 340 and the 2% of it is sorted, 340×2% is 6.8. Since rounding down the digit in the one's place of 6.8 results in 0, the credit will be 5. The credit obtained by the treasure box at the end is 100% of the remaining amount.

(Pop-the-Bubble Bonus Payout Amount Random Determination Table)

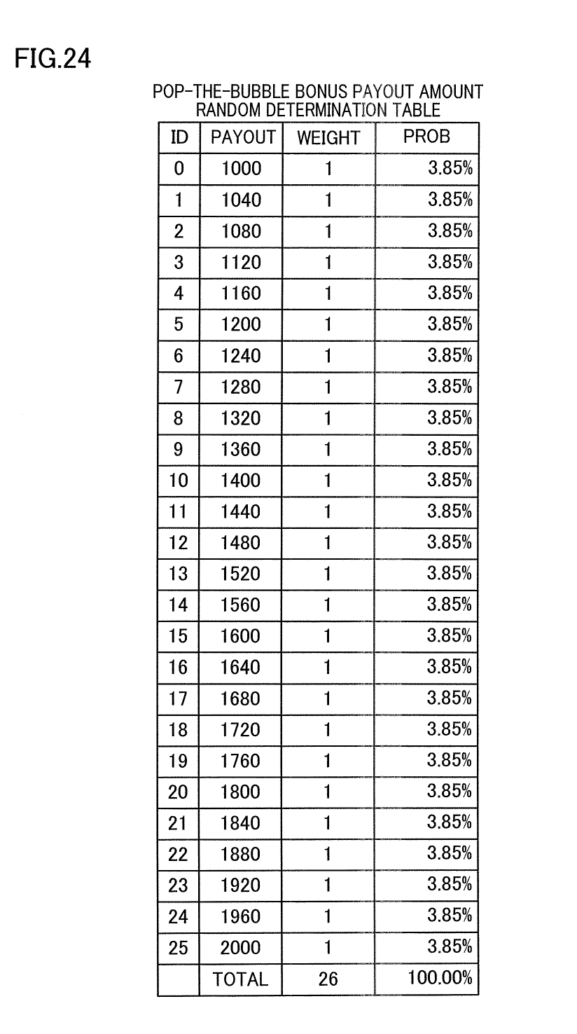

In the pop-the-bubble bonus which is a type of the wheel bonus, a payout amount determination process for determining a payout amount is executed by using a pop-the-bubble bonus payout amount random determination table shown in FIG. 24. The pop-the-bubble bonus payout amount random determination table is a table in which weights are set for 26 payout amounts, i.e., “1000” to “2000”. The weights indicate the probabilities of the 26 payout amounts being selected in the payout amount determination process. In the present embodiment, the same weight is set for the 26 payout amounts.

(3-Choice Table)

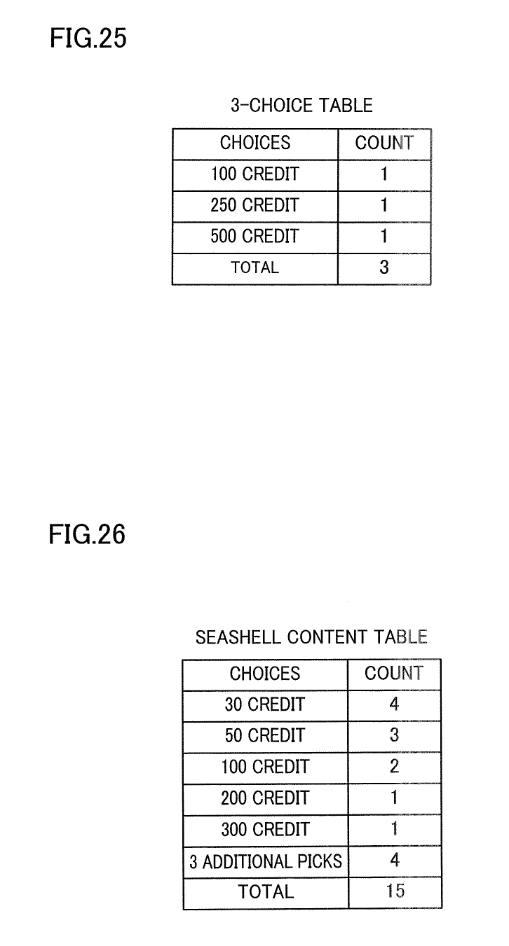

In the pop-the-bubble bonus, choices of three bubbles are given, and the payout amount to be awarded at the end is determined based on the selection of any of the three bubbles, using a 3-choice table shown in FIG. 25. In the 3-choice table, three payout amounts, i.e., “100 credit”, “250 credit”, “500 credit” are associated with three bubbles, respectively.

(Seashell Content Table)

In the seashell-pick bonus which is a type of the wheel bonus, seashell contents are determined for each of the 15 seashells, using the seashell content table shown in FIG. 26. In the seashell content table, out of 15 seashells, the “30 credit” is associated with 4 shells, the “50 credit” is associated with 3 seashells, the “100 credit” is associated with 2 seashells, the “200 credit” is associated with 1 seashell, the “300 credit” is associated with 1 seashell, and the “additional 3 picks” is associated with 4 seashells.

(Mystery Feature Generation Random Determination Table)

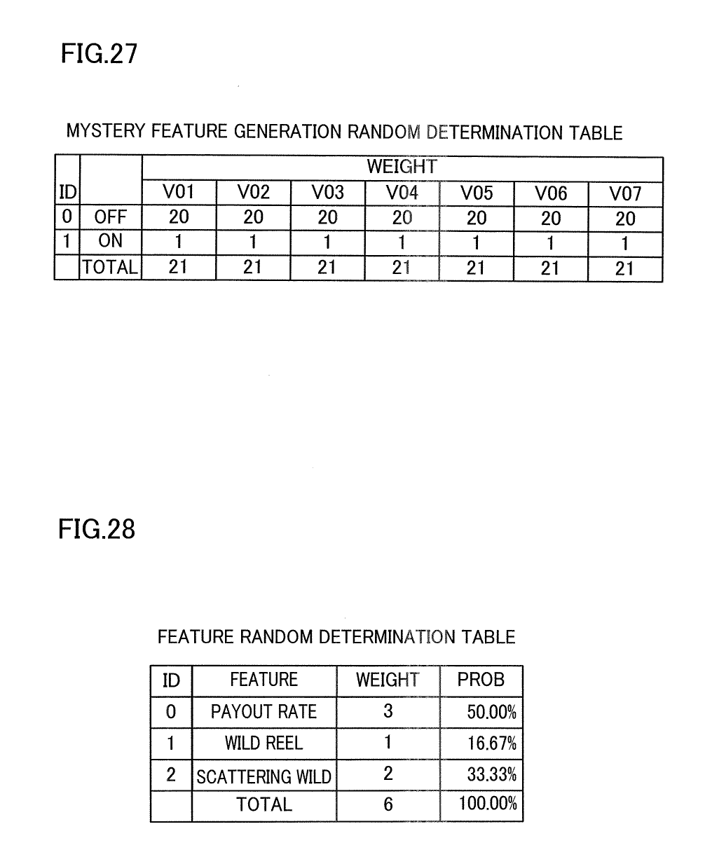

As described, if no “BONUS” symbol is displayed on the third reel, the mystery feature may be generated. When the mystery feature trigger is established, whether to generate the mystery feature is determined by using the mystery feature generation random determination table shown in FIG. 27. The probability of the mystery feature being generated is 1/21.

(Feature Random Determination Table)

In the mystery feature, a feature selection process is executed, in which any one of three types of features is selected by using a feature random determination table shown in FIG. 28. The feature random determination table is a table in which weights are set for each of the three types of features. The weights indicate the probabilities of the three types of features being selected in the feature selection process. In the present embodiment, weights for the three types of features are made different from one another. For example, the probability of “payout rate” being selected is 50%, while the probability of “scattering wild” being selected is 33.33%.

When the “payout rate” is selected as the feature in the mystery feature, a multiplying factor selection process is executed, in which any one of four multiplying factors for a payout of a base game is selected by using the multiplying factor random determination table shown in FIG. 14.

When the “wild reel” or the “wild reel” is selected as the feature in the mystery feature, a wild reel selection process is executed, in which a reel to be changed to the wild reel during the base game is selected by using the wild reel random determination table shown in FIG. 15.

When the “scattering wild” is selected as the feature in the mystery feature, a scattering wild count selection process is executed, in which the count of wild symbols to be scattered during the base game is selected by using the scattering wild random determination table shown in FIG. 16.

(Control Panel 30)

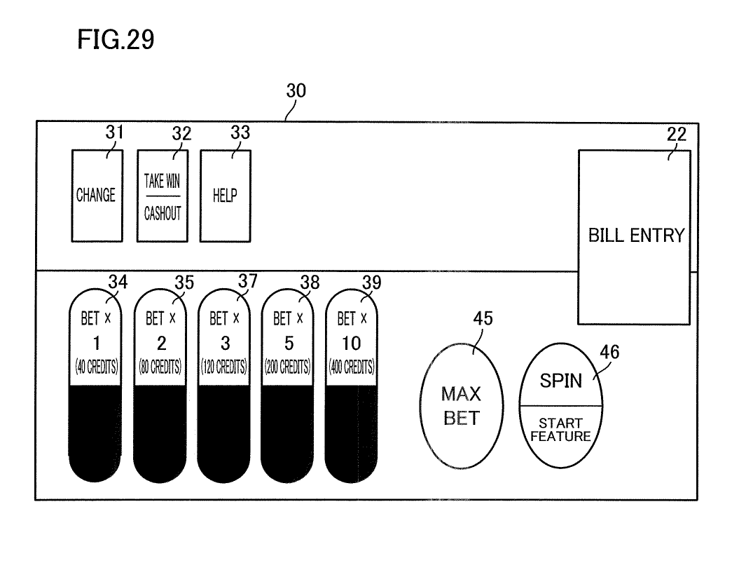

Below the lower image display panel 141, as shown in FIG. 29, a control panel 30 is provided. The control panel 30 is provided with buttons, and a bill entry 22 for inserting bills into the cabinet 11.

More specifically, on the control panel 30, a change button 31, a cash-out button 32, and a help button 33 are provided on the upper stage of the left area in front elevation, a 1-BET button 34, a 2-BET button 35, a 3-BET button 37, a 5-BET button 38, and a 10-bet button 39 are provided in the middle stage of the left area.

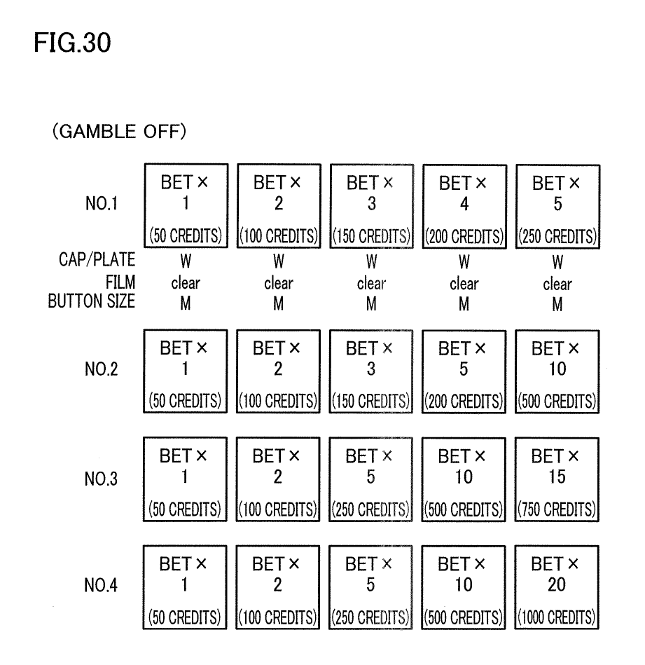

FIG. 30 shows a case where the gamble is off. FIG. 31 shows a case of gamble on.

The control panel 30 makes it possible to conduct selections in the same manner as those by the touch panel, on various types of selection screens. For example, the cursor is moved leftward as the 1-bet button 34 is touched, and the cursor is moved rightward as the 10-bet button 39 is touched. When the operation is carried out, the light source in each button is preferably turned on.

In addition to the above, on the control panel 30, the bill entry 22 is provided on the upper stage of the right side area, whereas a maximum BET button 45 and a spin button 46 are provided on the lower stage of the right area.

The change button 31 is an operation button used when a player leaves the machine or when the player requests exchanging of money to a staff person of the gaming facility. The cash-out button 32 is a so-called settlement button by which credit data concerning credits obtained in games is added to the credit data stored in an IC card inserted into the PTS terminal 700. The help button 33 is pressed when, for example, it is unclear how to play a game. As the help button 33 is pressed, various help information is displayed on the later-described lower image display panel 141.

Each time the 1-bet button 34 is pressed, one of the credits currently owned by the player is bet on each active line. The 2-bet button 35 is used to start a game with two bets. The 3-bet button 37 is used to start a game with three bets. The 5-bet button 38 is used to start a game with five bets. The 10-bet button 39 is used to start a game with ten bets. The max-bet button 45 is used to start a game with a maximum bet.

The gamble button is an operation button used for, for example, shifting to the gamble game after the end of the bonus game or the like. The gamble game here means a game run by using credit the player has won.

The spin button 46 is a button used for starting the scroll of the symbols. This spin button 46 also functions as a button for starting a bonus game and for adding a payout awarded in a bonus game to the credits. The bill entry 22 validate bills and receives genuine bills into the cabinet 11.

(Details on Operations of Control Panel 30)

The operations of the control panel 30 are changed or restricted in accordance with the content of the display screen and the operations on the lower image display panel 141.

(Details on Operations of Control Panel 30: Immediately after RAM Clear)

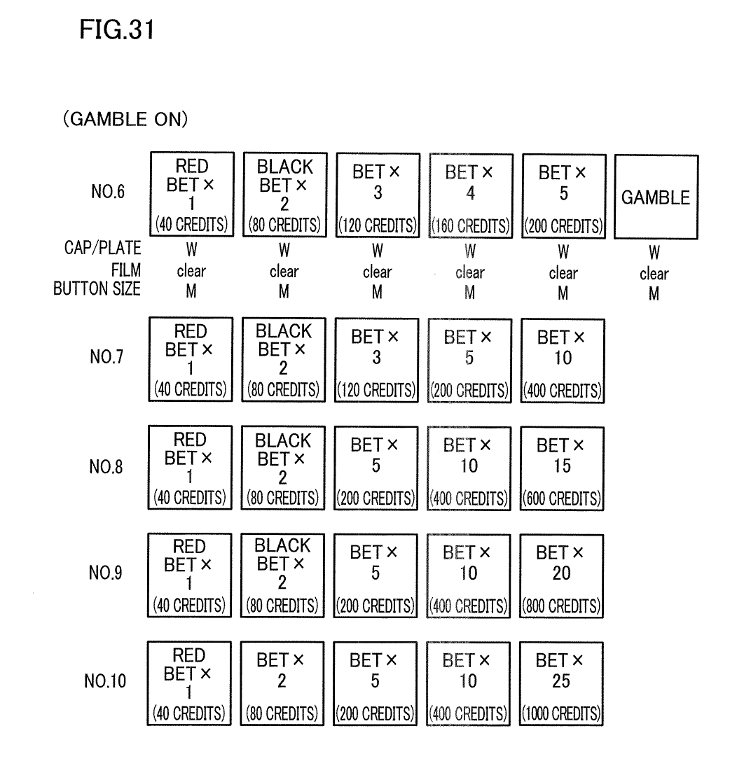

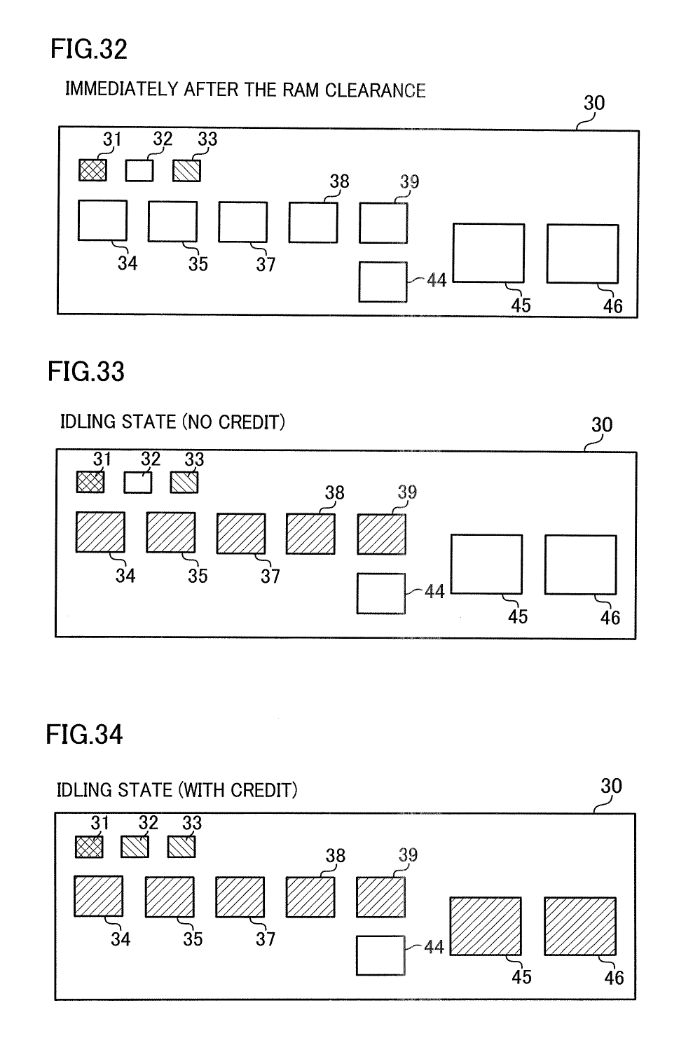

As shown in FIG. 32, the change button 31 is in the off state and disabled, and is turned on/off as pressed. The cash-out button 32 is in the off state and disabled. The help button 33 is in the on state and active. The 1-bet button 34 to 10-bet button 39 are in the off state but active. The gamble button 44 is turned off and disabled. The maximum bet button 45 is in the off state and disabled. The spin button 46 is in the off state and disabled.

The gamble button 44 appears only when GAMBLE ENABLE is set. The gamble button 44 is basically in the on state and active only when “PLAY ON, GAMBLE OR TAKE WIN” is displayed. The button is in the off state and disabled in other cases.

(Details on Operations of Control Panel 30: Idling State (No Credit))

As shown in FIG. 33, the change button 31 is in the off state but active. The button is turned on/off as pressed. The cash-out button 32 is in the off state but active. The help button 33 is in the on state and active. The 1-bet button 34 to 10-bet button 39 are in the off state or are in the on state and active. In other words, these buttons retain the state of the previous game play. The gamble button 44 is in the off state but active. The maximum BET button 45 is in the off state but active. The spin button 46 is in the off state but active.

(Details on Operations of Control Panel 30: Idling State (with Credit))

As shown in FIG. 34, the change button 31 is in the off state but active. The button is turned on/off as pressed. The cash-out button 32 is in the on state and active. The help button 33 is in the on state and active. The 1-bet button 34 to 10-bet button 39 are in the off state or are in the on state and active. In other words, these buttons retain the state of the previous game play. The gamble button 44 is turned off and disabled. The maximum BET button 45 is turned on when MAX BET is possible, and a game starts with “MAX BET” when the button pressed. When the credits are less than MAX BET, the button is turned on, and the maximum credits bettable are selected when the button is pressed. When the credit is less than the amount for one bet, the button is in the off state and disabled. The spin button 46 is in the on state and active in a bet pattern in which the remaining credits are selected. When the remaining credit<the selected bet pattern, the button is in the off state and disabled.

(Details on Operations of Control Panel 30: Spin Button 46 Long Pressing Play)

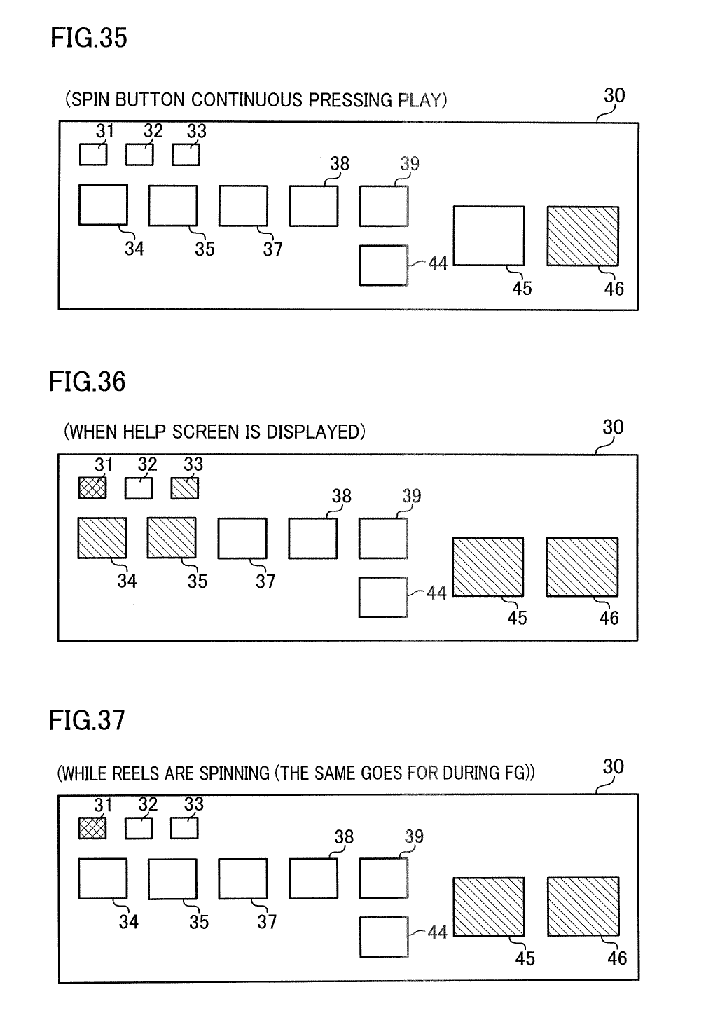

As shown in FIG. 35, auto bet starts as the spin button 46 is continuously pressed. The maximum bet button 45 is in the off state and disabled. The other buttons are in the off state and disabled. The auto bet function (button) is the operation identical with those during the reel spin and the WIN increment. However, during the WIN increment, the next game starts rather than the GAME OVER, when the illuminated button is pressed. The button operation when a payout occurs is identical with that of the WIN increment. The button operation when losing in the game is identical with the operation during the reel spin. When the feature is waited for, it is necessary to press the bottom at the time of the pressing of the spin button 46.

(Details on Operations of Control Panel 30: While Help Screen is Displayed)

As shown in FIG. 36, the change button 31 is in the off state but active. The button is turned on/off as pressed. The cash-out button 32 is in the off state and disabled. The help button 33 is in the on state and active. The help ends when the button is pressed. The 1-bet button 34 is in the on state and active. The next page of the help screen is displayed when the button is pressed. The 2-bet button 35 is in the on state and active. The previous page of the help screen is displayed when the button is pressed. The maximum bet button 45 is in the on state and active. The help ends when the button is pressed. The spin button 46 is in the on state and active. The help ends when the button is pressed. The other buttons are in the off state and disabled.

(Details on Operations of Control Panel 30: While Reels are Spinning (the Same Applies to Free Games))

As shown in FIG. 37, the change button 31 is in the off state but active. The button is turned on/off as pressed. The cash-out button 32 is in the off state and disabled. The help button 33 is in the off state and disabled. The maximum bet button 45 is in the on state and active. Quick stop is executed when the button is pressed. The spin button 46 is in the on state and active. Quick stop is executed when the button is pressed. The other buttons are in the off state and disabled.

(Details on Operations of Control Panel 30: While Cancellable Effect Screen is Displayed)

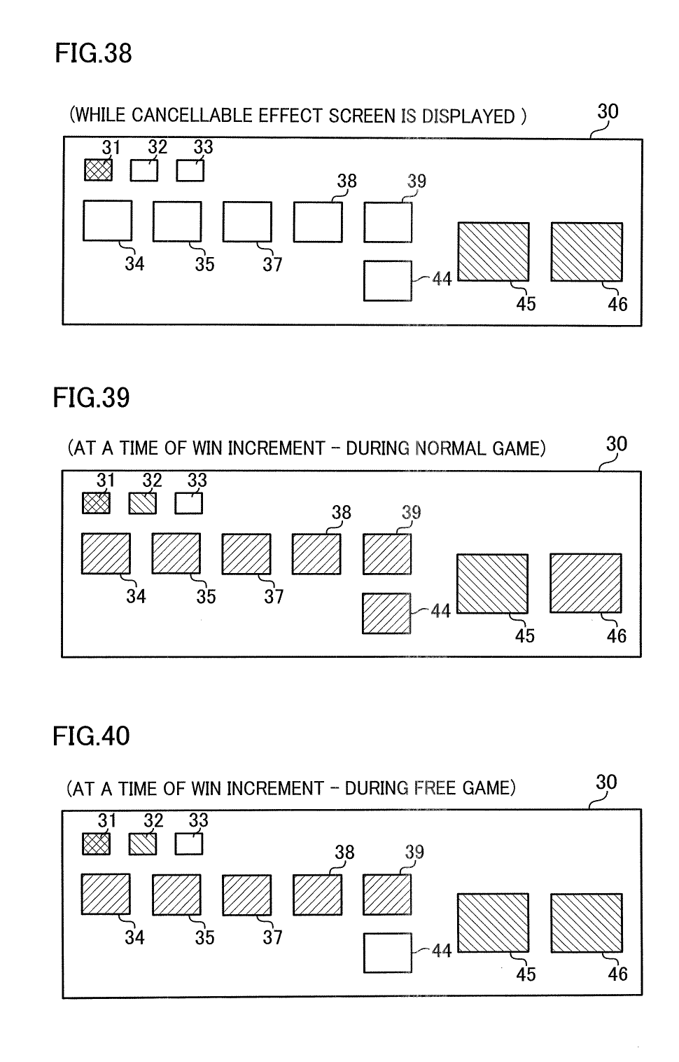

As shown in FIG. 38, the change button 31 is in the off state but active. The button is turned on/off as pressed. The cash-out button 32 is in the off state and disabled. The help button 33 is in the off state and disabled. The maximum bet button 45 is in the on state and active. The effect is canceled when the button is pressed. The spin button 46 is in the on state and active. The effect is canceled when the button is pressed. The other buttons are in the off state and disabled.

(Details on Operations of Control Panel 30: At a Time of Win Increment—During Normal Game)

As shown in FIG. 39, the change button 31 is in the off state but active. The button is turned on/off as pressed. The cash-out button 32 is in the on state and active. The increment is canceled when the button is pressed. The help button 33 is in the off state but active. The 1-bet button 34 to the 10-bet button 39 are in the off state or are in the on state and active. The increment is canceled when one of the buttons is pressed, leading to GAME OVER, and the selected bet is turned on. In other words, these buttons retain the state of the previous game play. Note that the bet buttons are turned off or turned on, and are active. The increment may be canceled when one of the buttons is pressed, leading to GAME OVER. The maximum bet button 45 is in the on state and active. The increment is canceled when the button is pressed, and the processes from Take WIN to GAME OVER are executed. The spin button 46 is in the on state and active. The increment is canceled when the button is pressed, and the processes from Take WIN to GAME OVER are executed. When credits allowing repeat bet are retained, the next game starts. The spin button 46 may be in the on state and active, and the increment may be canceled when pressed, leading to GAME OVER. The gamble button 44 is in the on state and active when Gamble is active. The increment is canceled when the button is pressed, and a gamble screen is displayed. The button is in the off state and disabled when Gamble is disabled.

(Details on Operations of Control Panel 30: At a Time of Win Increment—During Free Game)

As shown in FIG. 40, the change button 31 is in the off state but active. The button is turned on/off as pressed. The cash-out button 32 is in the on state and active. The next game starts when the number of remaining games is not zero. When the number of remaining games is zero, the shifting to a total WIN signboard is executed. The help button 33 is in the off state and disabled. The 1-bet button 34 to 10-bet button 39 are in the off state or are in the on state and active. Each button is turned on only at the time of betting with the triggering of a free game. The next game starts when the number of remaining games is not zero. When the number of remaining games is zero, the shifting to a total WIN signboard is executed. The maximum bet button 45 is in the on state and active. The next game starts when the number of remaining games is not zero. When the number of remaining games is zero, the shifting to a total WIN signboard is executed. The spin button 46 is in the on state and active. The next game starts when the number of remaining games is not zero. When the number of remaining games is zero, the shifting to a total WIN signboard is executed. The gamble button 44 is turned off and disabled.

(Details on Operations of Control Panel 30: After Winning in Free Game, at a Time of Trigger Payout Increment)

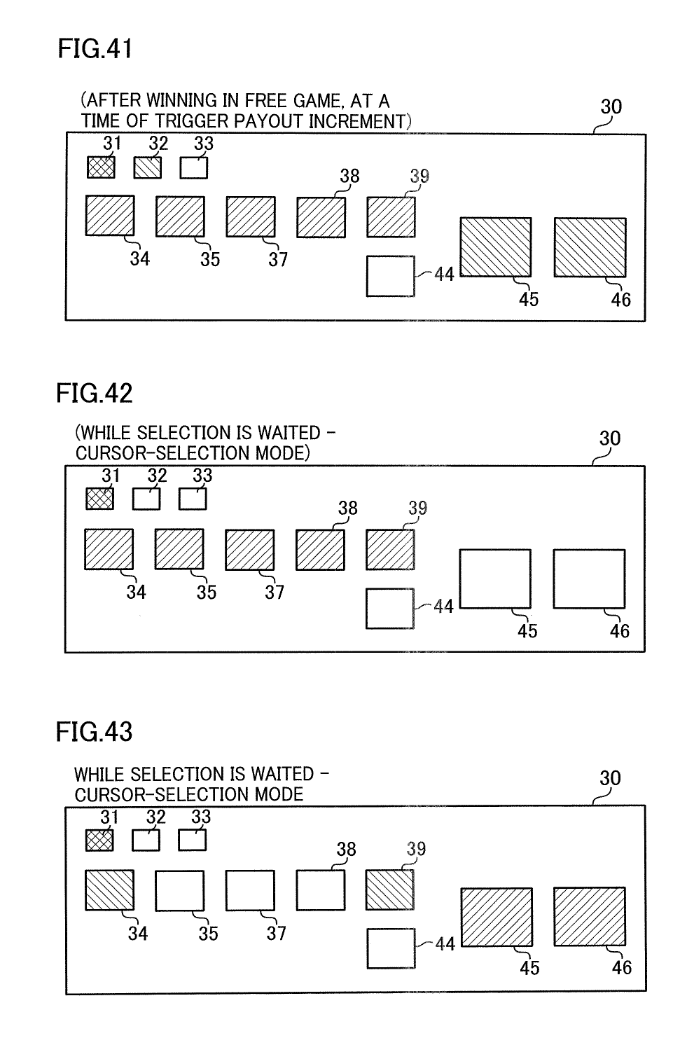

As shown in FIG. 41, the change button 31 is in the off state but active. The button is turned on/off as pressed. The cash-out button 32 is in the on state and active. The increment is canceled when the button is pressed, and the shifting to the next step is executed. The help button 33 is in the off state and disabled. The 1-bet button 34 to 10-bet button 39 are in the off state or are in the on state and active. Each button is turned on only at the time of betting with the triggering of a free game. The increment is canceled when the button is pressed, and the shifting to the next step is executed. The maximum bet button 45 is in the on state and active. The increment is canceled when the button is pressed, and the shifting to the next step is executed. The spin button 46 is in the on state and active. The increment is canceled when the button is pressed, and the shifting to the next step is executed. The gamble button 44 is turned off and disabled.

(Details on Operations of Control Panel 30: While Selection is Waited—Control Panel 30 Direct Selecting Mode)

As shown in FIG. 42, the change button 31 is in the off state but active. The button is turned on/off as pressed. The cash-out button 32 is in the off state and disabled. The help button 33 is in the off state and disabled. The 1-bet button 34 to the 10-bet button 39 are in the on state and active when allocated to selection buttons. The buttons are in the off state and disabled when not allocated to selection buttons. The maximum bet button 45 is in the off state and disabled. The spin button 46 is in the off state and disabled. The gamble button 44 is turned off and disabled.

(Details on Operations of Control Panel 30: While Selection is Waited—Cursor-Selection Mode)

As shown in FIG. 43, the change button 31 is in the off state but active. The button is turned on/off as pressed. The cash-out button 32 is in the off state and disabled. The help button 33 is in the off state and disabled. The 1-bet button 34 is in the on state and active. The cursor is moved to the next option when the button is pressed. The 10-bet button 39 is in the on state and active. The cursor is moved to the next option when the button is pressed. The maximum bet button 45 is in the on state and active when an icon is selected by the cursor. When no icon is selected by the cursor, the button is in the off state and disabled. The spin button 46 is in the on state and active when an icon is selected by the cursor. When no icon is selected by the cursor, the button is in the off state and disabled. The gamble button 44 is turned off and disabled.

(Details on Operations of Control Panel 30: After Free Game, when Total Win Signboard is Displayed)

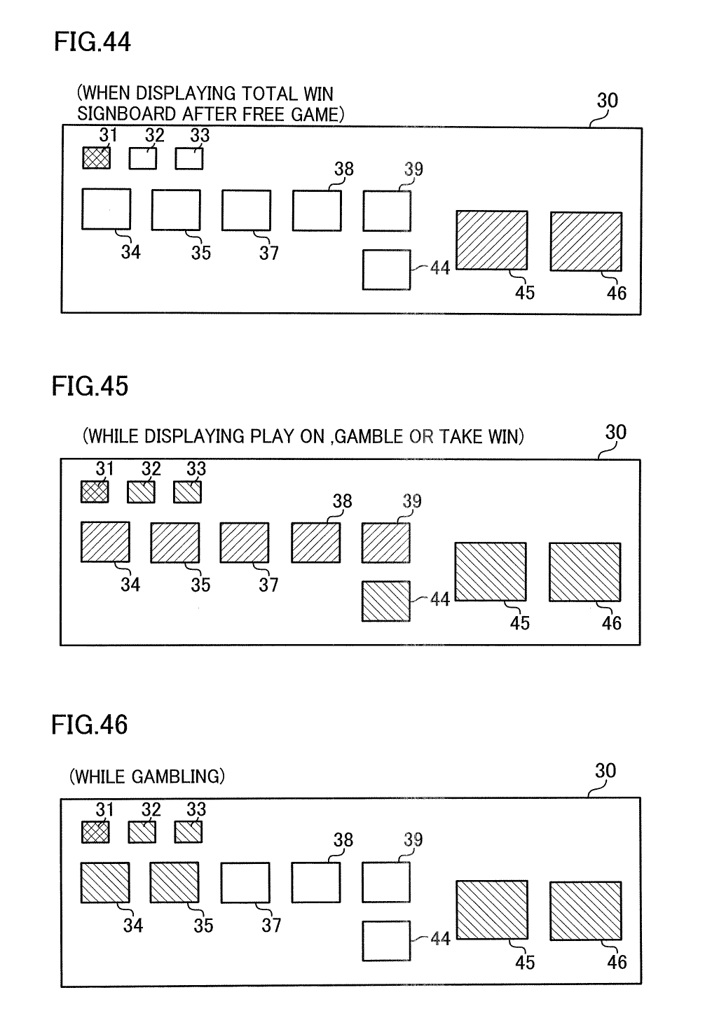

As shown in FIG. 44, the change button 31 is in the off state but active. The button is turned on/off as pressed. The cash-out button 32 is in the off state and disabled. The help button 33 is in the off state and disabled. The maximum bet button 45 is in the off state and disabled until four seconds elapse. The button is in the on state and active after four seconds elapses. The spin button 46 is in the off state and disabled until four seconds elapse. The determination is confirmed when the button is pressed. The button is in the on state and active after four seconds elapses. The increment is canceled when the button is pressed. The gamble button 44 is turned off and disabled.

(Details on Operations of Control Panel 30: While PLAYON, GAMBLE, or TAKE WIN is Displayed)

As shown in FIG. 45, the change button 31 is in the off state but active. The button is turned on/off as pressed. The cash-out button 32 is in the on state and active. Take WIN and GAME OVER are conducted when the button is pressed. The help button 33 is in the on state and active. The help is displayed when the button is pressed. The 1-bet button 34 to 10-bet button 39 are in the off state or are in the on state and active. In other words, these buttons retain the state of the previous game play. Take WIN and GAME OVER are conducted when the button is pressed. The maximum bet button 45 is in the on state and active. The increment is canceled when the button is pressed and the GAME OVER is executed. The spin button 46 is in the on state and active. Take WIN and GAME OVER are conducted when the button is pressed. Then the next game starts. The increment may be canceled and the GAME OVER may be executed when the spin button 46 is pressed. The gamble button 44 is in the on state and active. Gamble is executed when the button is pressed.

(Details on Operations of Control Panel 30: During Gamble)

As shown in FIG. 46, the change button 31 is in the off state but active. The button is turned on/off as pressed. The cash-out button 32 is in the on state and active. Take WIN and GAME OVER are conducted when the button is pressed. The help button 33 is in the on state and active. The help is displayed when the button is pressed. The 1-bet button 34 is in the on state and active. Red is selected when the button is pressed. The 2-bet button 35 is in the on state and active. Black is selected when the button is pressed. The maximum bet button 45 is in the on state and active. Take WIN and GAME OVER are conducted when the button is pressed. The spin button 46 is in the on state and active. Take WIN is conducted when the button is pressed, and the next game starts. Take WIN and GAME OVER may be conducted when the spin button 46 is pressed. The other buttons are in the off state and disabled.

(Details on Operations of Control Panel 30: During Residual Gamble)

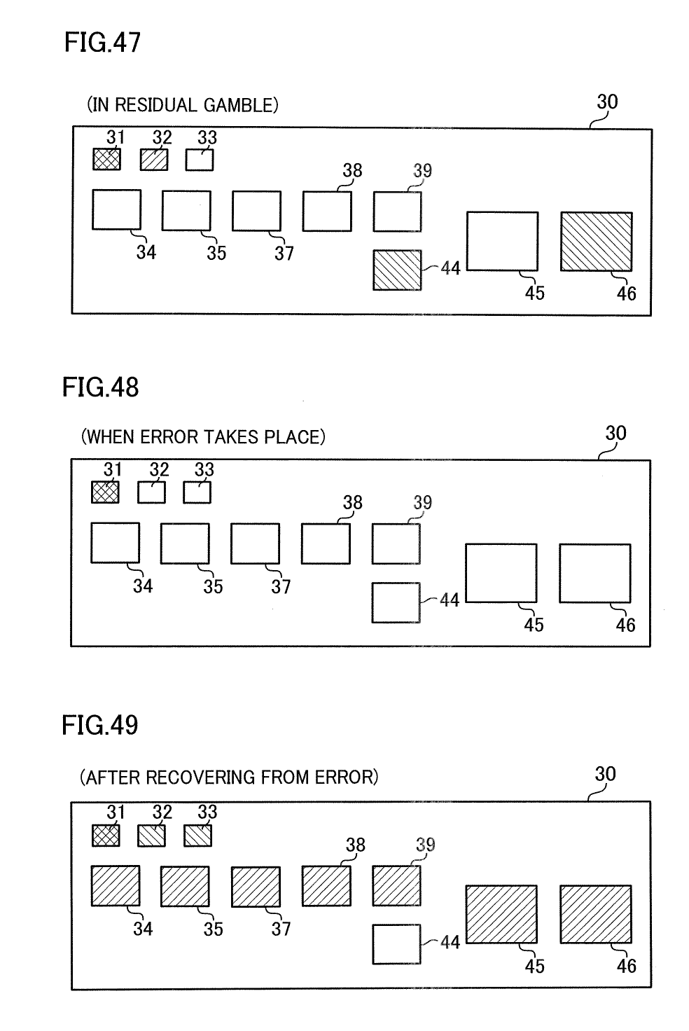

As shown in FIG. 47, the change button 31 is in the off state but active. The button is turned on/off as pressed. The cash-out button 32 is in the on state and active in case of GAMBLE-ODD SUM.

ATTENDANT PAY is conducted when the button is pressed. The button is in the off state and disabled in case of GAMBLE-NONE. The help button 33 is in the off state and disabled. The maximum bet button 45 is in the off state and disabled. The spin button 46 is in the on state and active. The normal game comes back when the button is pressed. The gamble button 44 is in the on state and active. RESIDUAL GAMBLE starts when the button is pressed. The other buttons are in the off state and disabled.

(Details on Operations of Control Panel 30: When Error Occurs)

As shown in FIG. 48, the change button 31 is in the off state but active. The button is turned on/off as pressed. The cash-out button 32 is in the off state and disabled. The other buttons are in the off state and disabled.

(Details on Operations of Control Panel 30: After Clearing Error)

As shown in FIG. 49, the change button 31 is in the off state and disabled. The button remains in the off state but active after 120 seconds elapses. The cash-out button 32 is in the on state and active. The help button 33 is in the on state and active. The 1-bet button 34 to 10-bet button 39 are in the off state or are in the on state and active. In other words, these buttons retain the state of the previous game play. The gamble button 44 is turned off and disabled. The maximum BET button 45 is turned on when MAX BET is possible, and a game starts with “MAX BET” when the button pressed. When the credits are less than MAX BET, the button is turned on, and the maximum credits bettable are selected when the button is pressed. When the credits are less than the amount for one bet, the button is in the off state and disabled. The spin button 46 is in the on state and active when the remaining credits>selected bet pattern. The button is in the off state and disabled when the remaining credits<selected bet pattern.

(Display Screens of Wheel 131 and Lower Image Display Panel 141)

An example of the display screens of the wheel 131 and the lower image display panel 141 in the operation process of the slot machine 1 above will be specifically described.

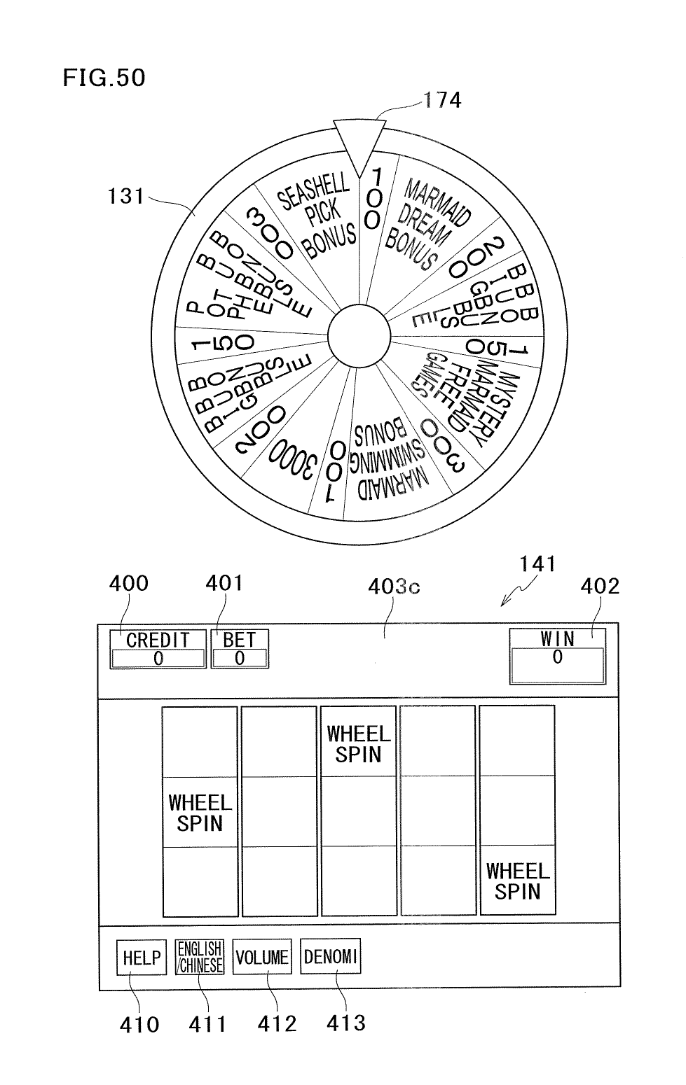

FIG. 50 shows image display on the wheel 131 and the lower image display panel 141 in a normal mode. The surface of the wheel 131 is parted into 16 areas, of which 9 areas associate with 5 types of fixed payouts, and 7 areas associate with 6 types of bonuses. The wheel 131 does not rotate during a base game. The wheel 131 rotates when the bonus trigger is established, and stops in such a manner that the pointer 174 points an area corresponding to a type of bonus selected.

The lower image display panel 141 has, at its upper part, a credit meter 400, a bet meter 401, and a win meter 402. Between the bet meter 401 and the win meter 402, a system font area 403c is provided. Furthermore, the lower image display panel 141 has, at its lower part, a help touch button 410, a language switching touch button 411, a sound volume switching touch button 412, and a denomination button 413.

The system font area 403c displays bet information and a game state. That is to say, the system font area 403c displays bet information of the game (or the last game).

The help touch button 410 displays the first page of the help screen when touched. The help touch button is darkened when it is inactivated, e.g., during the rotation of the reels. The game screen games back upon touching again. As the language switching touch button 411 is touched, the language is switched between English and Chinese. The button is active only during the advertisement. The help touch button is darkened when it is inactivated, e.g., during the rotation of the reels. By setting the AUDIT, the displayed national flags are changed to “Britain/China” or “United States/China”. When the switching of the language is set at “DISABLE”, a “PAYTABLE” button is displayed. In other words, the button is changed to a button displaying a payout table for help. The game screen games back upon touching again. The button is “RESCUE RULES” in an NSW version model. In other words, the button is changed to one that displays a first page of RESCUE page of the help. The sound volume switching touch button 412 is used for switching the game sound volume in three stages. Each time the button is touched, the game sound volume is switched such that, for example, from low to middle to high to small to middle. The denomination button 413 displays the current denomination. Denomination setting range is $0.10 to 10, and recommended denomination is $0.01. Details will be given later.

(Display Screen: Normal Game Screen)

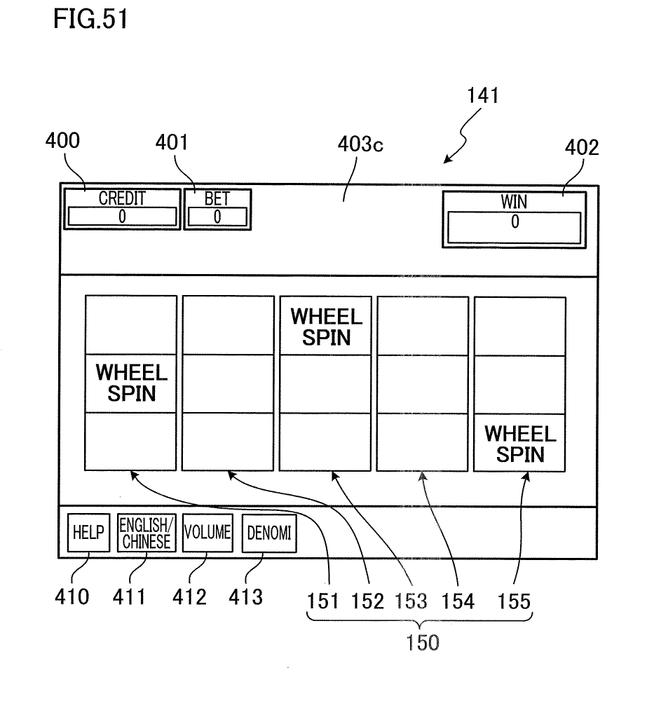

FIG. 51 shows an example of a base game screen which is the display screen of the normal game.

Specifically, the normal game screen is arranged in the central portion, and has a display window 150 including 5 columns of pseudo reels 151 to 155. In the machines of NGCB version, the way bet pattern is 1024 ways only. In machines of SABS or MACAU version, the way bet pattern is able to be changed depending on the selected region. More specifically, in this case, 4 ways is associated with a region 1, 16 ways is associated with a region 2, 64 ways is associated with a region 3, 256 ways is associated with a region 4, and 1024 ways is associated with a region 5.

Above the display window 150, a credit meter 400, a bet meter 401, and a win meter 402. The credit meter 400 and the bet meter 401 are displayed at the left end portion when viewed from the player. In the meanwhile, the win meter 402 is provided at the right end portion when viewed from the player. Between the bet meter 401 and the win meter 402, a system font area 403c is provided. The system font area 403c has, in an upper stage and a lower stage, a bet information display region 403a and a game state display region 403b, respectively.

The credit meter 400 displays the total credit amount. The default value is 0. The value is increased and decreased as follows: When “take WIN”, which indicates winning in a game, is achieved, the credit won in the game is added to the credit meter. When a game is played, the bet number is subtracted from the credit meter. The bet number is also subtracted when the collect ends.

The bet meter 401 displays “Total Bets”. The value is re-calculated in each game play. The win meter 402 displays the total obtained credits in an increment manner. The default value is 0. Every credit amount displayed on the WIN meter 402 is the actual credit amount obtained, which is calculated by multiplying a payout amount by the BET PER REEL value.

The bet information display region 403a displays the bet information of a game (or the last game). In the first line, the bet amount per way is displayed. The display content is either singular or plural in line with the bet amount. Specifically, in the first line, displayed is “BET MULTIPLIER 1”, for example. The game state display region 403b displays a current state of the game. A state display message is not displayed during the game, and the message “GAME OVER” is displayed when the game is over. When Gamble is waited for, “PLAY ON, GAMBLE or TAKE WIN” is displayed. The message is displayed until a button operation instructing Play-on or Gamble is conducted during the idle state or after the occurrence of winning.

In the meanwhile, below the display window 150 are provided a help touch button 410, a language switching touch button 411, a sound volume switching touch button 412, and a denomination button 413. These buttons 410, 411, 412, and 413 are provided left end to right end when viewed from the player.

The help touch button 410 displays the first page of the help screen 4101 when touched. The help touch button 410 is darkened when it is inactive, e.g., during the rotation of the reels. The button is displayed when the normal screen is displayed. The button disappears in the help screen 4101, the free game screen and the double-up screen.

As the language switching touch button 411 is touched, the language is switched between English and Chinese. The language switching touch button 411 is activated only during the advertisement, and is darkened when it is inactive, e.g., during the rotation of the reels. Furthermore, on the language switching touch button 411, the displayed national flags are changed to “U.K./China” or “U.S.A./China” in accordance with the setting of the AUDIT. When the switching of the language is set at “DISABLE”, a “PAYTABLE” button, through which a payout table for HELP is displayed, replaces the language switching touch button 411.

The sound volume switching touch button 412 is used for switching the game sound volume at three stages. Each time the button is touched, the game sound volume is switched such that, for example, from low to middle to high to small to middle. The button is displayed when the normal screen is displayed. The button disappears when the help screen 4101 is displayed.

The denomination button 413 displays the current denomination set in the AUDIT. This button is displayed when screens other than the AUDIT are displayed.

In addition to the above, a number of lines selection touch button and a bet per line selection touch button may be additionally provided. The number of lines selection touch button is used for increasing or decreasing the number of paylines L, in five steps of 1, 5, 9, 20, and 30. This is however limited to when the number of paylines is selectable. In the present embodiment, this button is arranged not to be touchable because the number of lines is fixed to 30. The setting depends on the setting in audit. The bet per line selection touch button makes it possible to select bet per line, in five steps of 1, 2, 3, 5, and 10. When the button is touched, five selection buttons corresponding to the current bet configuration appear. This is however limited to when the number of paylines is selectable. The setting depends on the setting in audit.

(Reel Control)

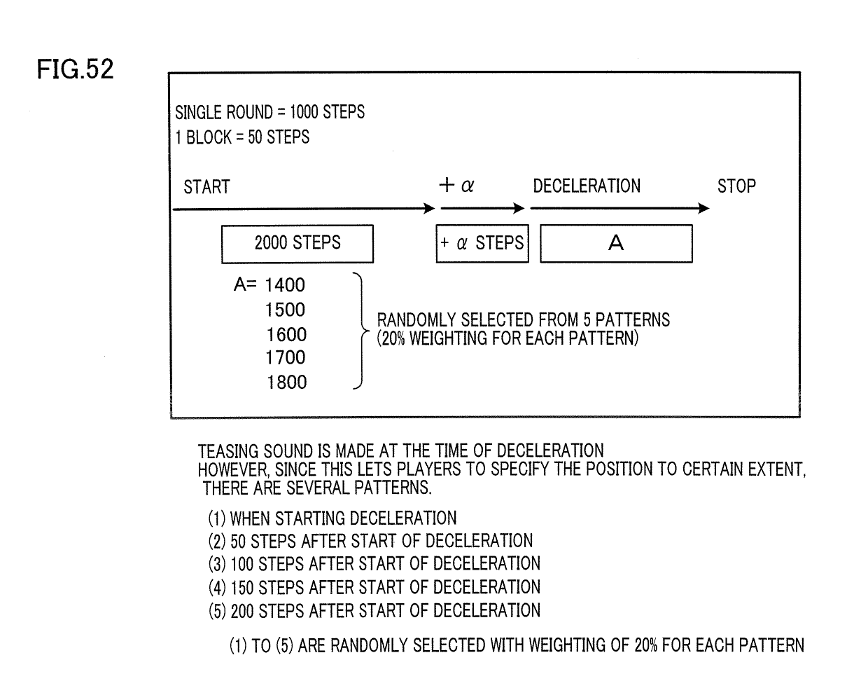

Each column in the display window 150 shown in FIG. 51 forms a reel. As shown in FIG. 52, each reel takes 1000 steps per cycle of scroll, and 50 steps for each symbol. At 2000+α steps from the start of scrolling, the reel starts to decelerate, and a symbol stops after predetermined steps A. The predetermined steps A are randomly selected from 5 types of steps. The 5 types are evenly weighted. With the configuration to select the deceleration steps A from a plurality of types, the position where the symbol stops is not easily found out by the player.

On the other hand, when the reel decelerates, a deceleration sound is generated. This deceleration sound is also referred to as teasing sound. In the present embodiment, the timing of generating the deceleration sound is randomly selected from 5 different timings. These 5 different timings are: the start of deceleration, 50 steps after the start of deceleration, 100 steps after the start of deceleration, 150 steps after the start of deceleration, and 200 steps after the start of deceleration. The each of the different timings are evenly weighted. With the configuration to select the timing of generating the deceleration sound (teasing sound) from a plurality of timings, the position where the symbol stops is not easily found out by the player.

(Details of Display Screen: Payline Box)

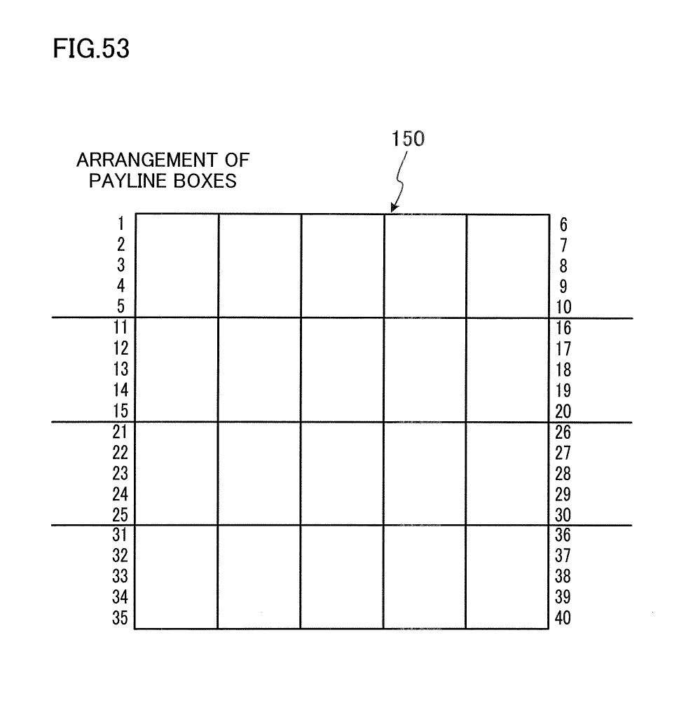

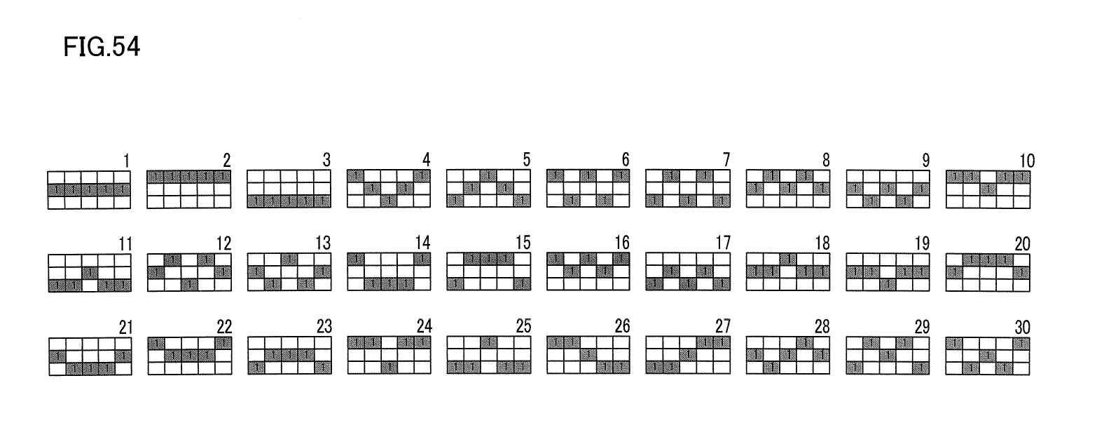

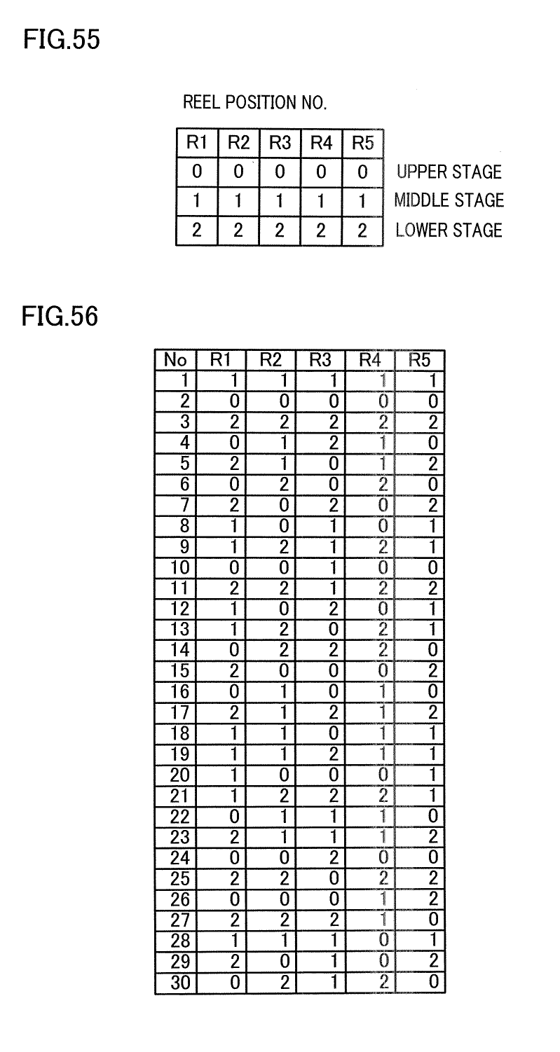

The lower image display panel 141 described above forms, as shown in FIG. 53, payline boxes in the display window 150. As the payline boxes forming 3 rows and 5 columns are combined, 30 paylines L are formed as shown in FIG. 54. FIG. 55 shows the relationship between reel positions and the reel segment numbers. FIG. 56 shows the relationship between 30 payline numbers and the reels.

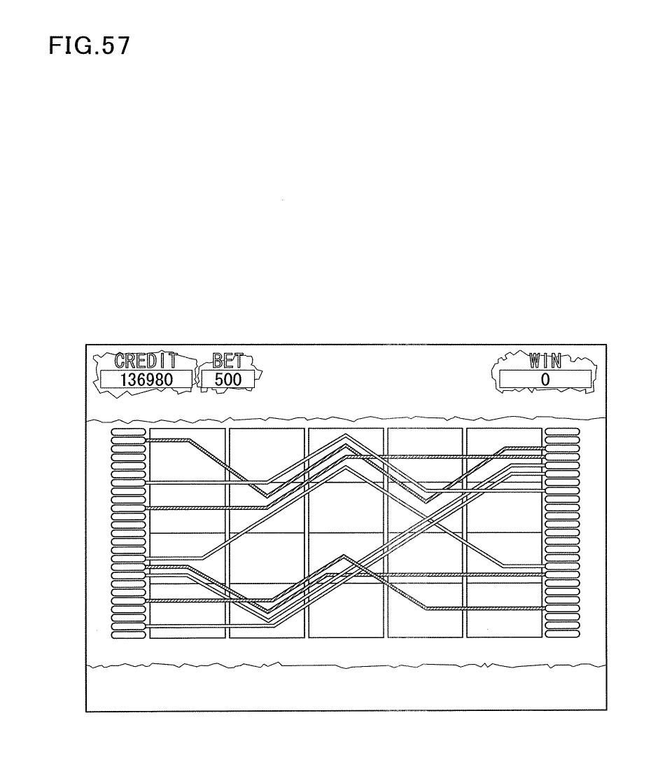

As shown in FIG. 57, every payline L is displayed for 2 seconds, when a winning occurs. It should be noted that the figure only shows 8 patterns of paylines.

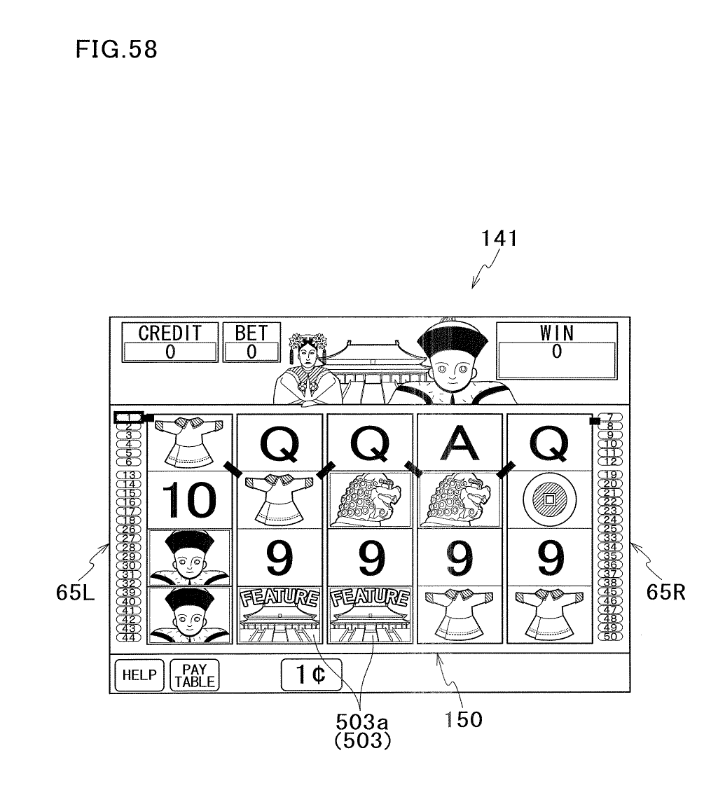

Furthermore, as shown in FIG. 58, at the left and right edges of the display window 150, payline occurrence columns are provided in a symmetrical manner on the left side and right side. The left payline occurrence column on the left side when viewed from the player has 25 payline occurrence parts 65L. The right payline occurrence column on the right side when viewed from the player has 25 payline occurrence parts 65R.

The left payline occurrence parts 65L form pairs with the respective right payline occurrence parts 65R. The left payline occurrence parts 65L form pairs with the respective right payline occurrence parts 65R. From the left payline occurrence parts 65L to the right payline occurrence parts paired with the left payline occurrence parts 65L, paylines L are defined in advance. The paylines L are associated with the above-described payline boxes.

Each payline L is activated when the payline occurrence parts 65L and 65R are connected with each other. In other cases, the paylines are inactive. The number of activated paylines L is determined based on a bet amount. When the bet amount is maximum, i.e., MAXBET, the upper limit of, i.e. 40 paylines are activated. Based on the activated paylines, various winning combinations of symbols are established. The paylines L are all displayed one by one each for 0.5 second in the ascending order of the line numbers. In the free game, the display of all lines and each line is continued for at least 5 seconds.

(Details of Display Screen: Win Display for Payline L During Free Game)

In the free game, line win display is continued until both of the following conditions are satisfied. A condition 1 is satisfied when all winning lines are displayed. A condition 2 is satisfied when 5 seconds elapse from the start of the display of winning lines. A condition 3 is satisfied when increment of the WIN meter finishes. However, when an operation is performed by the player (i.e., a button is pressed or a part of the screen other than the touch buttons is touched), the process shifts to the next spin.

(Details of Display Screen: When Winning Occurs on Single Line)

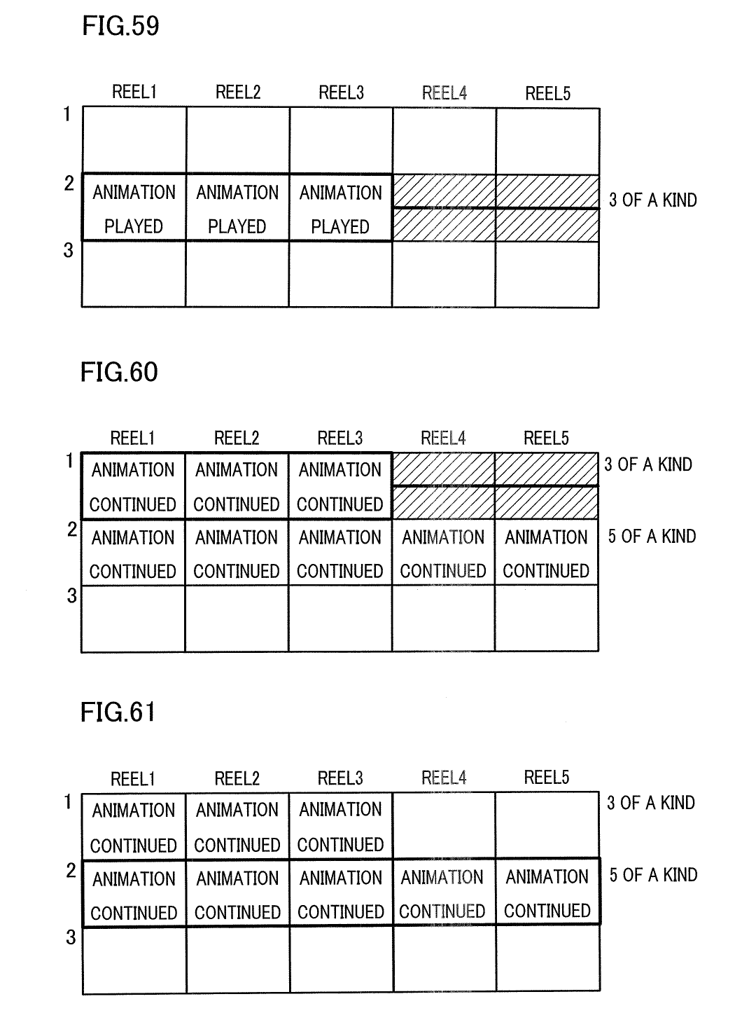

As an example of a case where a winning occurs on a single line, suppose a winning occurs on the line 2, in a 3-line game as shown in FIG. 59. In this case, the following two single line processes 1 and 2 are executed. That is, the single line process 1 displays (not flushing) a frame that surrounds the line on which a winning has occurred and the symbols related to the winning. The single line process 2 starts animation of symbols related to the winning. When the winning involves scatter symbols such as bonus symbols, only the frame that surrounds the symbols is displayed. Further, the above-described line display is continued until the next game is started. Further, in the display portion shown in gray in the figure, the symbols are displayed below the payline.

(Details of Display Screen: Line Display: When Winning Occurs on Plural Lines)

As an example of a case where a winning occurs on plural lines, suppose a winning occurs on the lines 1 and 2, in a 3-line game as shown in FIG. 60. In this case, the following plural line processes 1, 2, and 3 are executed. The plural line process 1 displays a frame that surrounds a line on which a winning has occurred. The frame is displayed for 0.5 second for each line. Further, animation is continued for all the symbols related to the winning. The line win is executed in the ascending order of the line numbers. When a bonus win which does not relate to a line occurs, an effect is provided thereafter. In that case, the win meter 402 indicates “bonus win=XXXXX”. Further, in the display portion shown in gray, the symbols are displayed below the payline.

The plural line process 2 lights the next line related to the winning for 0.5 second, as shown in FIG. 61. Further, animation is continued for all the symbols related to the winning. In the display portion shown in gray, the symbols are displayed below the payline.

The plural line process 3 brings back the process to the plural line process 1, which is the first line display, after displaying is executed for each line. The line display by the plural line processes 1, 2, and 3 is continued until the next game is started.

(Details of Display Screen: Line Display: When 5-of-a-Kind Winning Occurs)

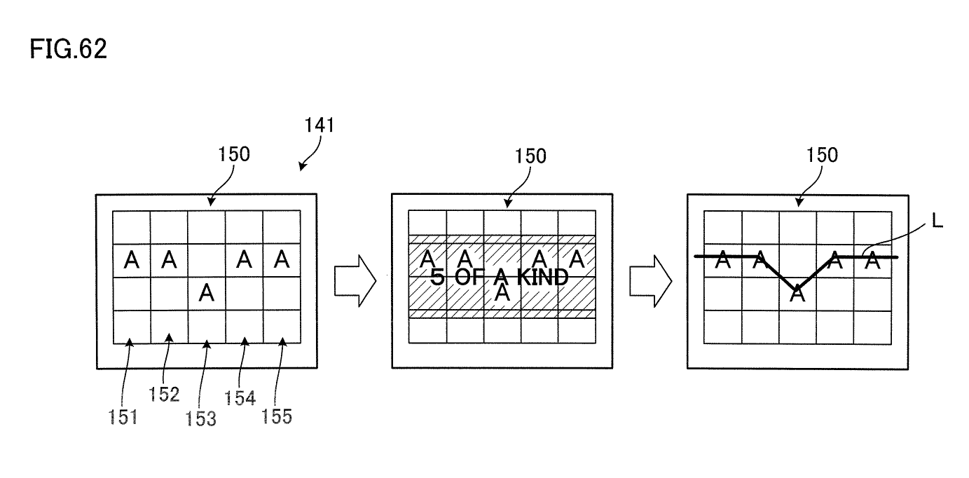

When a 5-of-a-kind symbol combination occurs, an audio visual effect is provided, irrespective of the strength of the combination. The volume of the sound is varied according to the combination. For example, a 5-of-a-kind combination occurs when the reels stop as shown in FIG. 62. Then, a display and sound output for the 5-of-a-kind combination is output. At this time, “5 OF A KIND” is displayed, a voice output of “5 OF A KIND” is executed. It should be noted that this process is not skippable. Further, the increment & line display is not executed at this time. A payout is generated thereafter. Specifically, the payout is incremented, and displaying of line win is executed. It should be noted that this process is not skippable.

(Details of Display Screen: Line Display: When Big Win Occurs)

The following effects are provided depending on the multiplying factor of the win. There are two types of wordings to be displayed. It should be noted that the operation is the same. Specifically, ×10 to ×25 wins are called “high payout”. On the other hand, ×25 or higher wins are called “GREAT”.

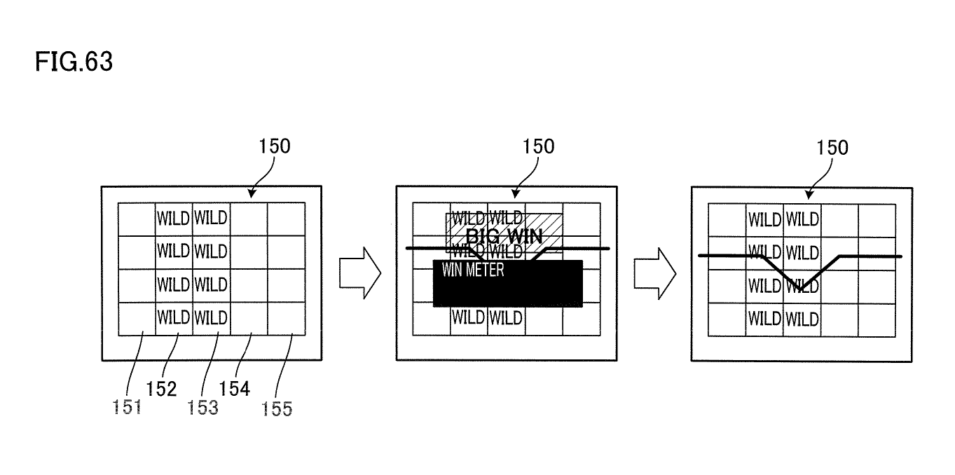

The following describes a case without a 5-of-a-kind combination. For example, a winning of ×10 or higher but less than ×25 occurs when the reels stop as shown in FIG. 63. Then, increment is started, and “Big Win”, a big-win dedicated meter (big meter), and the line win are displayed. It should be noted that this process is skippable. The speed of increment in the big-win dedicated meter follows the increment operation of the win meter 402. The increment operation is detailed later. After elapse of 3 seconds from the end of the increment, the displayed big win and the big meter disappear. However, the line win is continued.

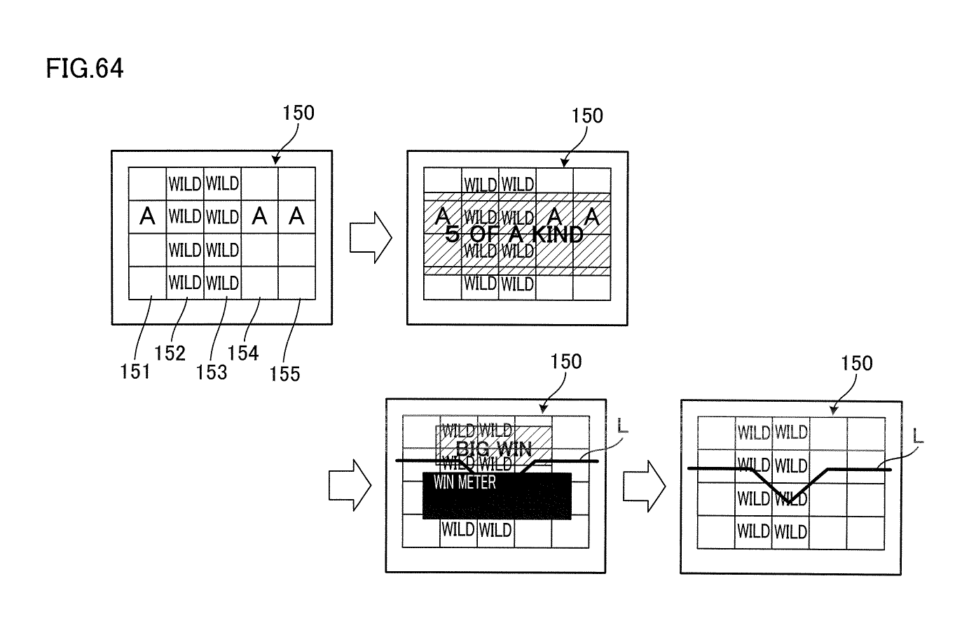

The following describes a case with a 5-of-a-kind combination. For example, a winning of ×10 or higher but less than ×25 occurs when the reels stop as shown in FIG. 64. Then, a display and sound output for the 5-of-a-kind combination is output. Specifically, “5 OF A KIND” is displayed, and a voice output of “5 OF A KIND” is executed. It should be noted that this process is not skipped. Further, the increment and line display is not executed at this time.

Next, increment is started, and the big win and the big meter are displayed. Specifically, increment is started. The speed of increment follows the increment of the win meter 402. The “big win” and the line win are displayed. It should be noted that this process is skippable. After elapse of 3 seconds from the end of the increment, the displayed big win and the big meter disappear. However, the line win is continued.

(Details of Display Screen: Win Meter 402)

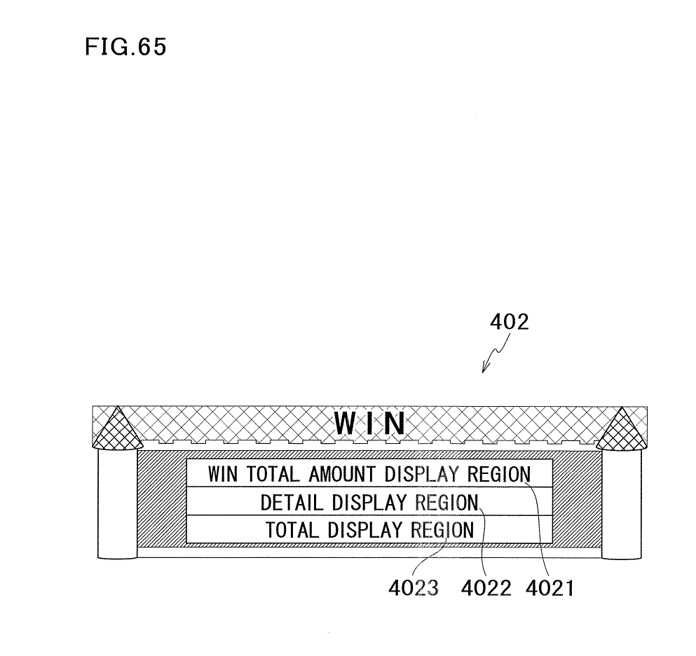

As shown in FIG. 65, the win meter 402 displays a obtained credit and the details thereof in an integrated meter, when a winning is achieved. The win meter 402 includes a win totally amount display region 4021, a detail display region 4022, and a total display region 4023.

(Details of Display Screen: Win Meter 402: WIN Total Amount Display Region 4021)

The WIN total amount display region 4021 displays a WIN total amount display region WIN credit and a money amount. Increment display is performed based on a win increment speed sheet, when performed. More specifically, the win total amount display region 4021 displays a credit amount obtained in the current game cycle (or in the previous game cycle). When a credit is obtained more than once in one game cycle, the credit is added to the win total amount display region 4021 each time it is obtained.

0 is displayed either when the next game cycle starts or when lost in Gamble. When won in Gamble, increment is not performed and the displayed amount is immediately doubled. During the idle state, the state display shows the total amount of WIN immediately after the winning, or 0 in other cases. Pressing [Spin] displays 0. Increment display is performed during WIN increment. At the introduction of the free game, the total amount of WIN up until the game is displayed. During the free game, the total amount of WIN in that game up to the present time is displayed.

(Details of Display Screen: Win Meter 402: Detail Display Region 4022)

The detail display region 4022 displays the win credit after the stop of the fifth reel, when winning is achieved in the normal game or the free game. The state display is carried out as below. Immediately after a normal winning in the idle state, the detail of the payout is displayed. When there are more than one payout, the details of the payouts are switched at intervals of 0.5 seconds. Nothing is displayed in other cases. Pressing [Spin] displays 0. The detail of the payout is displayed during WIN increment. When there are more than one payout, the details of the payouts are switched at intervals of 0.5 seconds. Furthermore, nothing is displayed at the time of the introduction of the free game. Furthermore, nothing is displayed during the rotation of the reels in the free game.

(Details of Display Screen: Win Meter 402: TOTAL DISPLAY REGION 4023)

The total display region 4023 displays the total credits of the detail display region 4022 when the increment in the WIN total amount display region 4021 is completed. The region is not displayed until the increment in the WIN total amount display region 4021 is completed. More specifically, the total credit amount obtained by the spinning in the game is displayed. After the increment is finished in the WIN total amount display region 4021, the total amount is displayed.

The state display is carried out as below. In the idle state, total WIN is displayed immediately after normal WIN. Zero is displayed in other cases. The [Spin] is not displayed. Nothing is displayed during the win increment. The total win is displayed after the win increment. Nothing is displayed at the time of the introduction of a free game. Furthermore, nothing is displayed during the rotation of the reels in a free game.

(Details of Display Screen: Win Meter 402: Increment Spec)

### (Basic Specification)

The count up is smoothly carried out upward. The control is executed in consideration of a difference between an actual amount of money (real amount of money) and an amount of money displayed at that time (displayed amount of money). The operation of the carry of a digit is done at the same time as the operation for lower digits. When a displayed amount of money is larger than a real amount of money (e.g., at the time of resetting in response to a winning), rewriting is immediately carried out.

(Details of Increment Operation)

The speed of the increment is determined in accordance with a remaining count number. When the remaining count number is increased during the operation, the speed of the increment is immediately changed to correspond to the increased remaining count number. The rewriting is performed when the remaining count number exceeds “101”. More specifically, the increment operation is carried out at a speed of increment (seconds) corresponding to each remaining count number, using a data table indicative of the relation between the remaining count up number and the number of seconds.

(Details of Rewriting)

When the remaining count number exceeds “101”, the rewriting is carried out with the value (remaining count number −60), and the count up is carried out based on a data table for the remaining 60 counts. For example, when the remaining count number is 110 counts, the target amount is rewritten so that 50 counts calculated by subtracting 60 from 110 are added to the target amount. At the same time as the rewriting, the remaining 60 counts are counted up. In the meanwhile, when the display amount becomes larger than the real amount due to resetting on account of progressive winning or the like, rewriting is immediately carried out. It is noted that the numbers above such as “101” and “60” are mere examples, and “101” may be any predetermined number and “60” may be any number to be subtracted.

When a progressive winning occurs, the increment is interrupted, the rewriting to the amount of money having been won is carried out, and a flickering effect starts. The flickering is not performed while the increment is being interrupted.

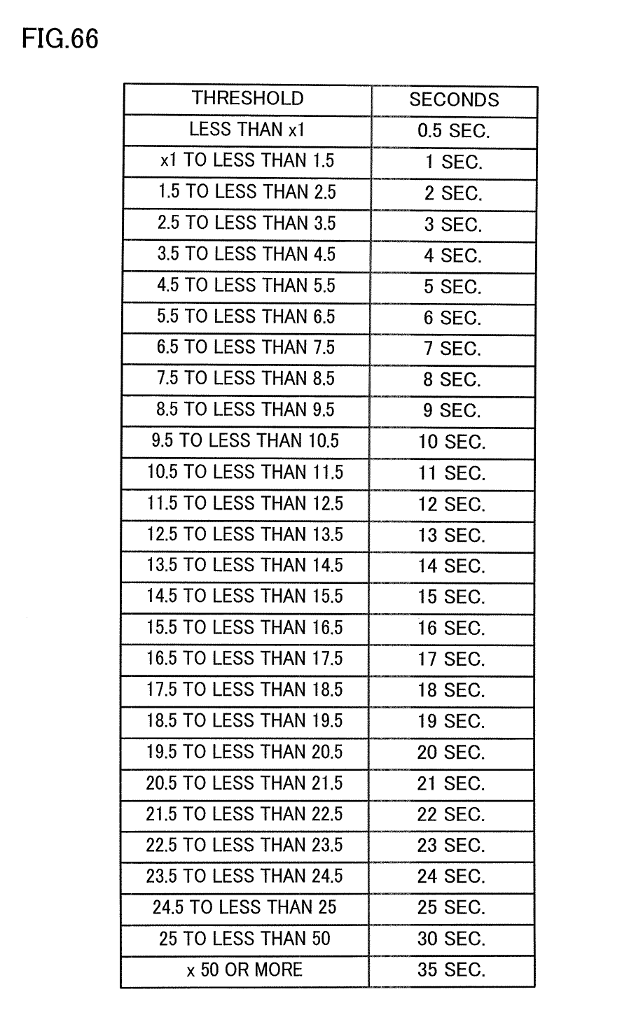

The speed of increment may be managed based on the ratio between the bet and the amount won. For example, when an amount won by winning is four times larger than a bet, the speed of the increment is set at four seconds with reference to the relationship between control thresholds and seconds defined in, for example, a data table shown in FIG. 66. Furthermore, after the speed of the increment is determined based on the data table, the data table may be rewritten based on the determined value. For example, when the speed of the increment is determined to be four seconds in the case where an amount won by winning is four times larger than the bet as above, the second for the remaining count number (1 to 2) in the data table of FIG. 66 is set at four seconds, and the other remaining count numbers are changed to values calculated based on a predetermined ratio.

(Details of Display Screen: System Font Area 403c)

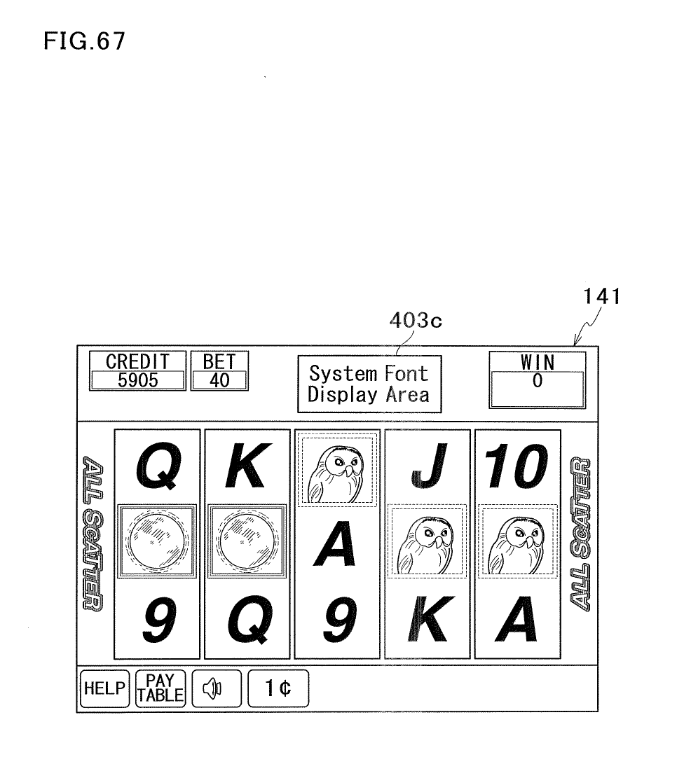

As shown in FIG. 67, the system font area 403c has the bet information display region 403a and the game state display region 403b. The system font area 403c shows the bet information of the game (or the last game) to the player.

The display contents on the game state display region 403b of the system font area 403c are as follows. Immediately after the RAM is cleared, GAME OVER is displayed. When the spin button 46 is pressed, nothing is displayed if the reel is rotating, and GAME OVER is displayed in other cases. If winning is achieved immediately after the reel stop (without trigger) and Gamble is possible, “PLAY ON, GAMBLE or TAKE WIN” is displayed, while in other cases, “GAME OVER” is displayed.

Nothing is displayed at the time of bonus trigger. If winning is achieved immediately after the bonus ends and Gamble is possible, “PLAY ON, GAMBLE or TAKE WIN” is displayed, while in other cases, “GAME OVER” is displayed. Immediately after the end of the jackpot, GAME OVER is displayed. When the help button 33 is pressed (to display the help screen 4101), nothing is displayed if Gamble is possible on condition that winning is achieved. GAME OVER is displayed in other cases.

When the help button 33 is pressed (to return to the game screen), the state before the help screen 4101 is displayed comes back. When the gamble button 44 is pressed (to display the gamble screen), nothing is displayed if Gamble is possible on condition that winning is achieved. The button cannot be operated in other cases. GAME OVER is displayed when the BET buttons 34 to 39 are pressed. GAME OVER is displayed when Take Win is selected. The previous states come back when returning from the AUDIT or in case of power failure.

(Details of Display Screen: Details of Screen Touch Buttons)

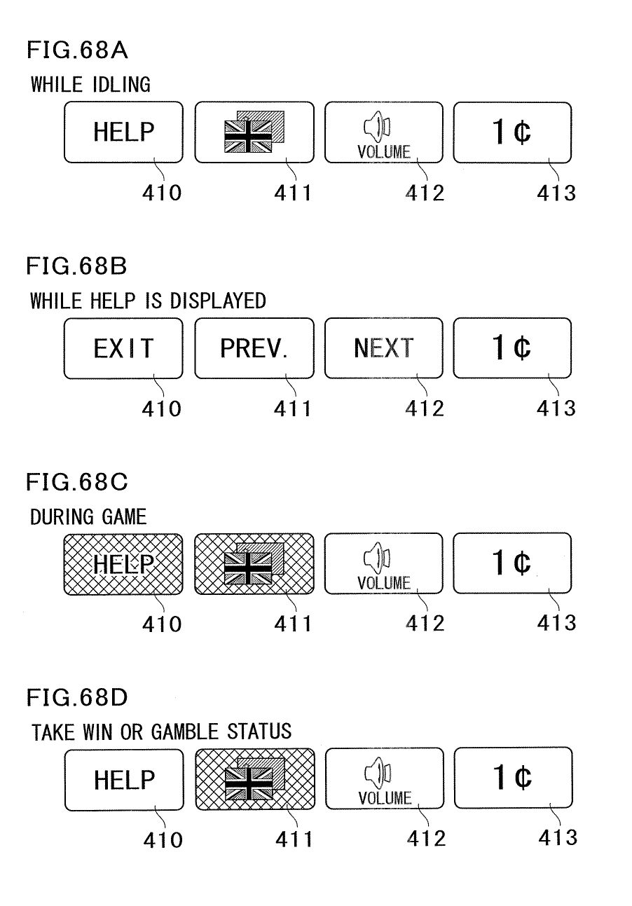

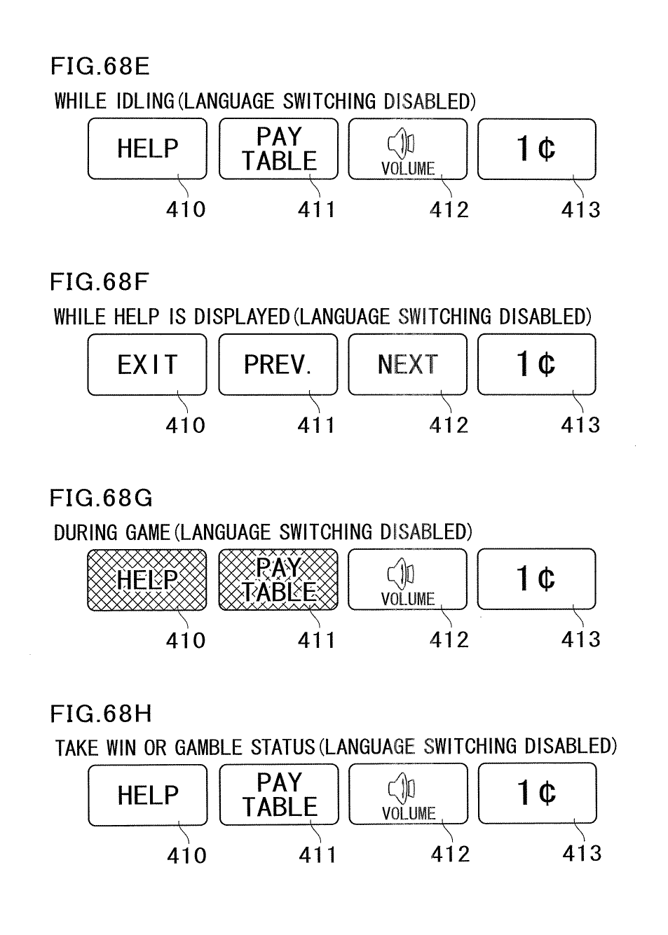

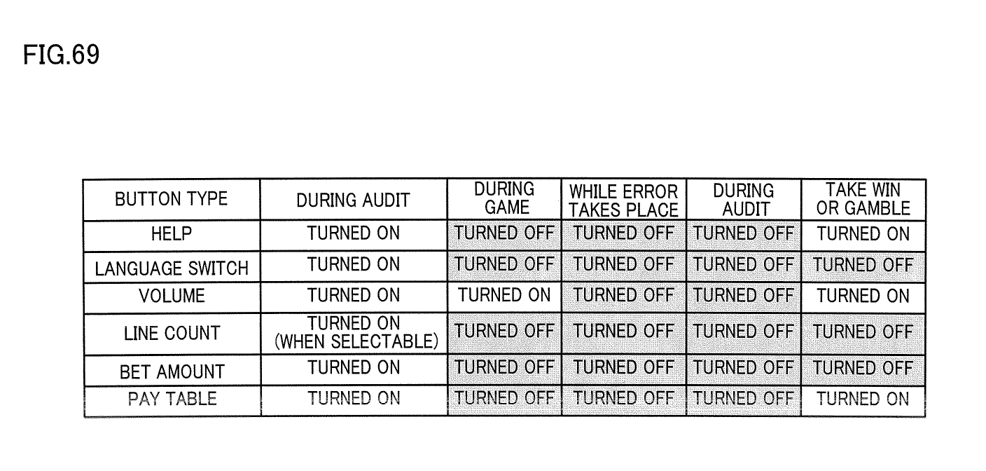

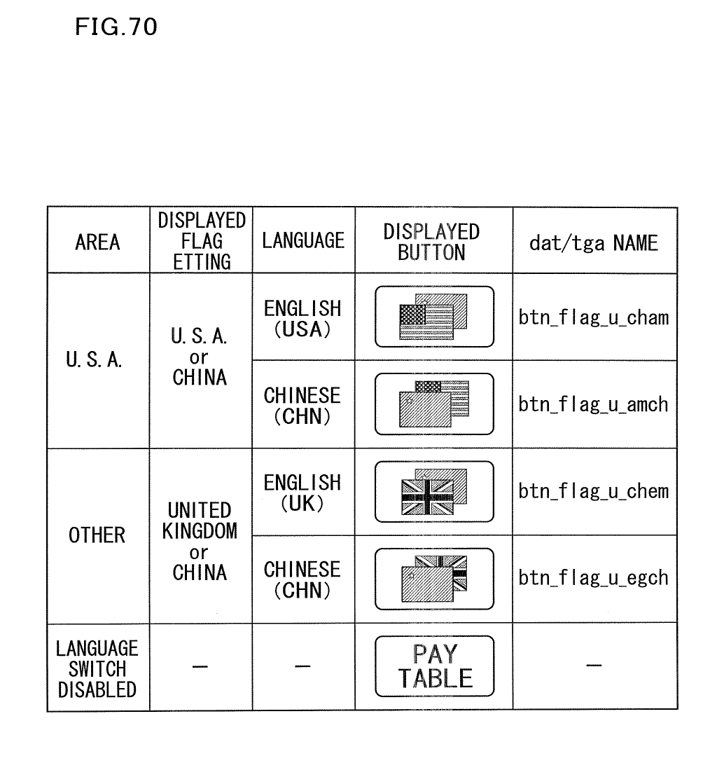

The positions and operations of the help touch button 410, the language switching touch button 411, the sound volume switching touch button 412, and the denomination button 413 are based on the positions in the operation states shown in FIGS. 68A to 68H, a lighting table shown in FIG. 69, and the language setting shown in FIG. 70. For example, the buttons are operable only in the idle state (game over state) regardless of the presence of credits. The switching is impossible during the help, during games, during an error, and during the AUDIT. (The buttons are not illuminated and inactive, or are replaced with other buttons). The switching is impossible during the help, during games, during an error, and during the AUDIT. (The buttons are not illuminated and inactive, or are replaced with other buttons). The national flag associated with the currently used language is displayed on the top. The states of the previous game are maintained even after the switching. The default language in English-speaking countries is English. The default language in Chinese-speaking countries is Chinese.

(Details of Display Screen: Sound Volume Switching Touch Button 412)

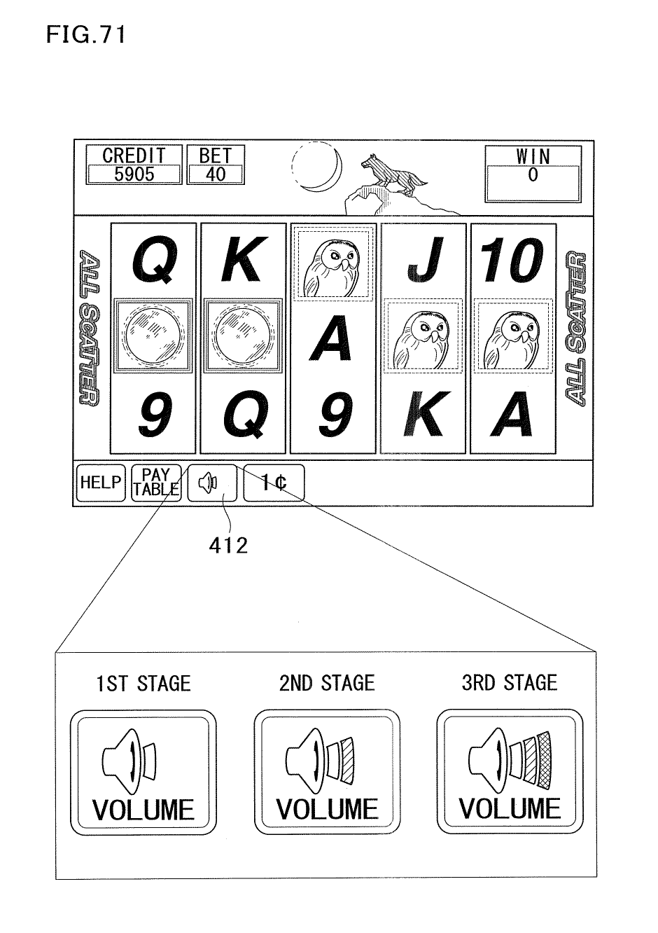

As shown in FIG. 71, the sound volume switching touch button 412 has a function of allowing the player to switch the sound volume at will. The volume is switchable in, for example, three stages. The volume may be linearly changeable. The first stage corresponds to the minimum volume. The second stage corresponds to the medium volume. The third stage corresponds to the maximum volume. The volume stages are switched such that from the first stage to the second stage to the third stage to the first stage.

The default volume stage is the first stage. The default bonus stage is set when (1) a game is activated and (2) at the return from the AUDIT (regardless of whether the volume in the AUDIT is changed). The coefficients of volume changes are 30% in the first stage, 70% in the second stage, and 100% in the third stage. The sound volume switching touch button 412 is always activated unless the button is hidden. The button is activated when GUI (Graphical User Interface) such as the help touch button 410 is displayed. However, when a help screen is displayed, the sound volume switching touch button 412 disappears from the GUI (i.e., is covered with the NEXT button), the button is not operable. The operation invalidation time of the sound volume switching touch button 412 after the touch, i.e., the minimum interval between serial touching is 0.15 second (150 msec). The default sound volume setting value in the AUDIT is 12. The default value is 5 when no sound volume adjustment touch panel function is provided. The reproduction sound volume of the volume setting change sound in the AUDIT is identical with the default volume of the sound volume switching touch button 412 (i.e., the volume reflecting the coefficient in the default stage).

(Details of Display Screen: AUDIT Screen)

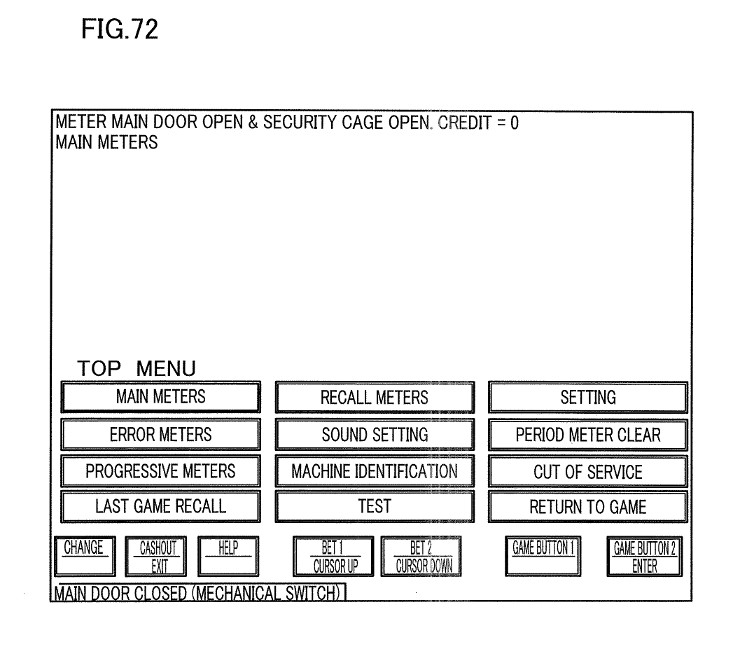

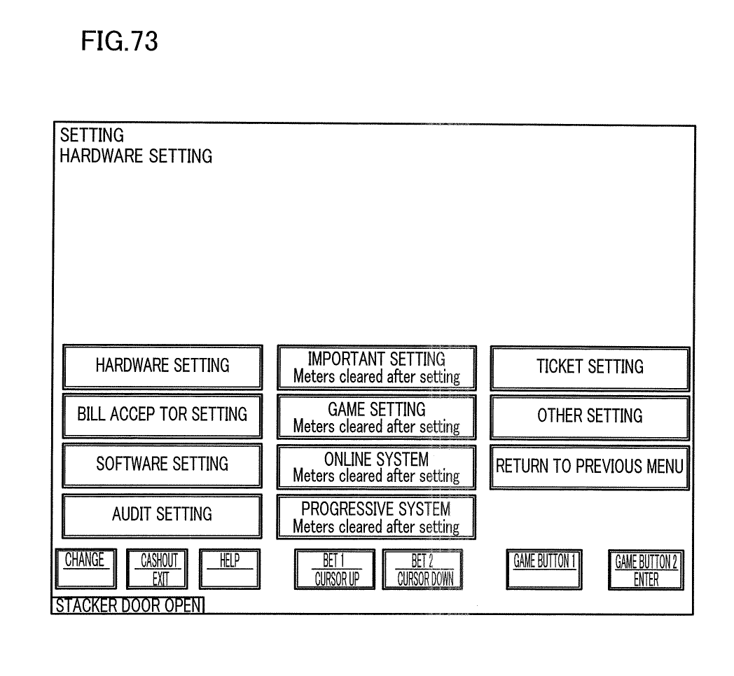

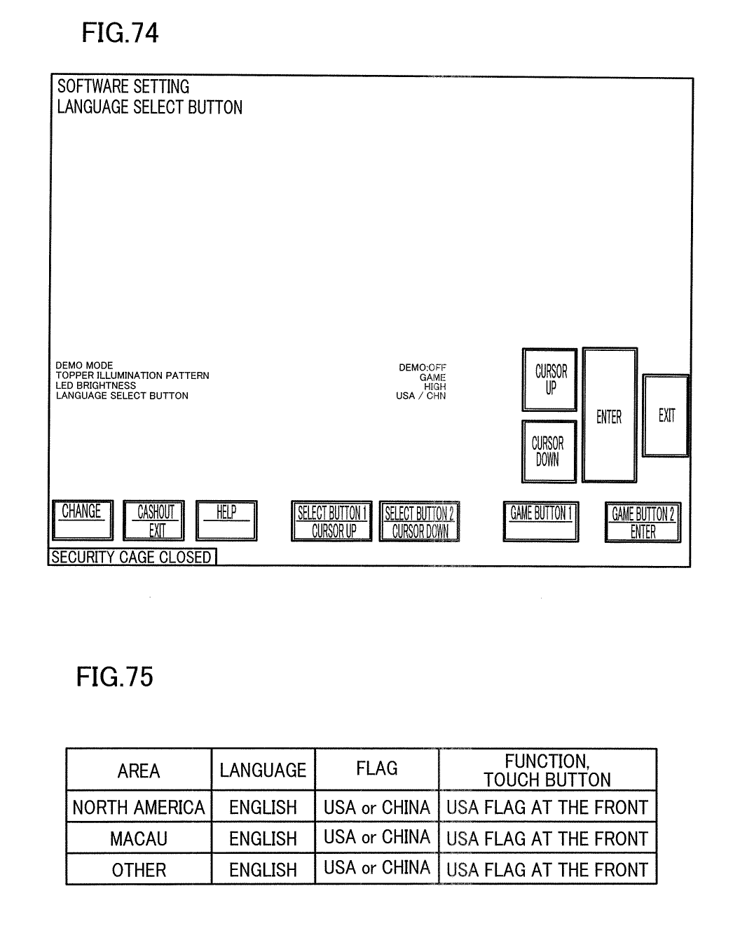

As shown in FIG. 72, the AUDIT screen allows the switching of the national flag on an AUDIT menu. In the switching of the national flag on the AUDIT menu, “national flag” displayed on the touch button at the switching of the language can be set on the AUDIT menu. For example, the operator enters the “AUDIT menu”. Then “SETTING” is pressed, and “SOFTWARE SETTING” is pressed as shown in FIG. 73, a screen shown in FIG. 74 appears.

In the screen shown in FIG. 74, the item “LANGUAGE SELECT BUTTON DISPLAY” is added. In regard to the language switching button, the display content in this later is one of the followings. That is, “LANGUAGE SELECT BUTTON DISPLAY” is one of “DISABLED”, “UK/CHN”, and “US/CHN”.

In addition to the above, the initial display at the clearance of the RAM is shown in FIG. 75. That is to say, in North America, the display language is English, the national flags are U.S./China, and the U.S. flag is on the front on the function touch button. In the Macau area, the display language is English, the national flags are U.K./China, and the U.K. flag is on the front on the function touch button. In the other areas, the display language is English, the national flags are U.K./China, and the U.K. flag is on the front on the function touch button.

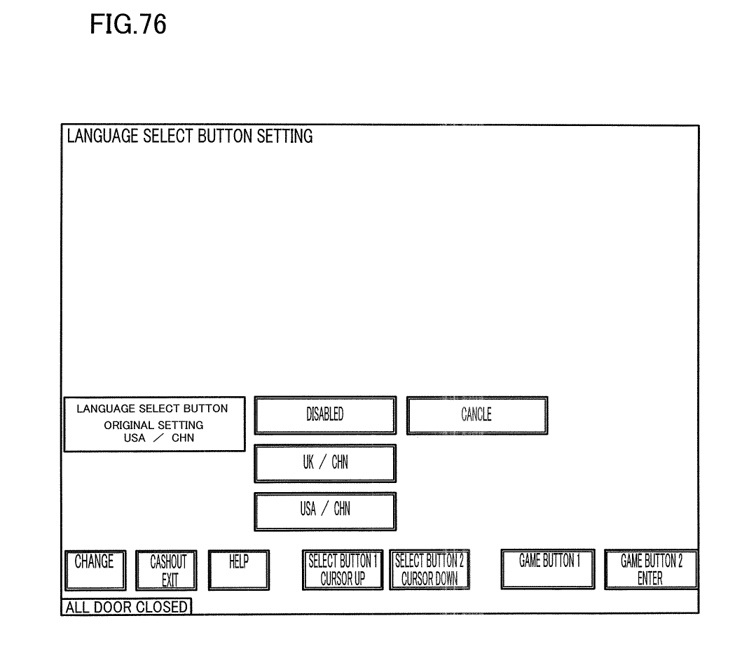

When the item “LANGUAGE SELECT BUTTON DISPLAY” is selected, a screen shown in FIG. 76 is displayed. It is noted that the selected item is enclosed by a red frame. It is noted that the operations by the control panel 30 or the like are not changed from the current settings. “DISABLED” is setting with which the switching function is disabled (only English). The language switching touch button is switched to “PAYTABLE touch button. After the touch (i.e., the determination by the button), the screen of the immediately above layer is displayed and the determination is confirmed. UK/CHN indicates that the U.K. flag is set. USA/CHN indicates that the U.S. flag is set. The button also functions as the activation of the switching function (i.e., the switching touch button is displayed). After the touch (i.e., the determination by the button), the screen of the immediately above layer is displayed and the determination is confirmed. The selected national flag is on the front on the touch button (Chinese flag is positioned behind). By “CANCEL”, the screen is canceled and the screen of the immediately above layer comes back. The contents that were previously set remain the same.

(Details of Display Screen: Help Screen 4101)

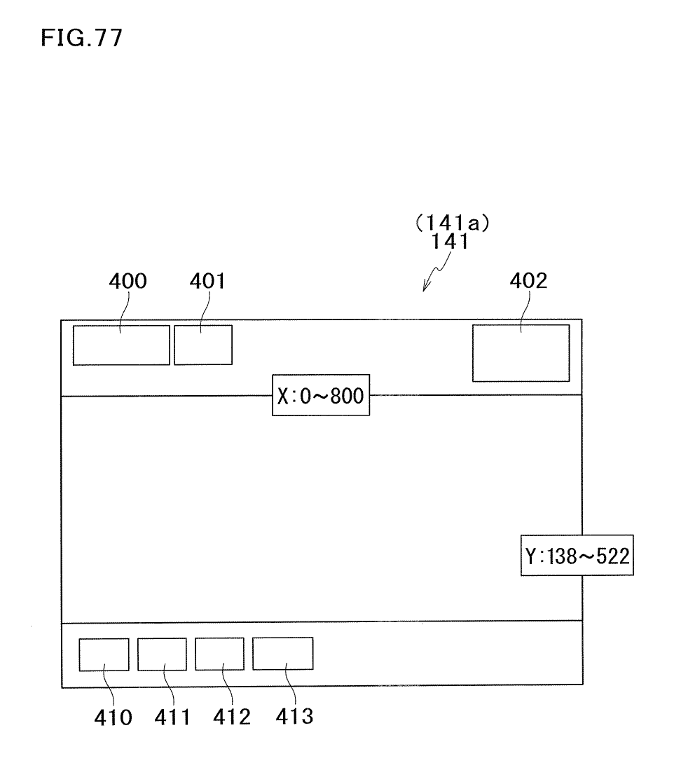

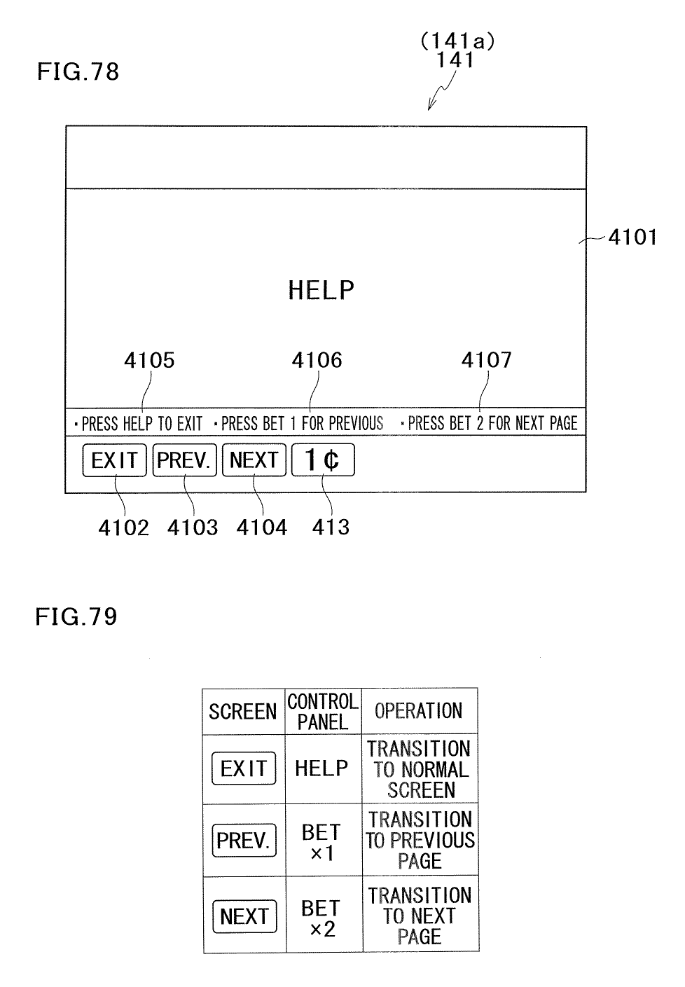

As shown in FIG. 77, the lower image display panel 141 displays a help screen 4101 as the help touch button 410 is operated. Below the help screen 4101 are provided text display regions 4105, 4106, and 4107, as shown in FIG. 78. On the text display regions 4105, 4106, and 4107, texts are displayed with the system font. The help touch button 410 is switched to an EXIT button 4102, the language switching touch button 411 is switched to a PREV button 4103, and the sound volume switching touch button 412 is switched to a NEXT button 4104. When the EXIT button 4102 is touched, the help is terminated and the normal game screen comes back. As the PREV button 4103 is touched, the previous help page is displayed. As the NEXT button 4104 is touched, the next help page is displayed.

An example of the text displayed on the text display region 4105 is PRESS HELP TO EXIT. The maximum number of the characters is 25. An example of the text displayed on the text display region 4106 is PRESS BET 1 FOR PREVIOUS PAGE. The maximum number of the characters is 36. An example of the text displayed on the text display region 4107 is PRESS BET 2 FOR NEXT PAGE. The maximum number of these characters is 33.

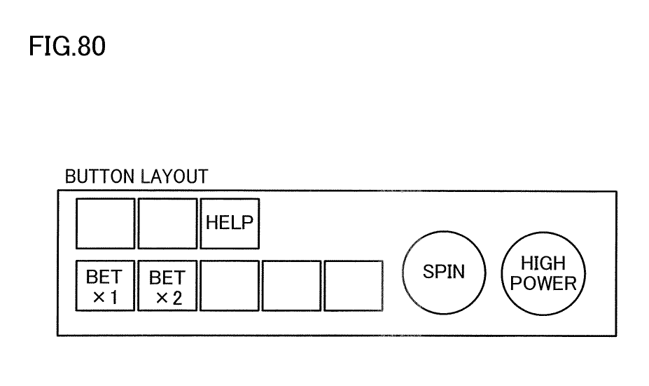

As shown in FIG. 79 and FIG. 80, these buttons 4102, 4103, and 4104 and the text display regions 4105, 4106, and 4107 are linked to the control panel 30. Even if the patterns are altered and the values are changed, the text display regions 4105, 4106, and 4107 display correct contents in accordance with the changes.

(Details of Display Screen: Help Screen 4101: Operations: Operation when Entering the Help Screen 4101)

When the help touch button 410 is pressed in the idle state, only the first screen 141a is changed to the help screen 4101 while the second screen 131a keeps displaying the basic screen of the idle state. In this regard, the second screen 131a is displayed on the wheel 131, whereas the first screen 141a is displayed on the lower image display panel 141. The help screen 4101 is displayed only on the first screen 141a. During an error or AUDIT, the help touch button 410 LED is not illuminated so as not to allow the player to enter the help screen 4101. Whether it is possible to enter the help screen 4101 during games is different in each game. Basically, at the destinations of shipment, it is possible to enter the help screen 4101 only in the idle state. The help screen 4101 must be displayed from the first page.

(Details of Display Screen: Help Screen 4101: Operations: Operation while the Help Screen 4101 is Displayed)

When an error or door open occurs, the help screen 4101 is hidden (i.e., the game screen is reinstated) and ERROR/DOOR OPEN is displayed. When a bill or a coin is inserted, the help screen 4101 is terminated and the credit is received. When an AUDIT key is turned, the help screen 4101 is terminated and the AUDIT is displayed. After the end of the AUDIT, the idle state comes back. When power interruption occurs, the help screen 4101 is not displayed when the power is turned on and the machine becomes in the idle state. When no input is made for 3 minutes while the help screen 4101 is being displayed, the help screen 4101 disappears and the machine becomes in the idle state.

(Details of Display Screen: Help Screen 4101: Help 1)

Help 1 includes the following contents to be displayed. “This game must be played with all lines.” “Select credits bet on each line.”, “All WINs are displayed as credits.”, “WIN is determined on successive reels from the leftmost, excluding bonus symbols.”, “WIN is determined on illuminated line, except bonus symbols.”, “Target is the highest WIN.”, “WIN on different line is also added.”, “WIN on line is multiplied by credits bet on each line.”, “All payouts and game play become invalidated when malfunction occurs.”, “Player should check whether correct credits are registered before game starts.”

(Details of Display Screen: Help Screen 4101: Help 2) Help 2 includes 30 patterns of payout lines as display data.

(Details of Display Screen: Help Screen 4101: Help 3)

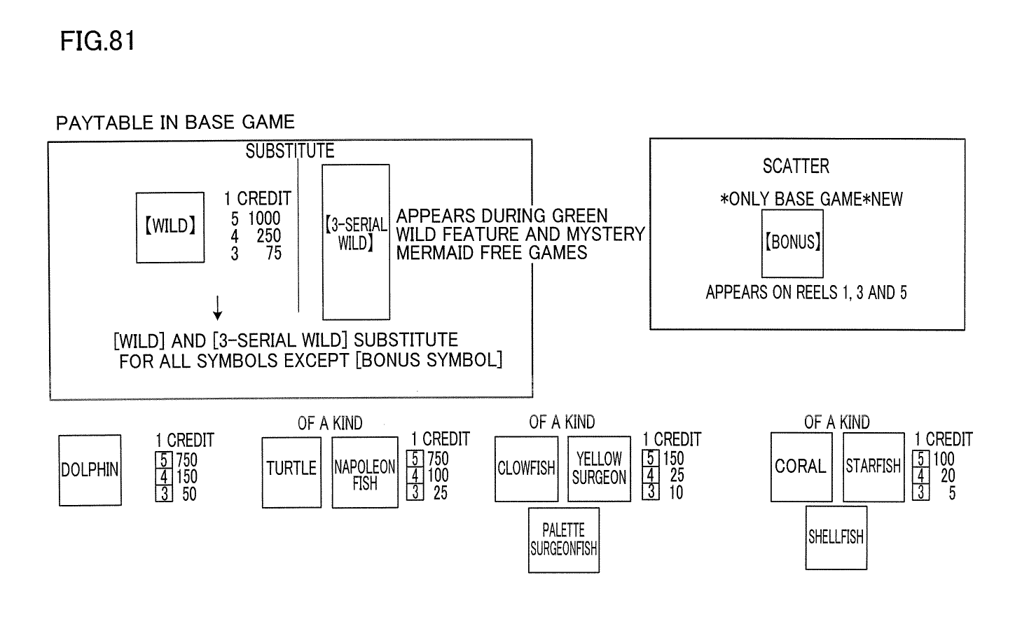

Help 3 explains the payout table as shown in FIG. 81. To be more specific, the following contents are displayed. Explained is how [WILD] appears in the base game which is the normal game. That is, the [WILD] and “3-serial wild” have a function of substituting for any symbols except the feature symbol. The [BONUS] appears on reels 1, 3, and 5 only. The [BONUS] can appear only in a base game.

(Details of Display Screen: Help Screen 4101: Help 4)

Help 4 includes the following contents to be displayed. “When a bonus symbol stops on reels 1, 3, and 5, MERMAID SPIN BONUS is triggered.”, “When MERMAID SPIN BONUS starts, the wheel on the top box starts to spin, to determine a bonus or a credit payout.”, “When the roulette stops, the bonus or payout pointed by the pointer is awarded to the player.”, “The bonus or the payout awarded by the roulette is as follows.”, “100, 150, 200, 300, and 3000: the payout displayed is multiplied by Bet Per Line, and the resulting payout is awarded.”, “BIG BUBBLE BONUS: BIG BUBBLE BONUS is triggered.”, “FREE GAMES: Mystery mermaid free game is triggered.”, “SEASEASHELL-PICK BONUS: SEASEASHELL-PICK BONUS is triggered.”, “SWIMMING MERMAID BONUS: SWIMMING MERMAID BONUS is triggered.”, “POP THE BUBBLES BONUS: POP THE BUBBLES BONUS is triggered.”, “MERMAID DREAM BONUS: MERMAID DREAM BONUS is triggered.”

(Details of Display Screen: Help Screen 4101: Help 5)

Help 5 includes the following contents to be displayed. “BIG BUBBLE BONUS is won when the pointer points ‘BIG BUBBLE BONUS’ in MERMAID SPIN BONUS.”, “Pressing the SPIN button during BIG BUBBLE BONUS changes the animation, but does not affect the result.”, “Credit displayed on the screen at the end will be obtained.”, “Credit Payout: 150 to 1000 credit×Bet Multiplier”,

(Details of Display Screen: Help Screen 4101: Help 6)

Help 6 includes the following contents to be displayed. “MYSTERY MERMAID FREE GAMES is won when the pointer points ‘FREE GAME’ in MERMAID SPIN BONUS.”, “MYSTERY MERMAID FREE GAMES are 7 GAMES of FREE GAMES.”, “SPECIAL REEL BAND IS USED in MYSTERY MERMAID FREE GAMES.”, “The number of play lines and the amount of bet in MYSTERY MERMAID FREE GAMES are inherited from those at the time of triggering the MERMAID SPIN BONUS.”, “Four colors of Mermaids randomly appear in MYSTERY MERMAID FREE GAMES.”, “As many as 2 types of mermaids except a red mermaid may appear while the reels are spinning.”, “When a red mermaid appear after all the reels stop, the game count is increased randomly by 2, 3, 4, or 5 games.”, “When a purple mermaid appear while the reels are spinning, 1 to 15 randomly selected symbols are changed to wild symbols.”, “When a green mermaid appear while the reels are spinning, all the symbols on as many as 5 randomly selected reels are changed to wild symbols.”, “When a blue mermaid appear while the reels are spinning, the payout is multiplied by any of the following multiplying factors: ×2, ×3, ×4, ×5.”, “MYSTERY MERMAID FREE GAMES is not retriggered.”, “MERMAID SPIN BONUS is not triggered during MYSTERY MERMAID FREE GAMES.”

(Details of Display Screen: Help Screen 4101: Help 7)

Help 7 includes the following contents to be displayed. “SEASEASHELL-PICK BONUS is won when the pointer points ‘SEASEASHELL-PICK BONUS’ in MERMAID SPIN BONUS.”, “3 seashells can be selected out of 15 seashells.”, “The 15 seashells hide a credit payout and 3 extra picks.”, “When the credit payout appears from the selected seashells, the credit is won.”, “When the ‘3 extra picks’ appear from the selected seashells, the number of picks is increased by 3 times.”, “When there is no remaining pick, the displayed credit is won, and the SEASEASHELL-PICK BONUS ends.”, “Credit displayed on the screen at the end will be obtained.”, “Credit Payout: 30 to 300 credit×Bet Multiplier”

(Details of Display Screen: Help Screen 4101: Help 8)

Help 8 includes the following contents to be displayed. “SWIMMING MERMAID BONUS is won when the pointer points ‘SWIMMING MERMAID BONUS’ in MERMAID SPIN BONUS.”, “In this game, the mermaid is operated by the SPIN button to win a payout by collecting coins.”, “Credit displayed on the screen at the end will be obtained.”, “Pressing the SPIN button during the BONUS changes the animation, but does not affect the result.” “Credit Payout: 150 to 1000 credit×Bet Multiplier”

(Details of Display Screen: Help Screen 4101: Help 9)

Help 9 includes the following contents to be displayed. “POP THE BUBBLE BONUS is won when the pointer points ‘POP THE BUBBLE BONUS’ in MERMAID SPIN BONUS.”, “POP THE BUBBLE BONUS includes BUBBLE TIME CHALLENGE and BUBBLE SURPRISE.”, “This is a game to pick a countless number of bubbles appearing on the screen.”, “Touch the bubbles appearing on the screen, and win the credit payout appearing from the bubble.”, “If there are some bubbles not picked, it will not affect the total payout of the POP THE BUBBLE BONUS.”, “The BUBBLE TIME CHALLENGE ends upon elapse of 15 seconds from the start of the BUBBLE TIME CHALLENGE.”, “A bubble out of 3 bubbles is selected.”, “The 3 bubbles hide a credit payout.”, “When the credit payout appears from the selected bubbles, the credit displayed is won, and then THE BUBBLE BONUS ends.”, “Credit displayed on the screen at the end will be obtained.” “Credit Payout: 1000 to 2000 credit×Bet Multiplier”

(Details of Display Screen: Help Screen 4101: Help 10)

Help 10 includes the following contents to be displayed. “MERMAID DREAM BONUS is won when the pointer points ‘MERMAID DREAM BONUS’ in MERMAID SPIN BONUS.”, “Mermaid dream Bonus” includes DREAM SPIN and DOUBLE TREASURE CHANCE.”, “DREAM SPIN is a single free game”, “A special reel is used in DREAM SPIN.”, “DREAM SPIN is not retriggered.”, “The payout won in DREAM SPIN is the target of DOUBLE TREASURE CHANCE.”, “The number of play lines and the amount of bet in DREAM SPIN are inherited from those at the time of triggering the MERMAID SPIN BONUS.”, “One of 2 treasure boxes is selected.”, “The 2 treasure boxes hide either DOUBLE and END.”, “When DOUBLE appears from the selected treasure box, the credit won in DREAM SPIN is doubled, and two treasure boxes appear again.”, “DOUBLE TREASURE CHANCE continues up to 5 times, as long as DOUBLE is picked.”, “The credit won at the fifth DOUBLE TREASURE CHANCE or at the time of picking END is awarded, and then MERMAID DREAM BONUS ends.”. “The credit won in DREAM SPIN is multiplied by as many as 32 in DOUBLE TREASURE CHANCE.”

(Details of Display Screen: Help Screen 4101: Help 11)

Help 11 includes the following contents to be displayed. “The green mermaid randomly appears only when there is no bonus symbol on the third reel in the base game.”, “When a green mermaid appear while the reels are spinning, all the symbols on as many as 5 randomly selected reels are changed to wild symbols.”, “GREEN MERMAID WILD FEATURE, PURPLE MERMAID FEATURE, and BLUE MERMAID MULTIPLIER FEATURE do not take place at the same time.”

(Details of Display Screen: Help Screen 4101: Help 12)

Help 12 includes the following contents to be displayed. “The purple mermaid randomly appears only when there is no bonus symbol on the third reel in the base game and when there is not wild symbol.”, “When a purple mermaid appear while the reels are spinning, 1 to 15 randomly selected symbols are changed to wild symbols.”, “GREEN MERMAID WILD FEATURE, PURPLE MERMAID FEATURE, and BLUE MERMAID MULTIPLIER FEATURE do not take place at the same time.”

(Details of Display Screen: Help Screen 4101: Help 13)

Help 13 includes the following contents to be displayed. “The blue mermaid randomly appears only when there is no bonus symbol on the third reel in the base game.”, “When a blue mermaid appear while the reels are spinning, the payout is multiplied by any of the following multiplying factors: ×2, ×3, ×4, ×5.”, “GREEN MERMAID WILD FEATURE, PURPLE MERMAID FEATURE, and BLUE MERMAID MULTIPLIER FEATURE do not take place at the same time.”

(Details of Display Screen: Help Screen 4101: Help 14)

Help 14 includes the following contents to be displayed. “PLAY xxxx TO xxxx CREDITS”, “ALL WINS PAID BY MACHINE OR ATTENDANT”

(Description of Screens: Wheel Bonus)

Next, the following describes the display screens, with reference to drawings.

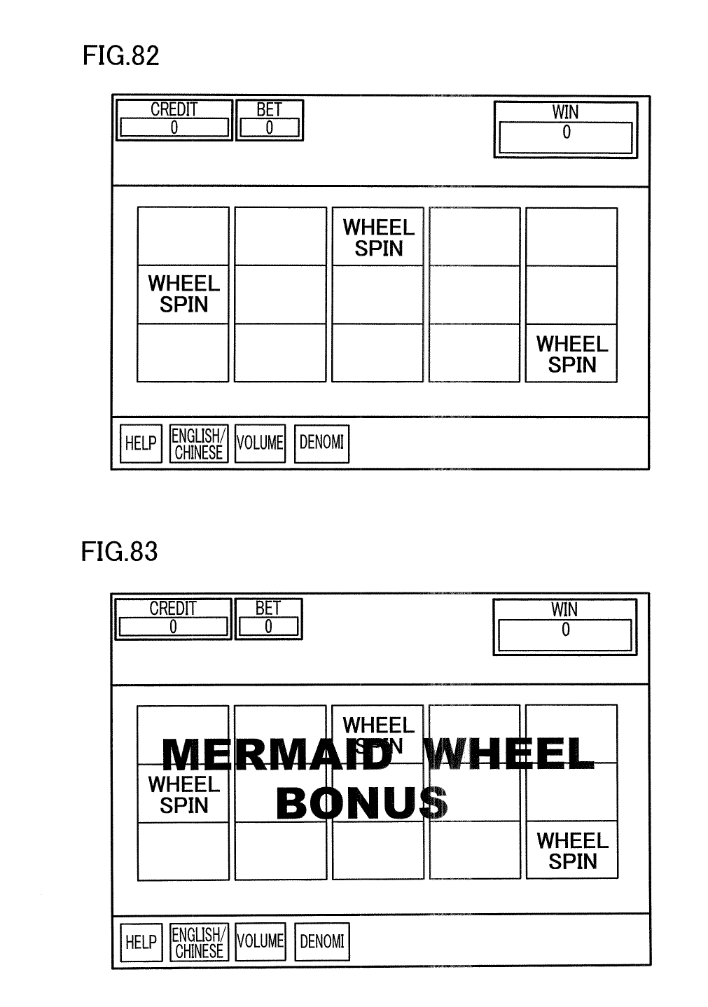

As shown in FIG. 82, the slot machine 1 of the present embodiment is configured so that rearrangement of “BONUS” symbol (specific symbol 502) in three or more positions in the display window 150 during a normal game establishes a bonus trigger condition, thus leading to a transition to the wheel bonus. Note that the “BONUS” symbol only exists in the first reel, third reel, and the fifth reel. Further, a line win does not occur when the bonus trigger is established.

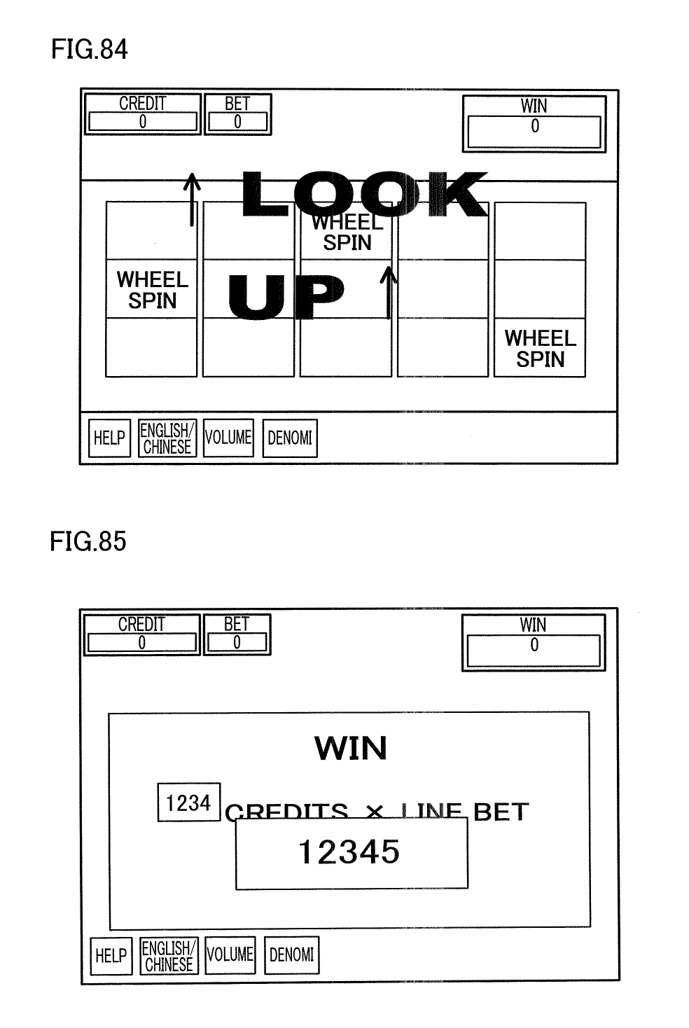

As shown in FIG. 83, when there is a transition to the wheel bonus, the bonus logo of “MERMAID WHEEL BONUS” is displayed on the lower image display panel 141, and the start of the wheel bonus is notified to the player. Then, as shown in FIG. 84, there will be a navigation text that prompts the player to look at the wheel 131, on the lower image display panel 141. Specifically, text of “LOOK UP” is displayed along with an arrow pointing up. Then, the wheel 131 rotates, and after elapse of a predetermined period, the pointer 174 points an area on the surface of the wheel 131 corresponding to the bonus selected by wheel bonus random determination.

(Description of Screens: Fixed Payout)

When the fixed payout is selected as the result of the wheel bonus random determination, there will be an indication that a fixed payout which is randomly determined is won, as shown in FIG. 85. The fixed payout bonus awards any of the following payouts: “100”, “150”, “200”, “300”, and “3000”. Then, the amount of fixed payout randomly determined is awarded to the player. The credit awarded to the player is added to the win meter. The screen then returns to the normal game screen.

(Description of Screen: Mermaid Dream Bonus)

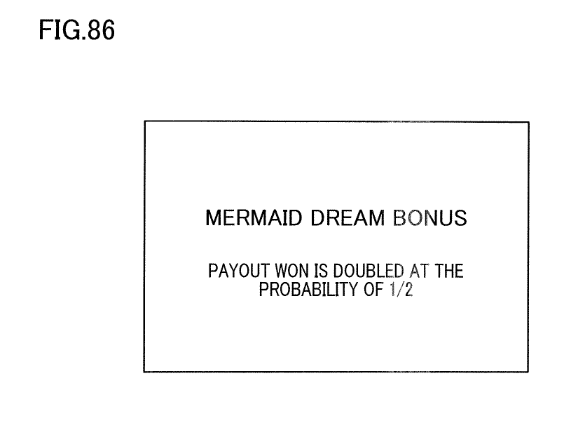

As shown in FIG. 86, when the mermaid dream bonus is selected as the result of wheel bonus random determination, the bonus logo of “Mermaid dream Bonus” is displayed on the lower image display panel 141, and the start of the mermaid dream bonus is notified to the player. Further, on the lower image display panel 141, there will be text that informs the player that the game will double the payout at a probability of 1/2.

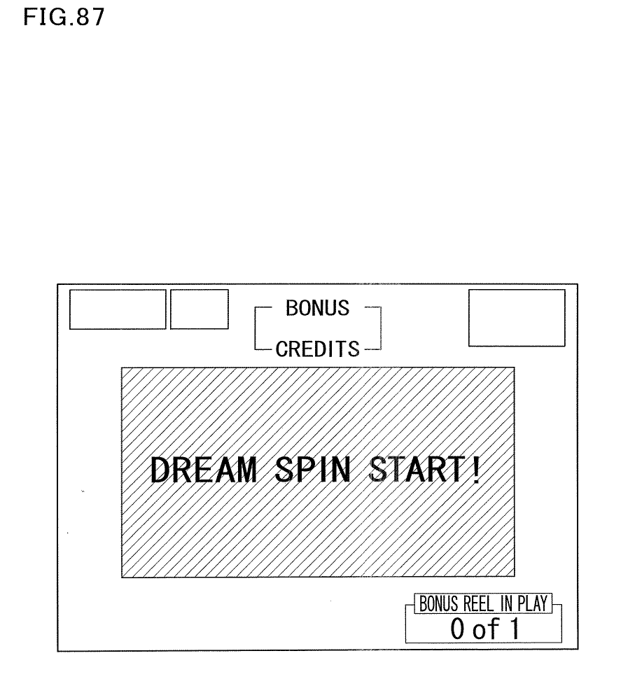

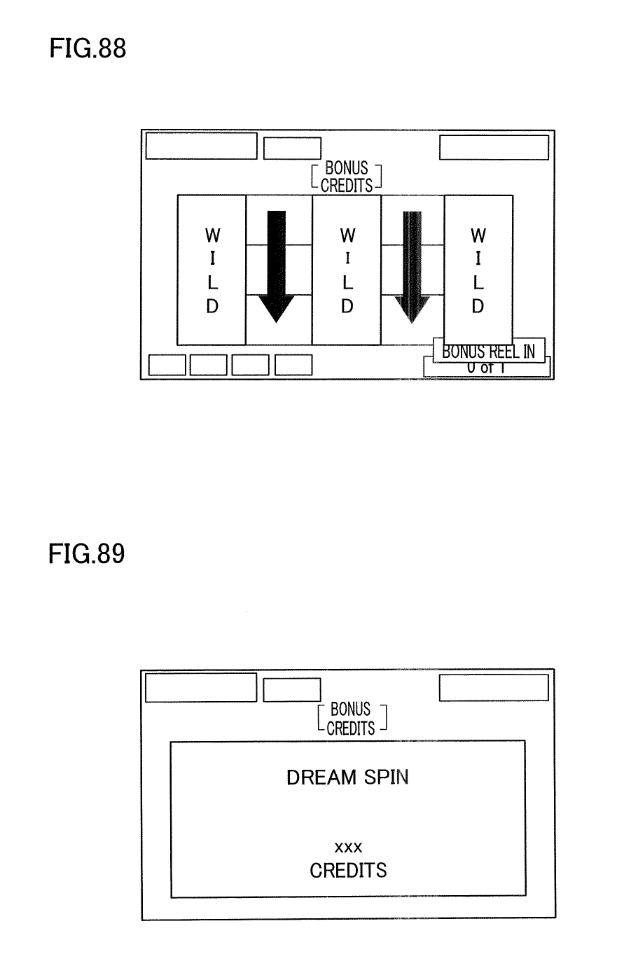

Then, after the introduction effect, the logo of “DREAM SPIN START” is displayed on the lower image display panel 141 as shown in FIG. 87, to notify the player that the free game is started. Then, as shown in FIG. 88, a screen of the free game is displayed, with the first reel, the third reel, and the fifth reel being the wild reel. Text of “BONUS REEL IN PLAY” is displayed at the lower right of the screen. The free game run here is one that determines the payout of the mermaid dream bonus, and is run only once. Further, the payout of the free game will be awarded after the 2-choice game. This free game is different from the free game run in the later-described mystery mermaid free game, although it is run without a need of betting of a gaming value. Further, there is no retrigger for this free game. The free game involves the symbol table shown in FIG. 8. With the first reel, third reel, and the fifth reel being a wild reel, the payout will be higher than that of the normal game. Further, there will not be a case where the payout is 0 (so-called lose). The initial position of the reel is the position “0”.

When the free game is run, the payout of the free game is displayed as shown in FIG. 89. Then, with this payout as the base, the 2-choice game is subsequently run in which one of two treasure boxes is selected.

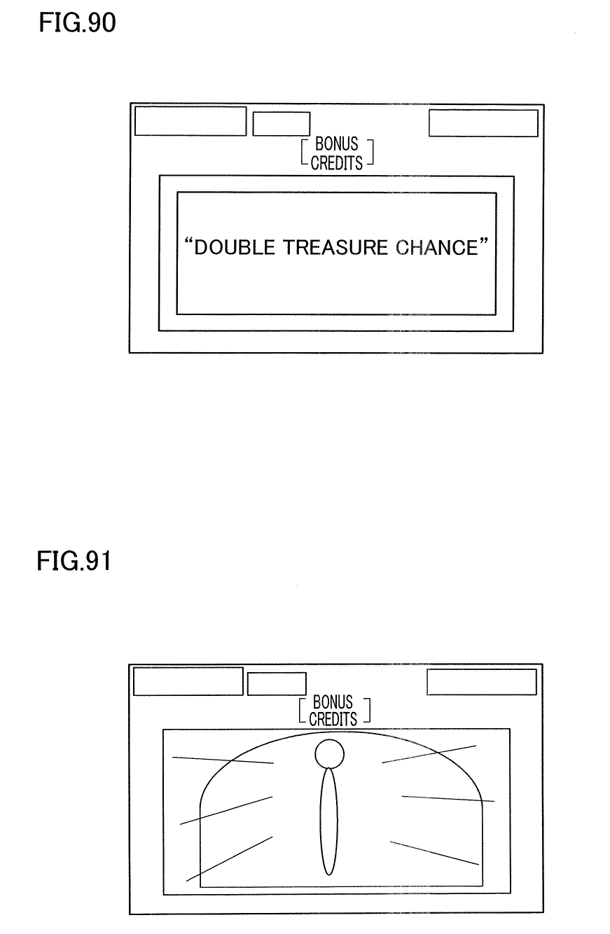

Then, when the free game ends, the logo of “Double Treasure Chance” is displayed on the lower image display panel 141 as shown in FIG. 90, to notify the player that the 2-choice game is started. Then, the description of the 2-choice game is displayed on the lower image display panel 141. After that, as shown in FIG. 91, a movie of a mermaid entering a cave is displayed on the lower image display panel 141.

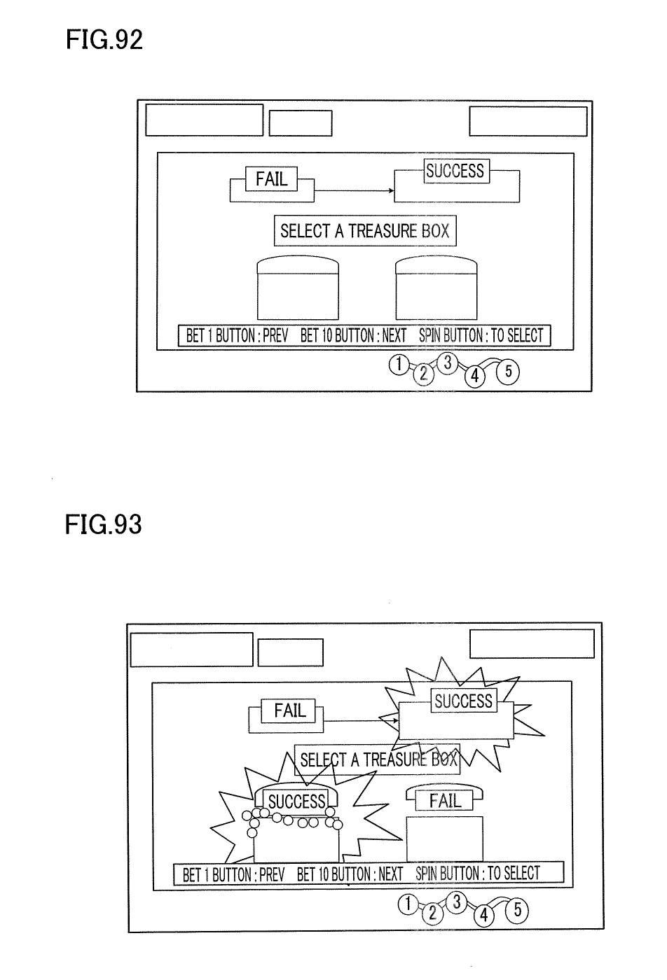

After that, as shown in FIG. 92, two treasure boxes are displayed on the lower image display panel 141, and a navigation text prompting the player to select one of the treasure boxes is displayed. One of the treasure boxes is success, and the other is fail. Further, a bonus credit meter is displayed in the upper part of the screen. Further, a meter corresponding to success and a meter corresponding to fail are displayed below the bonus credit meter. The meter corresponding to fail displays the credit won in the free game, which is moved from the bonus credit meter. The bonus credit meter is hidden, during the selection making by the player. In the lower right part of the screen is displayed a route in the cave in which the mermaid proceeds.

When the player selects one of the two treasure boxes, there will be a teasing effect until the treasure box opens. Then, as shown in FIG. 93, treasure will appear from the treasure box, if the player-selected treasure box is success. Further, as the treasure box opens, the treasure box is displayed with an emphasis. The meter corresponding to success is also displayed brightly. Further, the inside of the other treasure box not selected by the player will be displayed in gray, and the meter corresponding to fail is displayed in gray. The bonus credit meter is displayed, and the credit indicated by the meter corresponding to success is moved to the bonus credit meter. This way, the successful selection is notified to the player. The credit indicated in the meter corresponding to success is doubled and moved to the bonus credit meter.

When the player-selection is successful, the mermaid proceeds further inside of the cave in the movie, as shown in FIG. 91. After that, as shown in FIG. 92, two treasure boxes are displayed again on the lower image display panel 141, and a navigation text prompting the player to select one of the treasure boxes is displayed. At this time, the route displayed in the lower right part of the screen indicates proceeding of 1 step. One of the treasure boxes is success, and the other is fail, as in the first time. When the player selects one of the two treasure boxes, there will be a teasing effect until the treasure box opens.

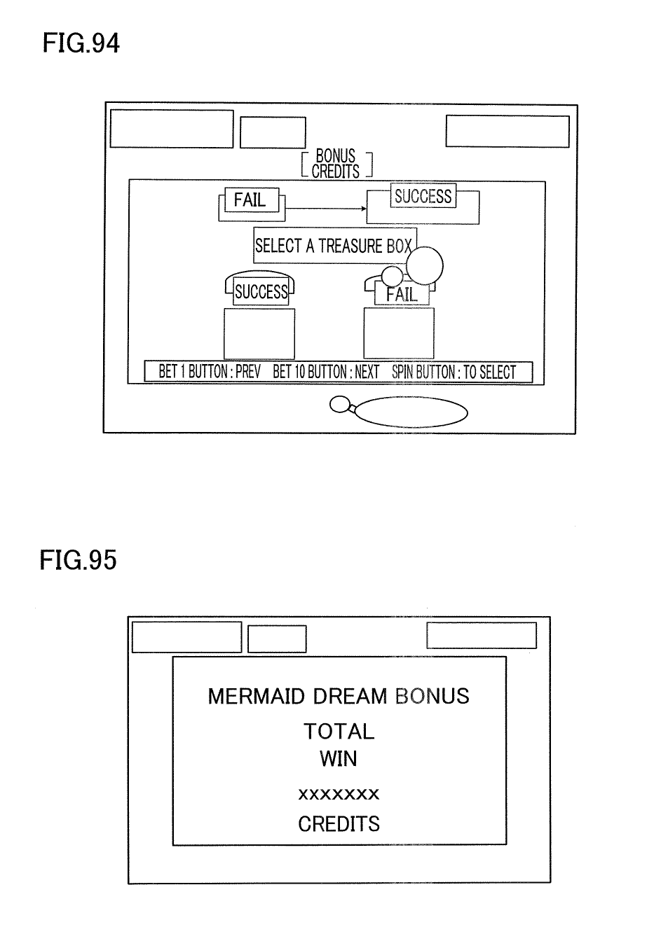

Then, as shown in FIG. 94, bubbles will appear from the treasure box, if the player-selected treasure box is fail. Further, the inside of the other treasure box not selected by the player will be displayed in gray, and the meter corresponding to success is displayed in gray. The bonus credit meter is displayed, and the credit indicated by the meter corresponding to fail is moved to the bonus credit meter. This way, the failure in selection is notified to the player. The bonus is displayed, and the credit indicated by the meter corresponding to fail is moved as it is to the bonus credit meter. Further, in the route shown in the lower right part of the screen, the part the mermaid has not yet proceeded is hidden.

The two treasure boxes displayed on the lower image display panel 141 changes depending on the number of times selection is made. In the first and second selection, wood treasure boxes are displayed. In the third selection, bronze treasure boxes are displayed. In the fourth selection, silver treasure boxes are displayed. In the fifth selection, gold treasure boxes are displayed.

When the player-selection results in fail, or when success is selected five times, the win meter is displayed on the lower image display panel 141 and awarding of the payout to the player is notified, as shown in FIG. 95. In cases of selecting success five times, a special win meter with 4 mermaids is displayed. Selecting success five times will multiplies the payout by 32. The normal game screen is then reinstated.

(Description of Screens: Mystery Mermaid Free Game)

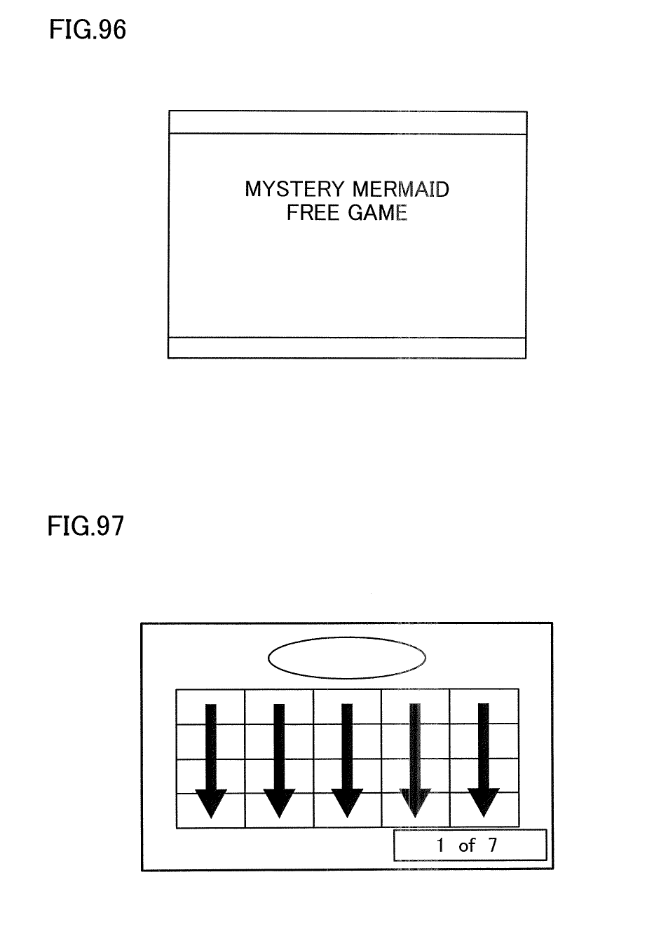

As shown in FIG. 96, when the mystery mermaid free game is selected as the result of wheel bonus random determination, the bonus logo of “Mystery Mermaid Free Game” is displayed on the lower image display panel 141, and the start of the mystery mermaid free game is notified to the player.

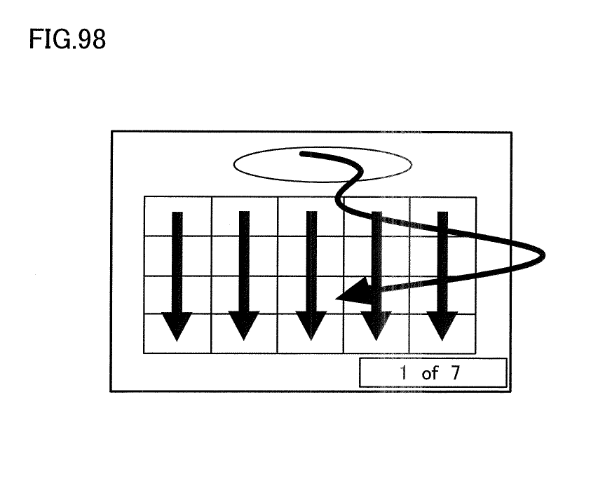

Then, after the introduction effect and displaying of description, free game screen is displayed as shown in FIG. 97. In the upper part of the screen are displayed four mermaids. The four mermaids include a red mermaid, a purple mermaid, a green mermaid, and a blue mermaid. Further, in the lower right part of the screen is displayed the number of games.

In the mystery mermaid free game, a free game is run a plurality of number of times in a row, and the number of times the game is run is initially 7 times. Although this free game is a game run without a bet of a gaming value, it is different from the free game run in the mermaid dream bonus, as hereinabove described. In the present embodiment, the generated bonus random determination table shown in FIG. 13 is used to determine the generated bonus in the free game, in every free game run. As the generated bonus, there are seven types: i.e., payout rate, wild reel, scattering wild, additional game count, a combination of payout rate and wild reel, a combination of payout rate and scattering wild, and a combination of wild reel and scattering wild. The free game involves the symbol table shown in FIG. 9A and FIG. 9B. Further, there is no retrigger for this free game. The initial position of the reel is the position “0”.

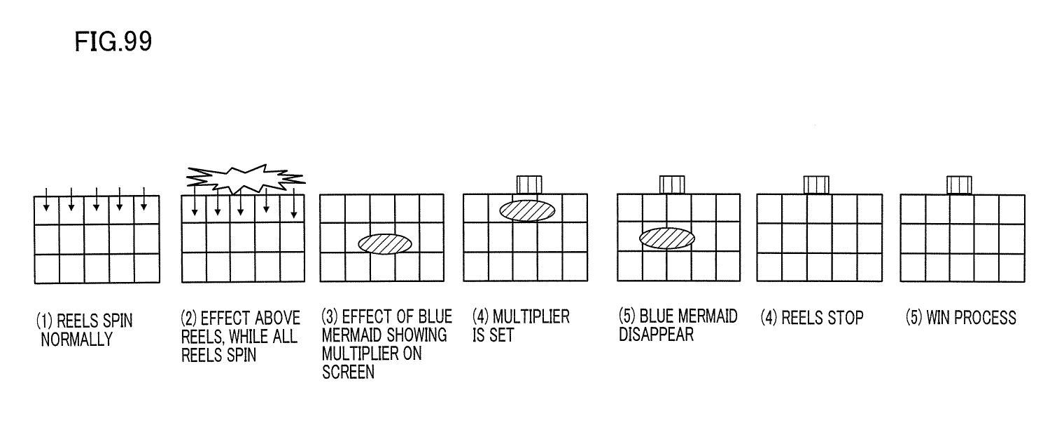

In the free game, an effect such that a mermaid corresponding to the generated bonus determined makes an action is provided while the pseudo reels 151 to 155 are scrolling, as shown in FIG. 98. When the generated bonus is the “payout rate”, the blue mermaid makes an action in the effect. Specifically, as shown in FIG. 99, the blue mermaid lifts up a big seashell and a small seashell twice, while the reels are scrolling. Then, an effect is provided in which the mermaid salvages a seashell showing the payout rate determined by using the multiplying factor random determination table shown in FIG. 14. Then, the blue mermaid disappear from the screen.

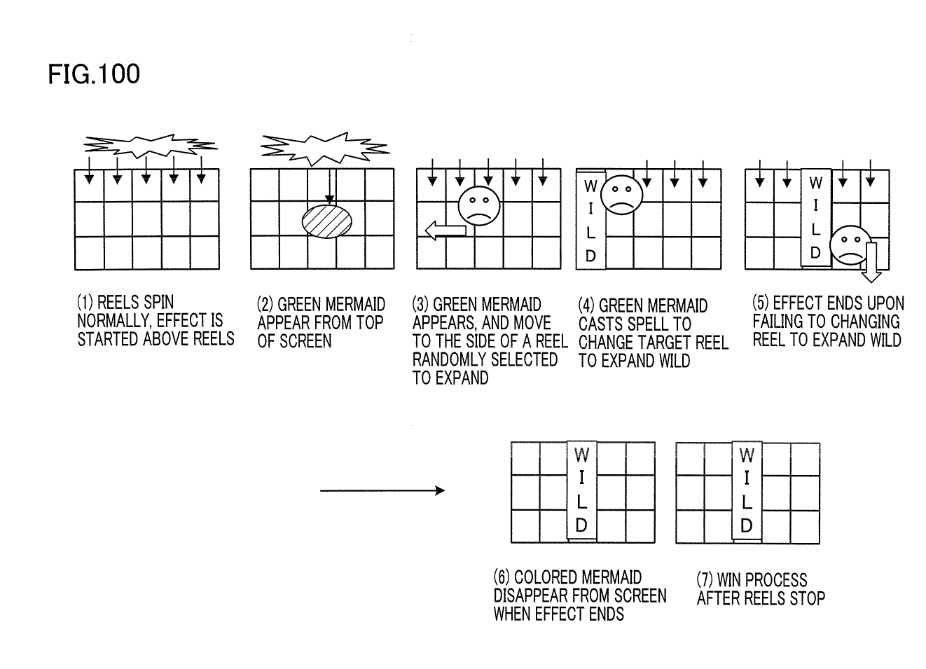

When the generated bonus is the “wild reel”, the green mermaid makes an action in the effect. Specifically, as shown in FIG. 100, the green mermaid appears from the upper part of the screen, while the pseudo reels 151 to 155 are spinning, and then moves to a reel determined by using the wild reel random determination table shown in FIG. 15. Then, an effect is provided in which the green mermaid casts a spell to change the target reel to the wild reel. Then, an effect is provided in which the green mermaid casts a spell to change a non-target reel to the wild reel and then fail to do so. Then, the green mermaid disappear from the screen.

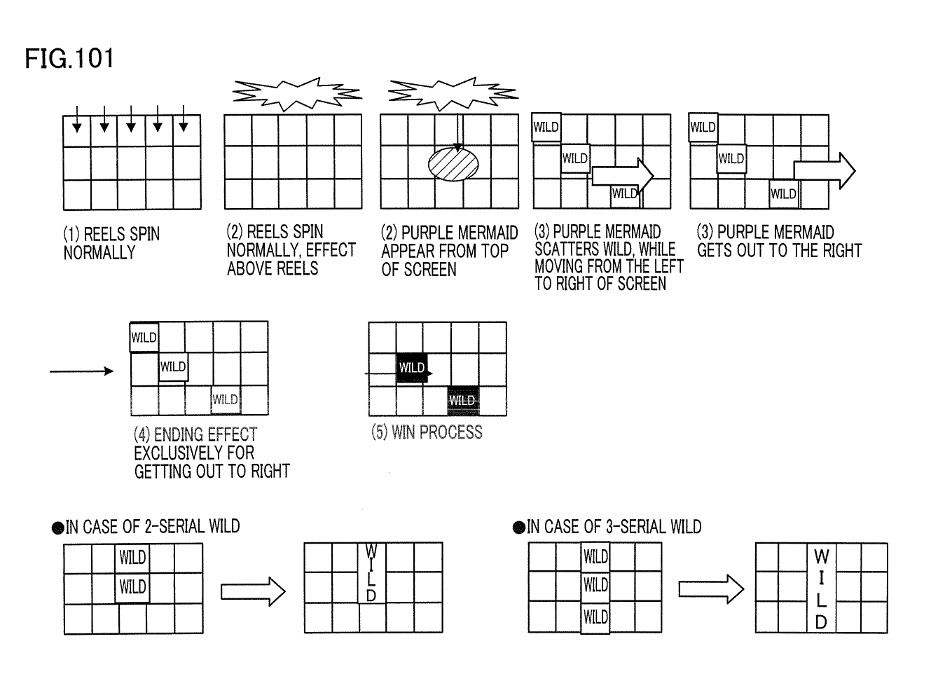

When the generated bonus is the “scattering wild”, the purple mermaid makes an action in the effect. Specifically, as shown in FIG. 101, the purple mermaid appears from the upper part of the screen, while the reels are spinning, and then while moving from the left to the right of the screen, scatters a certain number of wild symbols determined by using the scattering wild random determination table shown in FIG. 16, in any of the 15 display blocks 28. Then, the purple mermaid disappear from the screen.

It should be noted that, when the scattered wild symbols are aligned vertically, the wild symbols form a single wild symbol including the series of wild symbol aligned vertically. Then, the purple mermaid disappear from the screen.

When the generated bonus is the combination of “payout rate and Wild reel”, the effect of the green mermaid making an action is first provided, and then the effect of the blue mermaid making an action is provided. That is, the “wild reel” occurs first, followed by the “payout rate”. When the generated bonus is the combination of “payout rate and scattering wild”, the effect of the purple mermaid making an action is first provided, and then the effect of the blue mermaid making an action is provided. That is, the “scattering wild” occurs first, followed by the “payout rate”. When the generated bonus is the combination of “wild reel and scattering wild”, the effect of the green mermaid making an action is first provided, and then the effect of the purple mermaid making an action is provided. That is, the “wild reel” occurs first, followed by the “scattering wild”.

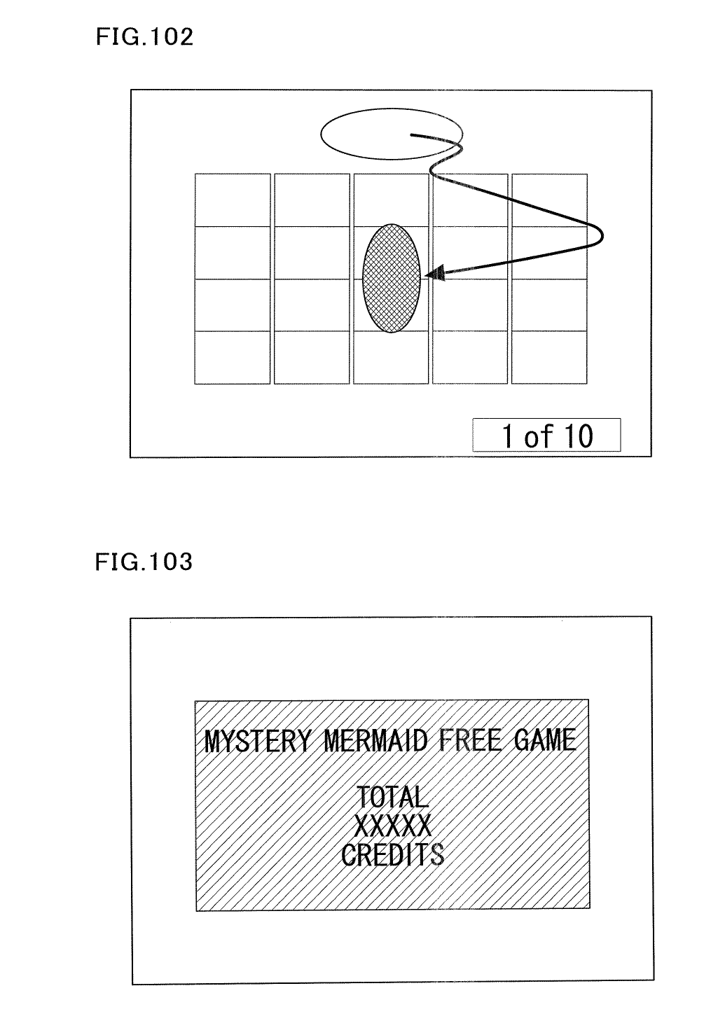

Then the rotation of the reels stops as shown in FIG. 102. At this time, when the generated bonus is the “additional game count”, the red mermaid makes an action in the effect. Specifically, an effect is provided in which the red mermaid tosses a game count determined by using the additional game count random determination table shown in FIG. 17, and the tossed game count is added to the current game count.

When the game count is 0, the total win is displayed on the lower image display panel 141 and awarding of the payout to the player is notified, as shown in FIG. 103. The normal game screen is then reinstated.

(Description of Screens: Big Bubble Bonus)

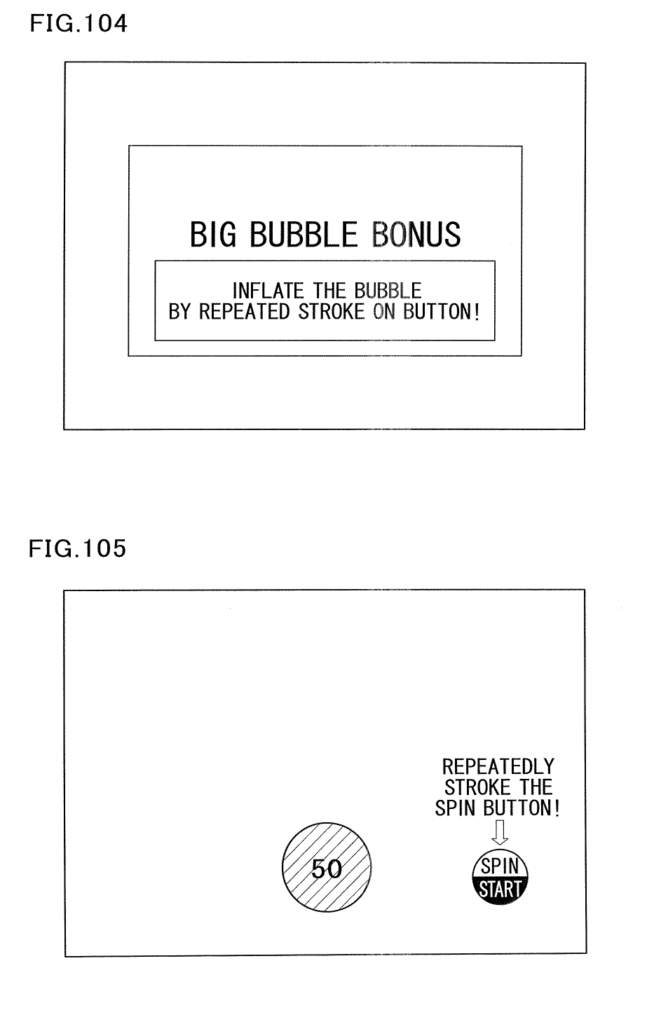

As shown in FIG. 104, when the big bubble bonus is selected as the result of wheel bonus random determination, the bonus logo of “Big Bubble Bonus” is displayed on the lower image display panel 141, and the start of the Big Bubble bonus is notified to the player. Further, on the lower image display panel 141, there will be text that informs the player that the game is to inflate the bubble by repeated strokes of the spin button 46.

Then, after the introduction effect, a single bubble is displayed in the lower part of the screen, as shown in FIG. 105. At the center of the bubble is indicated the credit amount. The credit amount at the start of the game is 0. Further, in the lower right part of the screen is displayed text reading “Repeatedly stroke the SPIN button”, along with the image of the spin button.

The credit indicated at the center of the bubble increases, with the repeated stroke of the spin button 46 by the player. The size of the bubble changes, when the credit reaches a predetermined value. Specifically, as shown in the sorting table of FIG. 21, the size of bubble changes from the “small” to the “medium”, when the credit changes from 300 to 330. It should be noted that the credit as well as the size of the bubble make no changes, without the repeated strokes of the spin button 46 by the player.

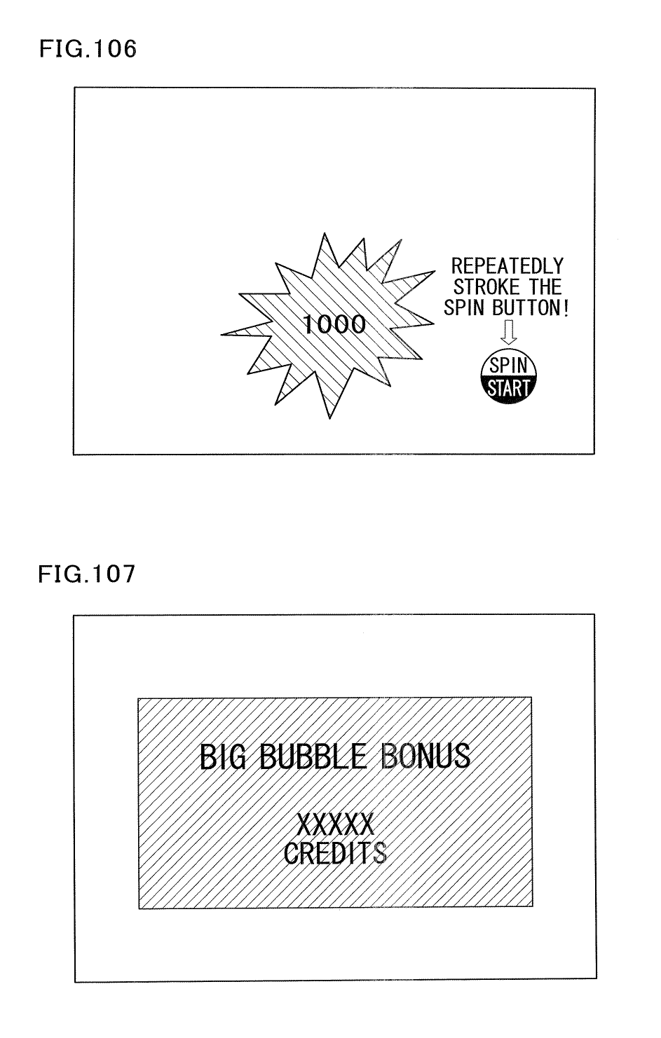

When the credit indicated at the center of the bubble reaches the amount of payout determined by using the big bubble bonus payout amount random determination table shown in FIG. 20, the bubble collapse and the credit inside is indicated as shown in FIG. 106. At the same time the bubble collapse, the text and the image of spin button displayed in the lower right part of the screen disappear.

Then, the payout is displayed on the lower image display panel 141 and awarding of the payout to the player is notified, as shown in FIG. 107. The normal game screen is then reinstated.

(Description of Screen: Swimming Mermaid Bonus)

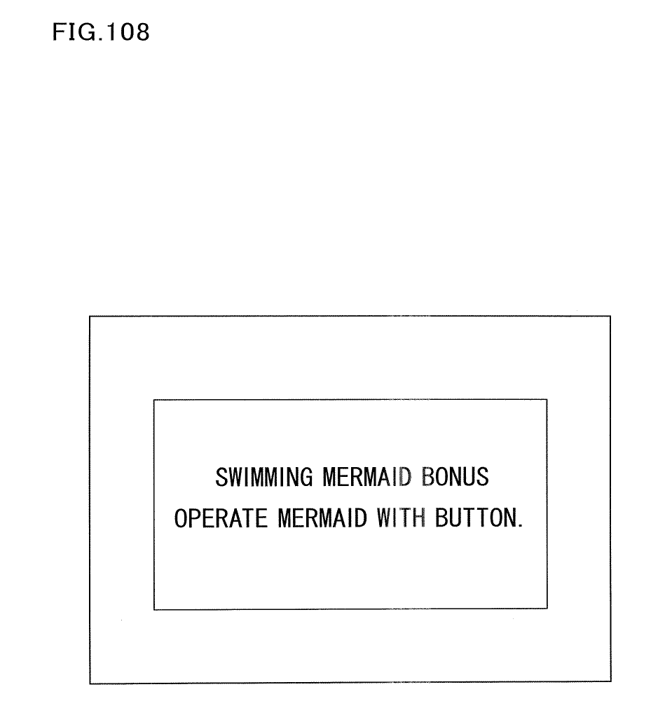

As shown in FIG. 108, when the swimming mermaid bonus is selected as the result of wheel bonus random determination, the bonus logo of “Swimming Mermaid Bonus” is displayed on the screen, and the start of the swimming mermaid bonus is notified to the player. Further, on the lower image display panel 141, there will be text that informs the player that the game is to operate the mermaid by the spin button 46.

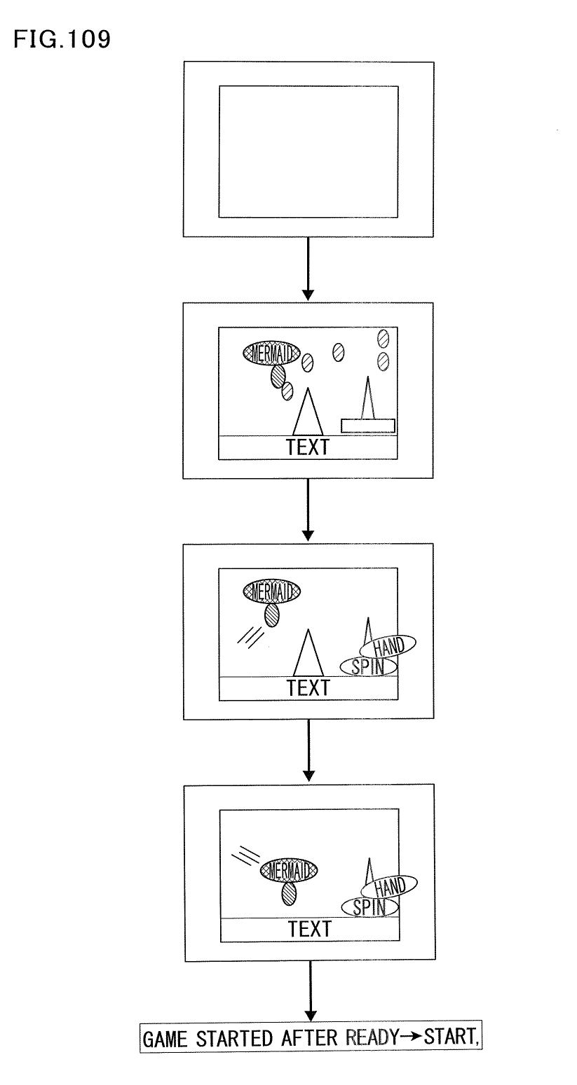

Then, after the introduction effect, a separate window opens in the center of the game screen, and a game movie explaining the game content is displayed, as shown in FIG. 109. In this movie of 7 seconds, the mermaid collects coins, along with text reading “In this game, the mermaid is operated by the SPIN button to collect coins.” Then, along with the text “Repeated strokes of SPIN button moves the mermaid upward”, an image of stroking the spin button 46 by a hand and the movie of the mermaid moving upward with the repeated stroke are displayed for 5 seconds. Then, with the text “the mermaid sinks if not pressed”, an image of the hand not touching the spin button 46 and a movie of the mermaid sinking along with it are displayed for 4.5 seconds.

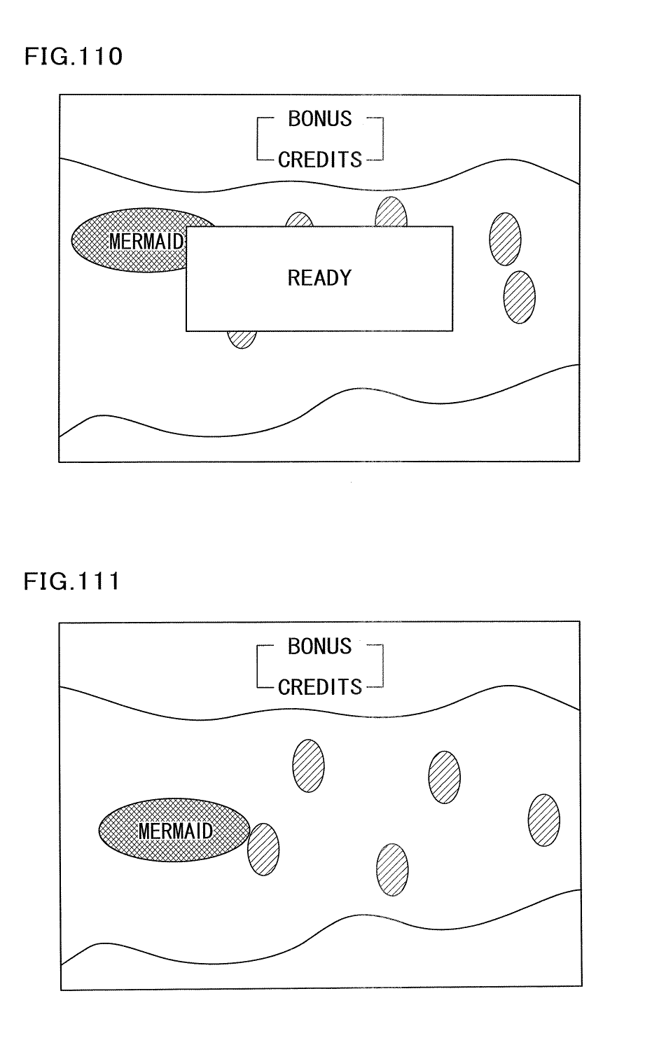

After that, the game start screen is displayed as shown in FIG. 110. The game screen includes a cave, a mermaid positioned between the ceiling and the ocean floor of the cave, a plurality of coins scattered within the cave, and text reading “READY”. When the game starts, the background scrolls from the left to right, as shown in FIG. 111. During the game, the mermaid gradually sinks. Every time the player presses the spin button 46, the mermaid moves upward a little by little. When the mermaid touches a coin, the coin disappear and credit is indicated. The amount of credit is determined based on the sorting patterns shown in FIG. 23.

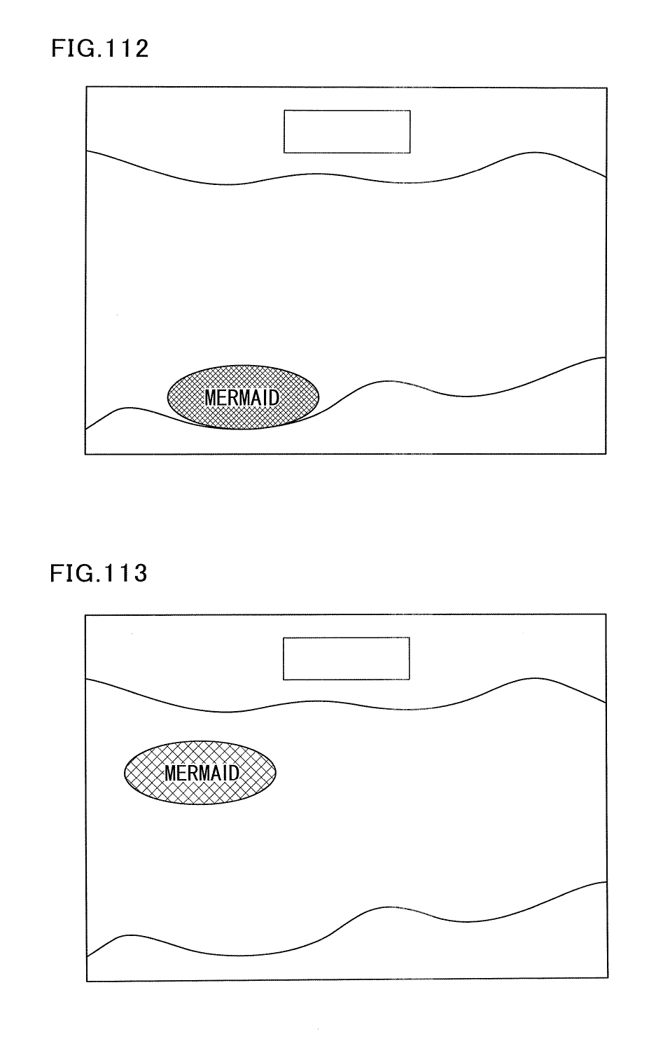

Further, as shown in FIG. 112, when the mermaid touches an obstacle such as the ocean floor as shown in FIG. 112, the mermaid becomes semi-transparent and repels to the uppermost part of the screen and be in pain, as shown in FIG. 113. This is displayed for 1.5 seconds. The mermaid cannot be operated during this period, and the credit will not increase even if the mermaid touches a coin. Further, the mermaid does not touch another obstacle such as the ceiling. However, the background continues to scroll even during this period. Upon elapse of 1.5 seconds, the mermaid recovers and can be operated again.

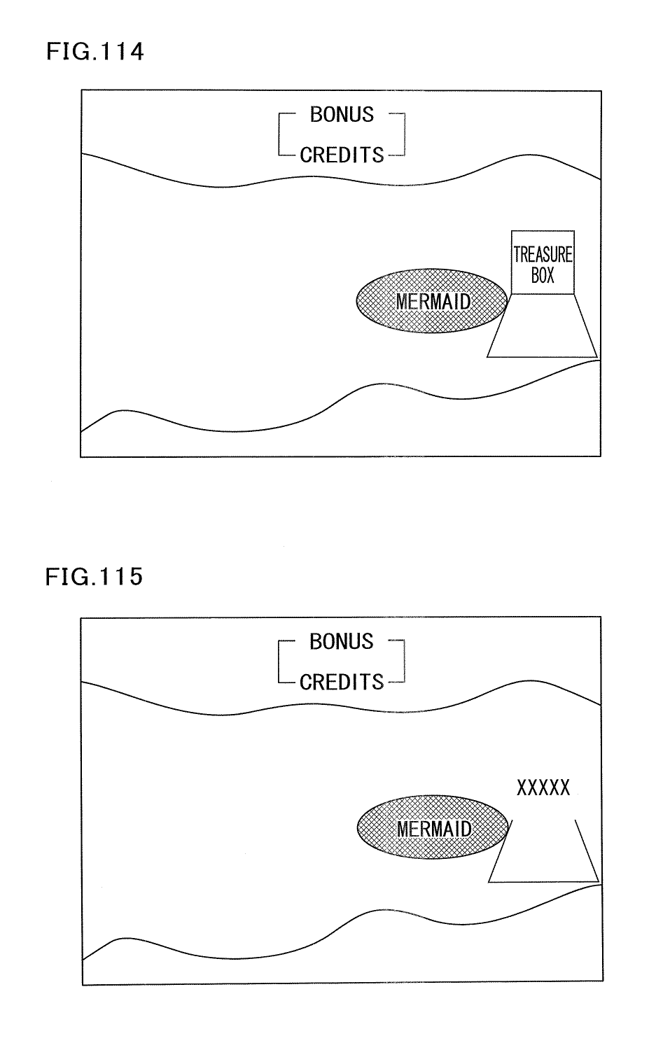

As shown in FIG. 114, when the mermaid reaches the innermost of the cave, a treasure box is displayed, and there will be an effect of mermaid opening the treasure box is executed. As shown in FIG. 115, credit appears from the treasure box, and the delighted mermaid is displayed. The credit coming out from the treasure box is the remaining amount of payout determined by using the swimming mermaid bonus payout amount random determination table shown in FIG. 22, which amount was not obtained by the coins.

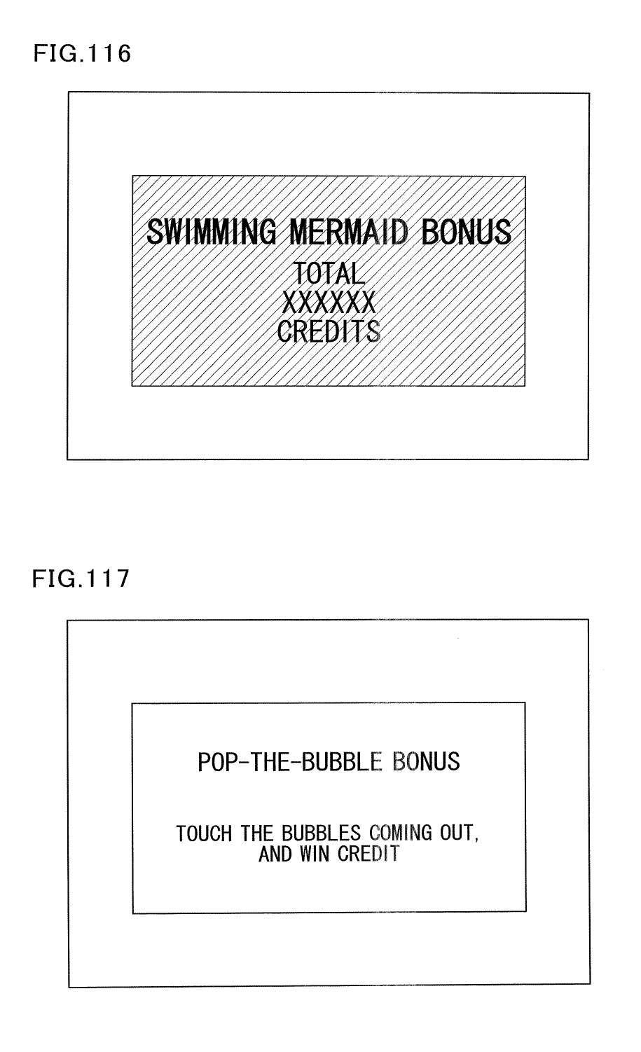

Then, the credit is displayed on the lower image display panel 141 and awarding of the payout to the player is notified, as shown in FIG. 116. The normal game screen is then reinstated.

(Description of Screens: Pop-the-Bubble Bonus)

As shown in FIG. 117, when the pop-the-bubble bonus is selected as the result of wheel bonus random determination, the bonus logo of “Pop-The-Bubble Bonus” is displayed on the lower image display panel 141, and the start of the pop-the-bubble bonus is notified to the player. Further, on the lower image display panel 141, there will be text that informs the player that the game is to touch the bubbles coming out to win credit.

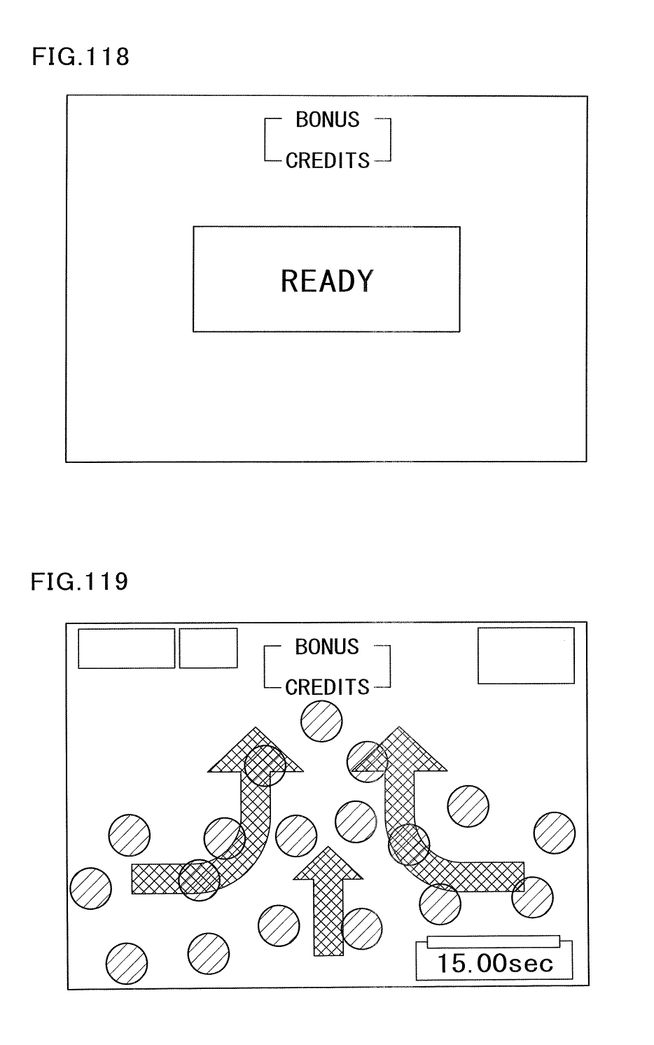

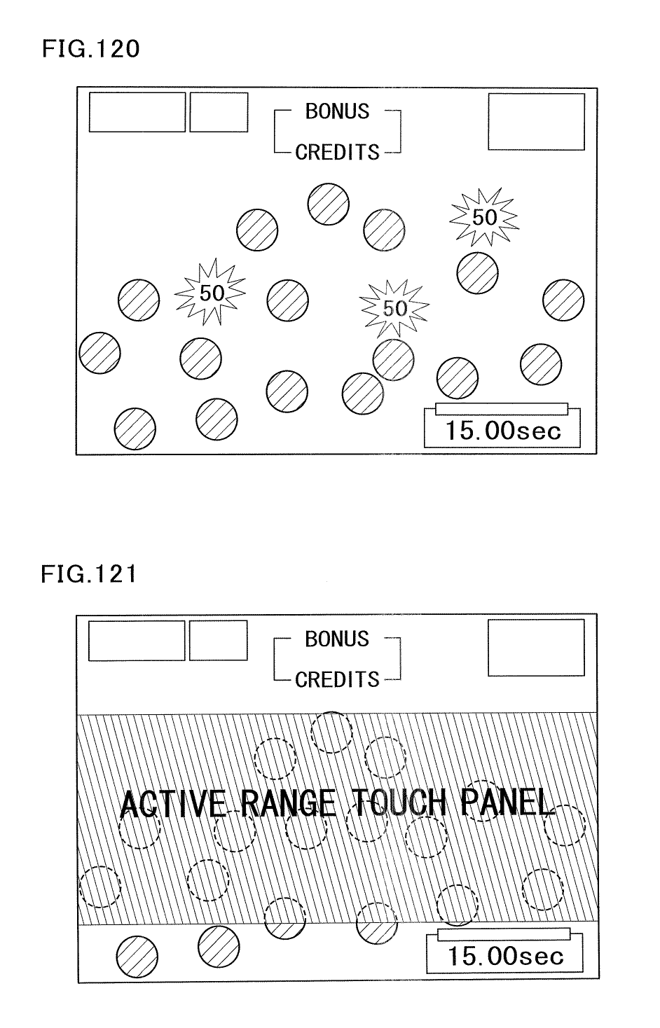

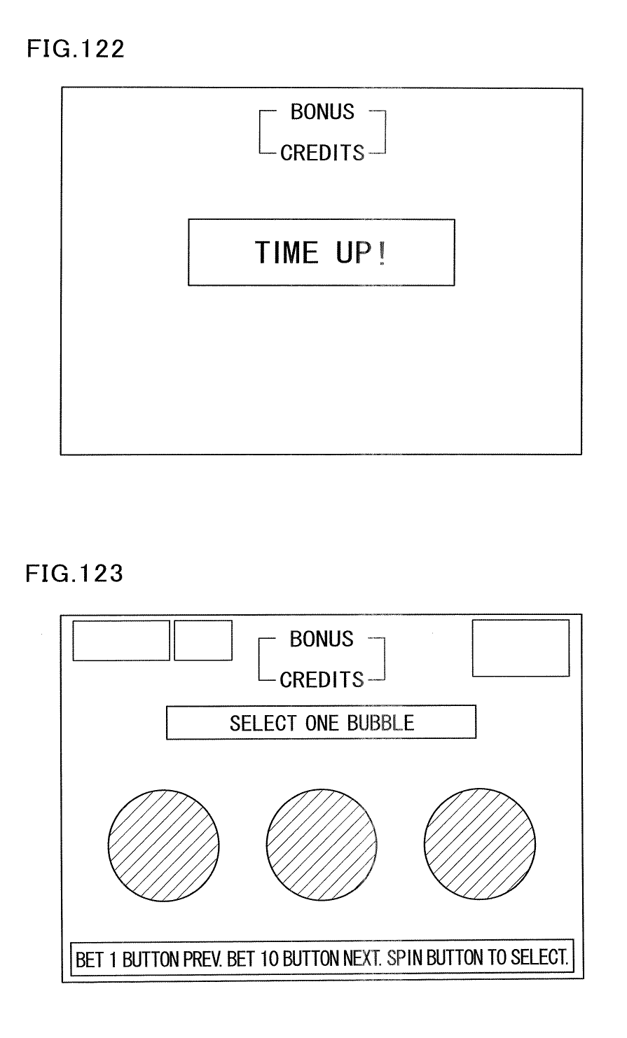

Then, after the introduction effect, a start screen including text reading “READY” is displayed on the lower image display panel 141 as shown in FIG. 118. Then, the game is started. The game period is 15 seconds. When the game starts, countless bubbles go up from the bottom of the screen, as shown in FIG. 119. The remaining period of the game is indicated in the lower right of the screen. As shown in FIG. 120, the bubble picked by the player cracks and a payout appears from inside. The credit appeared from the cracked bubble is added to the bonus win meter. It should be noted that, the active area of the touch panel 69 is set from the left end to the right end in the middle portion of the screen, as shown in FIG. 121. Upon elapse of 15 seconds from the start of the game, the lower image display panel 141 displays “TIME UP”, as shown in FIG. 122.

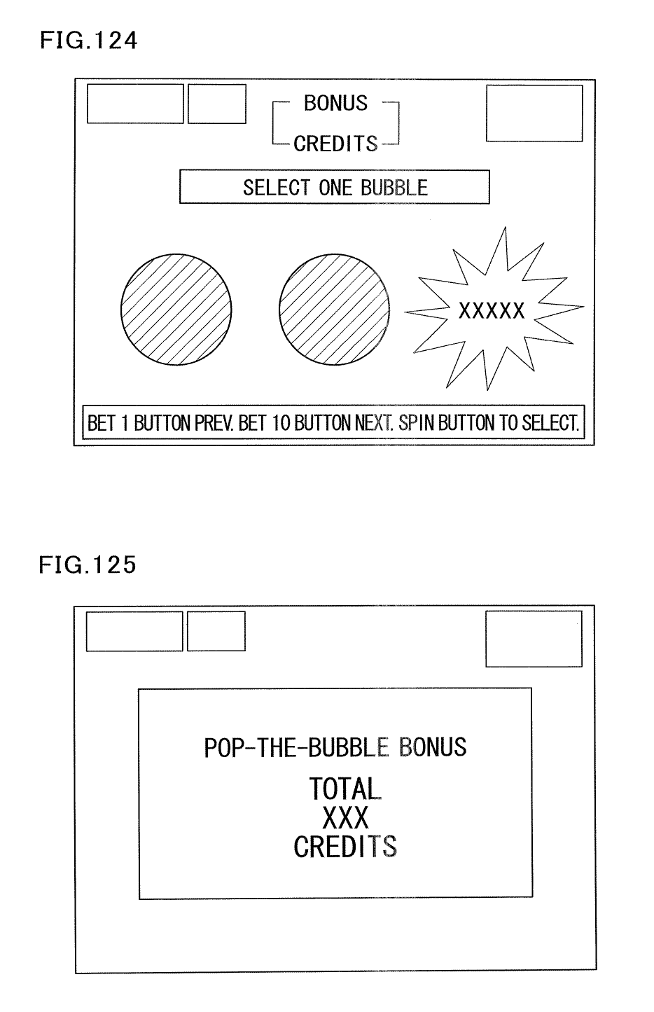

Then, as shown in FIG. 123, three bubbles are displayed in the center of the lower image display panel 141, and text prompting the player to select one of the bubbles is displayed. The contents of the three bubbles are determined by using the 3-choice table shown in FIG. 25. When the player picks any of the three bubbles, the selected bubble cracks and credit appears from inside, as shown in FIG. 124. The credit includes the remaining amount of payout determined by using the pop-the-bubble bonus payout amount random determination table shown in FIG. 24, which amount was not obtained by picking the bubbles, and a predetermined amount of credit. Then, the credit is displayed on the lower image display panel 141 and awarding of the payout to the player is notified, as shown in FIG. 125. The normal game screen is then reinstated.

(Description of Screens: Seashell-Pick Bonus)

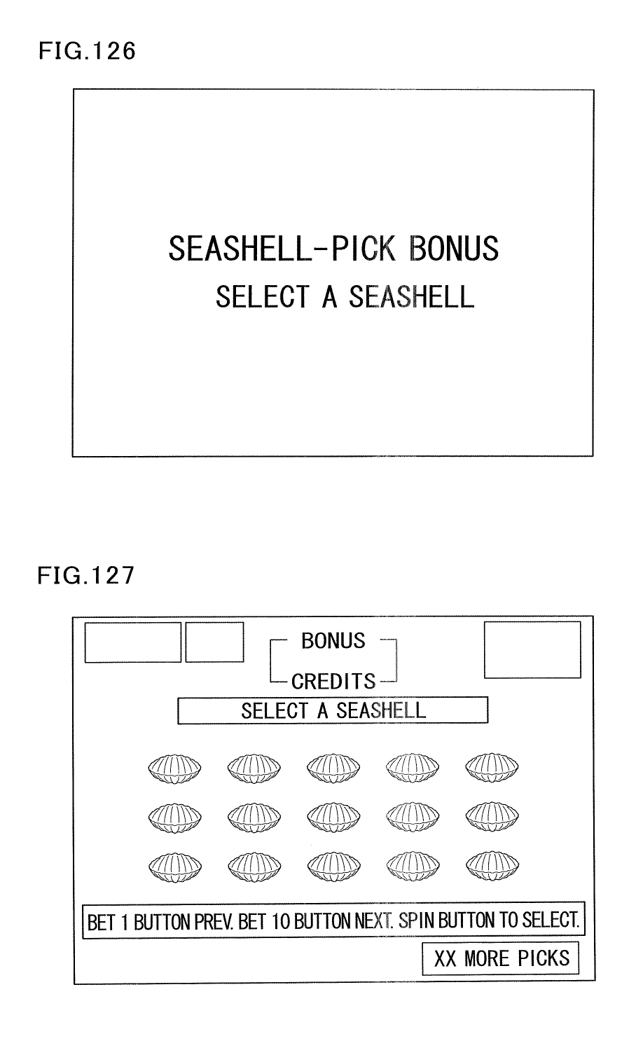

As shown in FIG. 126, when the seashell-pick bonus is selected as the result of wheel bonus random determination, the bonus logo of “Seashell-pick bonus” is displayed on the lower image display panel 141, and the start of the seashell-pick bonus is notified to the player. Further, on the lower image display panel 141, there will be text that informs the player that the game is to select seashells.

Then, after the introduction effect, 15 seashells are displayed in three lines, as shown in FIG. 127. As shown in FIG. 26, of the seashells, 4 seashells are associated with “30 credit”, 2 seashells are associated with “50 credit”, 2 seashells are associated with “100 credit”, 1 seashell is associated with “300 credit”, and 4 seashells are associated with “additional picks”. Text of “Select a seashell” is displayed in the upper part of the screen. The number of picks at the start of the game is 3 times.

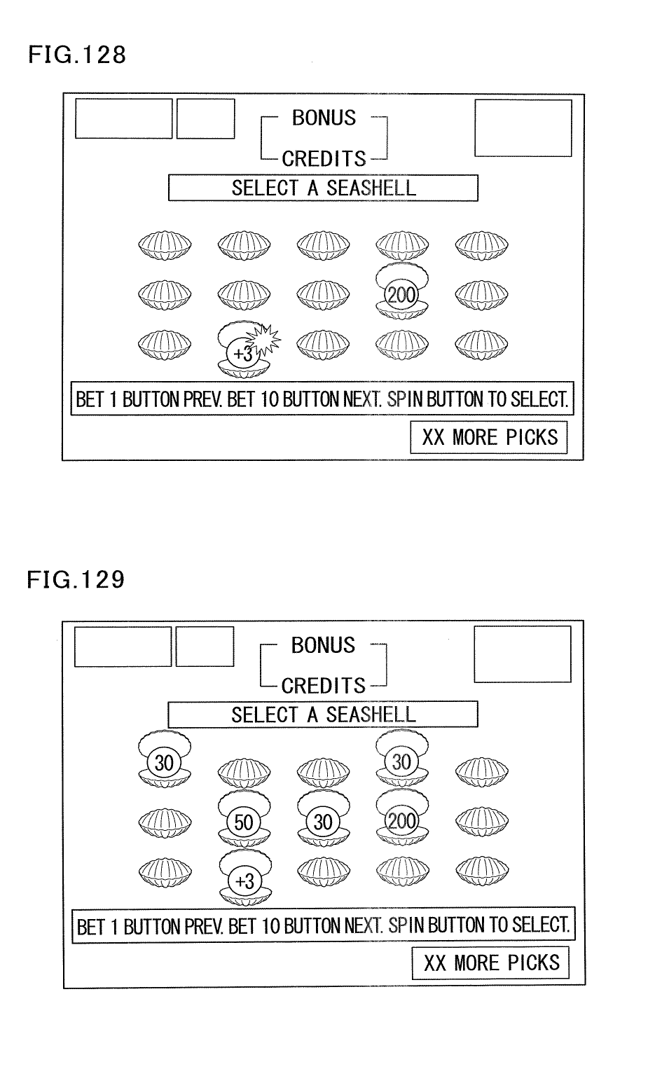

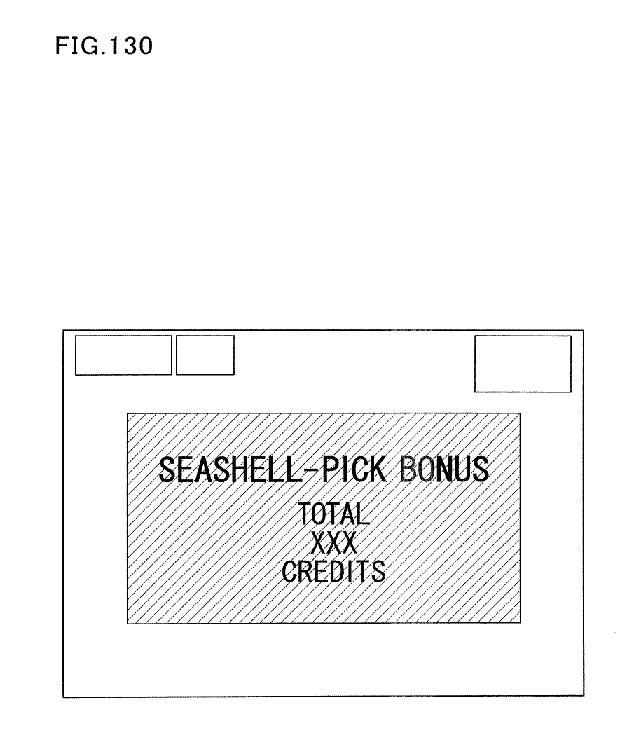

As shown in FIG. 128, the seashell picked by the player opens, and credit or a number of picks appears from the seashell. Every time the player picks a seashell, the remaining number of picks is reduced by 1. The credit appeared from the seashell is added to the bonus win meter. When a seashell associated with a number of picks, the number of picks is lighted up, and the number of picks is added to the remaining number of picks indicated in the lower right part of the screen. The pick of the seashell is continued until the number of picks reaches 0, as shown in FIG. 129. When the remaining number of picks is 0, the contents of seashells not selected by the player are displayed. Then, as shown in FIG. 130, total win is displayed on the lower image display panel 141 and awarding of the payout to the player is notified, as shown in FIG. 130. The normal game screen is then reinstated.

(TOTAL WIN Signboard)

After the end of the bonus, the total obtained credit is displayed on the lower image display panel 141. In accordance with the obtained credit (i.e., how many times as large as the total bet), one of three types of effects is used.

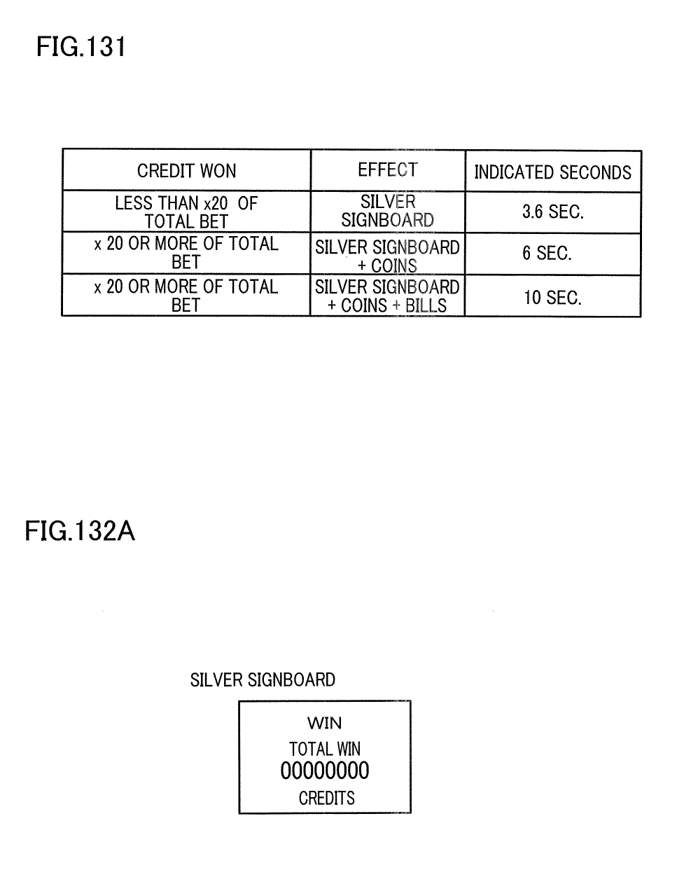

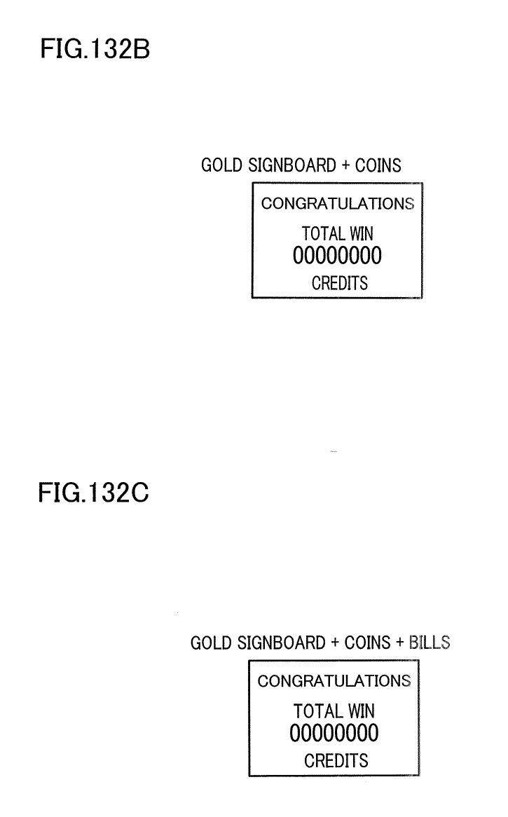

To be more specific, as shown in FIG. 131, the relationship between the obtained credit, the effect, and display seconds is as below. When the total obtained credit is less than 20 times as large as the total bet, a silver signboard is displayed for 3.6 seconds as shown in FIG. 132A. When the total obtained credit is not less than 20 times and less than 50 times as large as the total bet, a gold signboard and coins are displayed for 6 seconds as shown in FIG. 132B. When the total obtained credit is 50 or more times as large as the total bet, the gold signboard and coins and bills are displayed for 10 seconds as shown in FIG. 132C. When the “display seconds” elapse, the total WIN signboard disappears. Furthermore, after four seconds elapse from the start of the image display, the image display can be skipped by pressing the spin button or the maximum BET button.

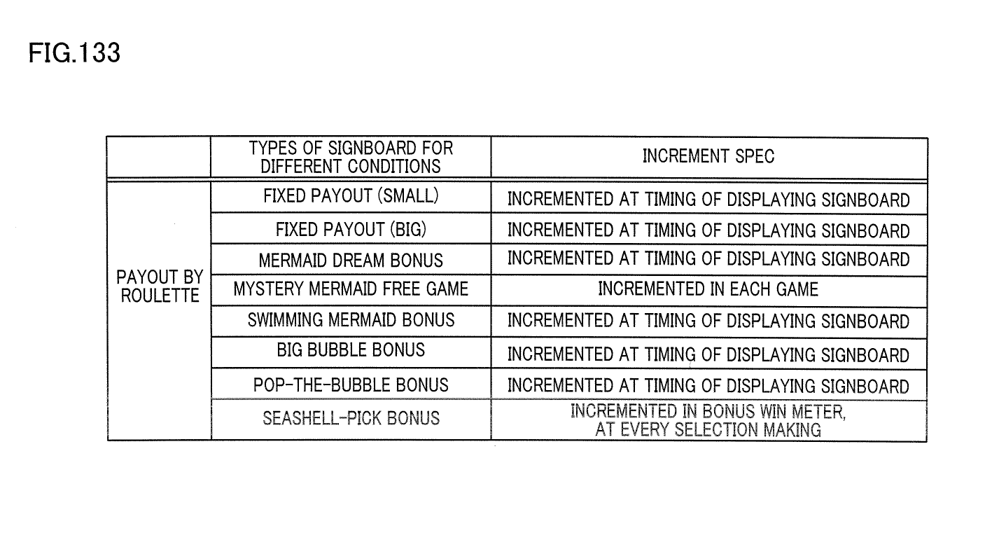

FIG. 133 shows a relation between each bonus and increment rate. For example, in cases of a fixed payout (small), the credit is incremented at the timing of showing the signboard. Further, in cases of the seashell-pick bonus, the credit is incremented in the bonus win meter every time a seashell is selected, and the credit is incremented at the timing of showing the signboard.

(Description of Screens: Mystery Feature)

In the slot machine 1 of the present embodiment, the mystery feature trigger condition may be established, thus leading to occurrence of mystery feature, when the “BONUS” symbol (specific symbol 502) is not displayed on the third reel 153, in the normal game. When the mystery feature occurs, any of three types of features occurs during the base game. The three types of features are: “payout rate”, “wild reel”, and “scattering wild”. These are the same as the previously described payout rate, wild reel, and scattering wild which are the generated bonuses of the mystery mermaid free game. Therefore, no further descriptions are provided as to the screens. Note however that the scattering wild of the mystery feature is not executed when the wild symbol is rearranged in any of the 15 display blocks 28.

(Contents of Program)

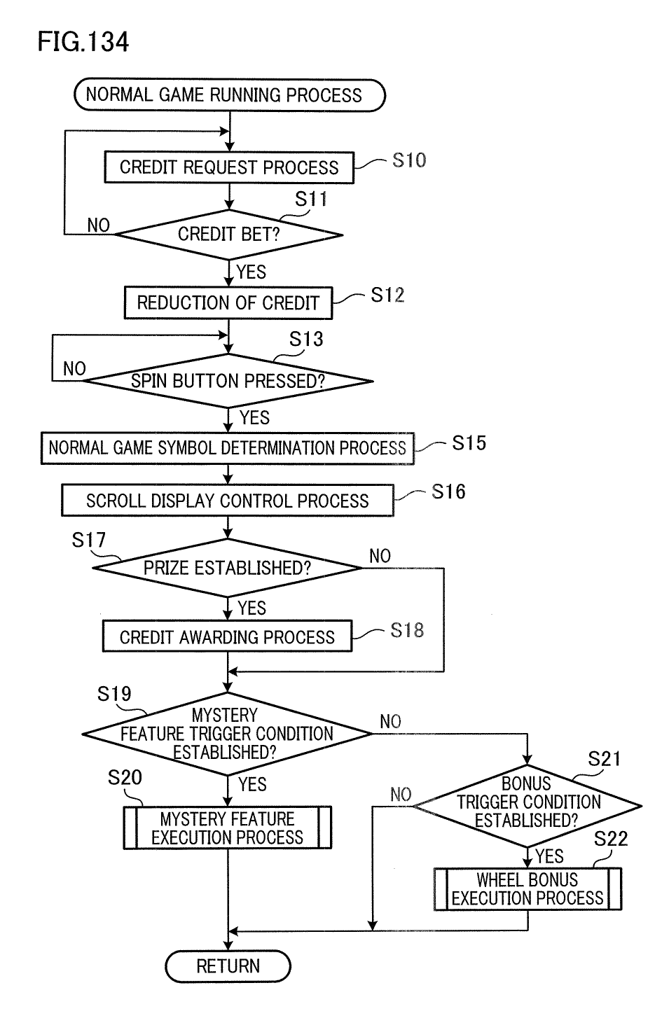

Now, the program to be executed by the slot machine 1 is described with reference to FIG. 134 to FIG. 142.

(Main Control Process)

The operation of the slot machine 1 arranged as above will be described. The normal game running process shown in FIG. 134 is executed by the main CPU 71 of the slot machine 1. The slot machine 1 has been activated in advance.

To begin with, the main CPU 71 executes a credit request process (S10). In this process, the player determines how many credits are used from the credits stored in the IC card.

Then, the main CPU 71 determines whether or not credit is bet (S11). In this process, the main CPU 71 determines whether an input signal output from the 1-BET switch 34S when the 1-BET button 34 is pressed and an input signal output from the 10-BET switch 39S when the 10-BET button 39 is pressed are received. When it is determined that no credit is bet (S11: NO), the process goes back to S10.

In the meanwhile, if it is determined in S11 that credit is bet (S11: YES), the main CPU 71 executes a process of reducing the credit amount stored in the RAM 73 in accordance with the credit amount bet (S12). When the credit amount bet is larger than the credit amount stored in the RAM 73, the step of reducing the credit amount stored in the RAM 73 is not executed and the process goes back to S11. When the credit amount is larger than the maximum amount (maximum bet amount in the present embodiment) of credit on one game, the step of reducing the credit amount stored in the RAM 73 is not executed and the process proceeds to S13.

Then the main CPU 71 determines whether the spin button 46 is pressed (S13). In this step, the main CPU 71 determines whether an input signal output from the start switch 46S when the spin button 46 is pressed is received. When it is determined that the spin button 46 is not pressed (S13: NO), the process goes back to S10. It is noted that, when the spin button 46 is not pressed (e.g., when an instruction to end a game is input while the spin button 46 is not pressed), the main CPU 71 cancels the reduction result in S12.

In the meanwhile, if it is determined in S13 that the spin button 46 is pressed (S13: YES), the main CPU 71 executes a normal game symbol determination process (S15). In the normal game symbol determination process, code numbers when the symbols are stopped are determined. More specifically, a random number is sampled, and the code number when each symbol array of the display block 28 stops is determined based on the sampled random number and a base game symbol table shown in FIG. 7A and FIG. 7B.

Thereafter, in S16, the main CPU 71 executes a scroll display control process. In this process, the display control is conducted so that, after the start of the scroll of the symbols, the symbols are rearranged in accordance with S15.

Thereafter, the main CPU 71 determines whether a prize is established (S17). The main CPU 71 executes this step of S17 for each types of symbols rearranged, for all the symbols rearranged in S16. Furthermore, whether a predetermined number or more of scatter symbols (WILD symbol 503b) are rearranged is determined.

When it is determined that a prize is established in S17 (S17: YES), the main CPU 71 executes a credit awarding process (S18).

When a prize is determined as not established in S17 (S17: NO), or after the process of S18, the main CPU 71 determines whether or not the mystery feature trigger is triggered (S19). When it is determined that the mystery feature trigger is established with no bonus symbol displayed on the third reel 153 (S19: YES), the main CPU 71 executes the mystery feature execution process (S20). Then, the present routine is terminated.

On the other hand, when it is determined that the mystery feature trigger is not established in S19 (S19: NO), the main CPU 71 determines whether or not the bonus trigger condition is established (S21). When it is determined that the bonus trigger condition is not established (S21: NO), the present routine is terminated. When the bonus symbols are displayed in three or more display blocks 28 and when it is determined that the bonus trigger condition is established (S21: YES), the main CPU 71 executes a wheel bonus execution process (S22). Then, the present routine is terminated.

(Wheel Bonus Execution Process)

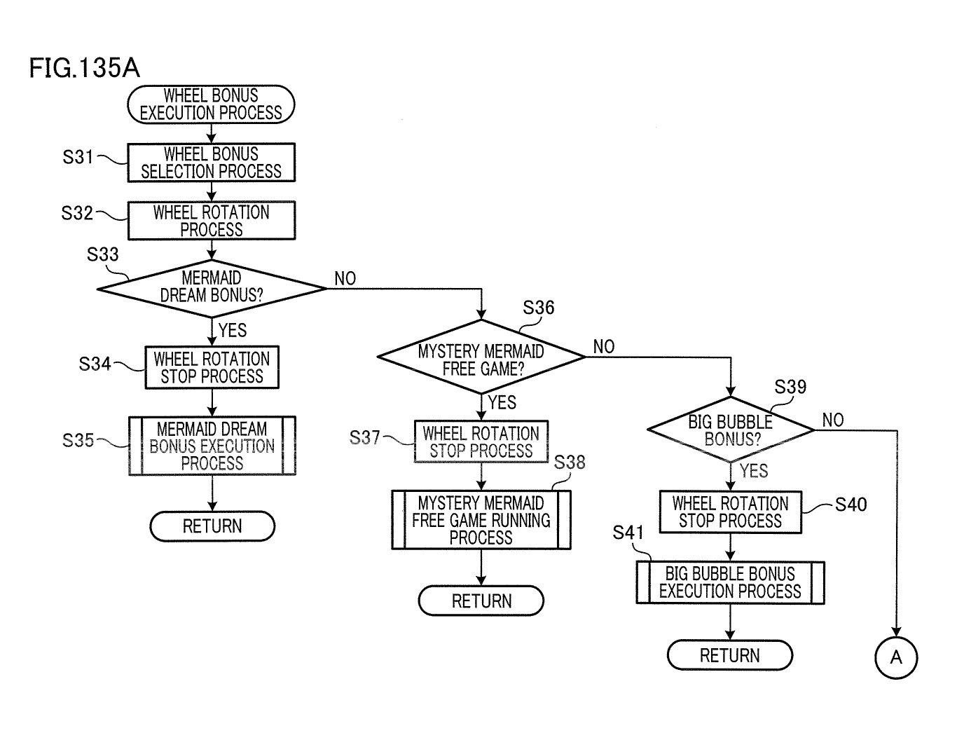

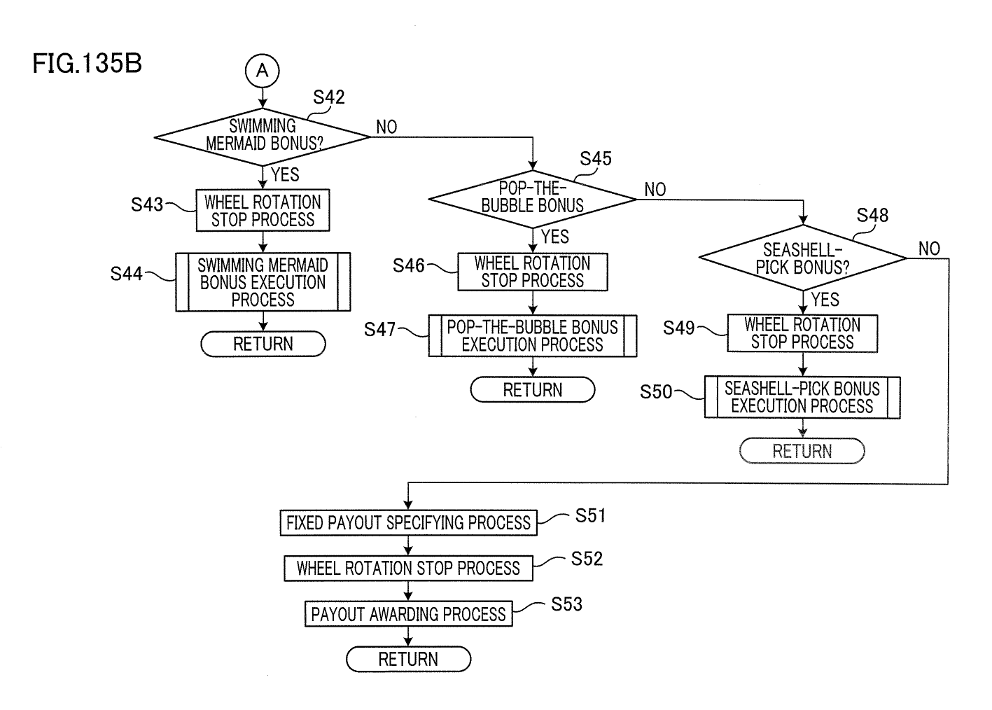

Next, the following describes the wheel bonus execution process, with reference to FIG. 135A and FIG. 135B.

When the wheel bonus execution process is executed, the main CPU 71 first executes a wheel bonus selection process (S31). In the wheel bonus selection process, the main CPU 71 first extracts a random number. Then, any one of the seven types of bonuses in the wheel bonus random determination table of FIG. 12 is randomly selected according to the weight set for each type of bonus and the random number extracted.

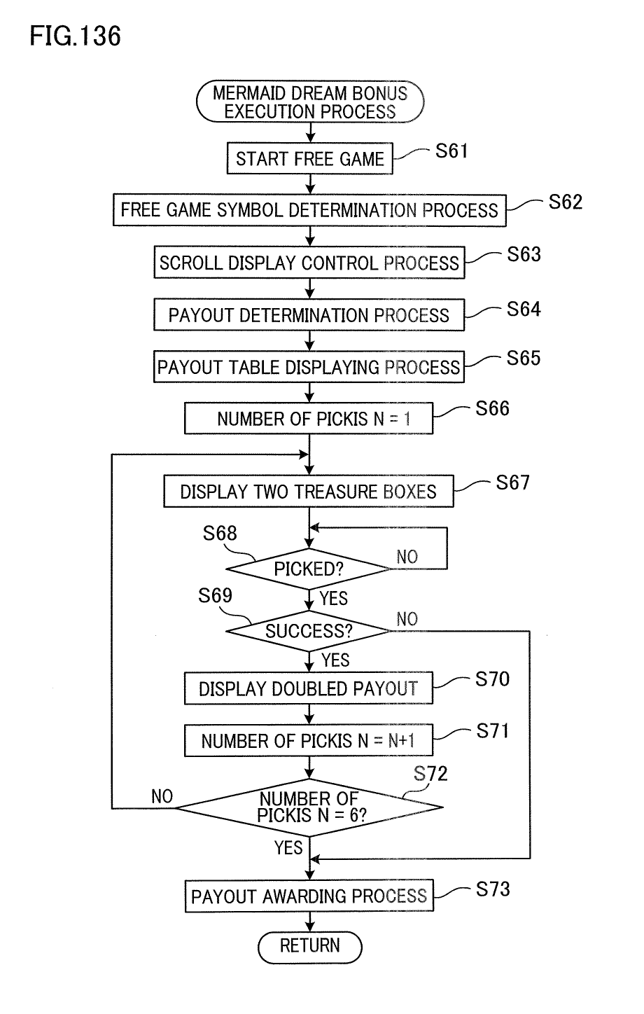

Next, the main CPU 71 rotates the wheel 131 (see FIG. 3) (S32). Subsequently, the main CPU 71 determines whether or not the mermaid dream bonus is selected as the bonus (S33). When it is determined that the mermaid dream bonus is selected (S33: YES), the main CPU 71 executes the wheel rotation stop process (S34). In the process, the rotating wheel 131 is stopped so that the pointer 174 points an area on the surface of the wheel 131, which corresponds to the mermaid dream bonus. The main CPU 71 then executes a mermaid dream bonus execution process which is described later with reference to FIG. 136 (S35). Then, the present routine is terminated.

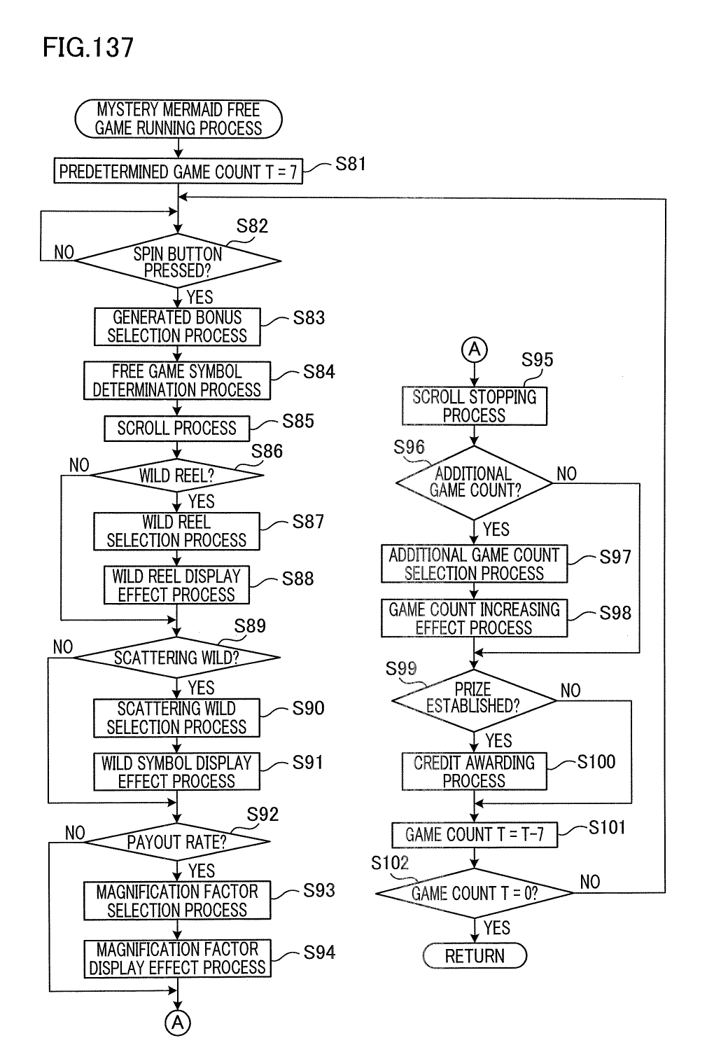

On the other hand, when it is determined in S33 that the mermaid dream bonus is not selected (S33: NO), whether or not the mystery mermaid free game is selected as the bonus is determined (S36). When it is determined that the mystery mermaid free game is selected (S36: YES), the main CPU 71 executes the wheel rotation stop process (S37). In the process, the rotating wheel 131 is stopped so that the pointer 174 points an area on the surface of the wheel 131, which corresponds to the mystery mermaid free game. The main CPU 71 then executes a mystery mermaid free game running process which is described later with reference to FIG. 137 (S38). Then, the present routine is terminated.

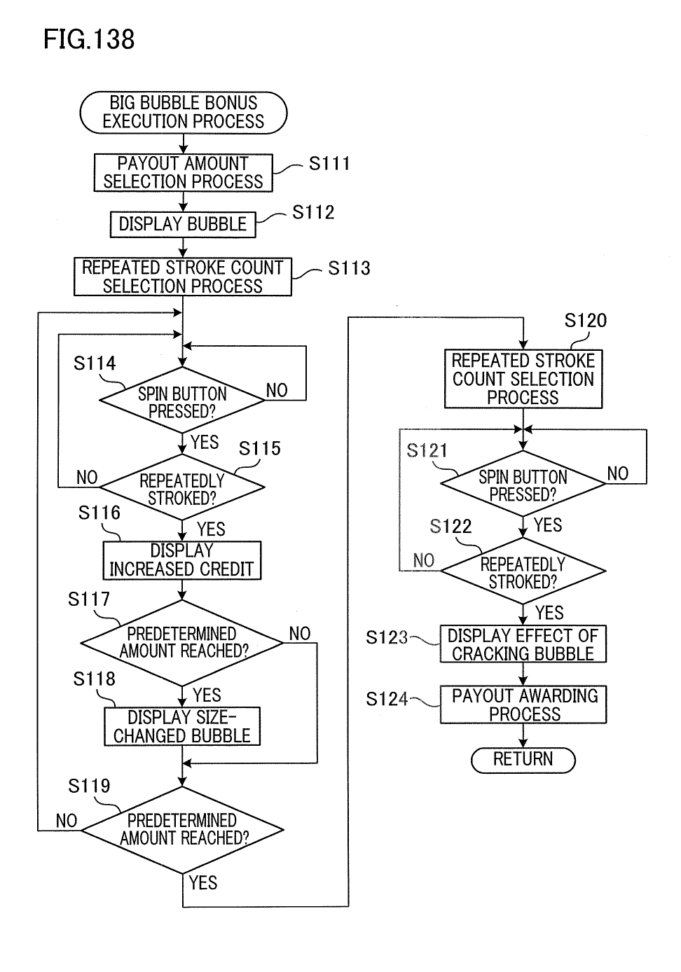

When it is determined in S36 that the mystery mermaid free game is not selected (S36: NO), whether or not the big bubble bonus is selected as the bonus is determined (S39). When it is determined that the big bubble bonus is selected (S39: YES), the main CPU 71 executes the wheel rotation stop process (S40). In the process, the rotating wheel 131 is stopped so that the pointer 174 points an area on the surface of the wheel 131, which corresponds to the big bubble bonus. The main CPU 71 then executes a big bubble bonus execution process which is described later with reference to FIG. 138 (S41). Then, the present routine is terminated.

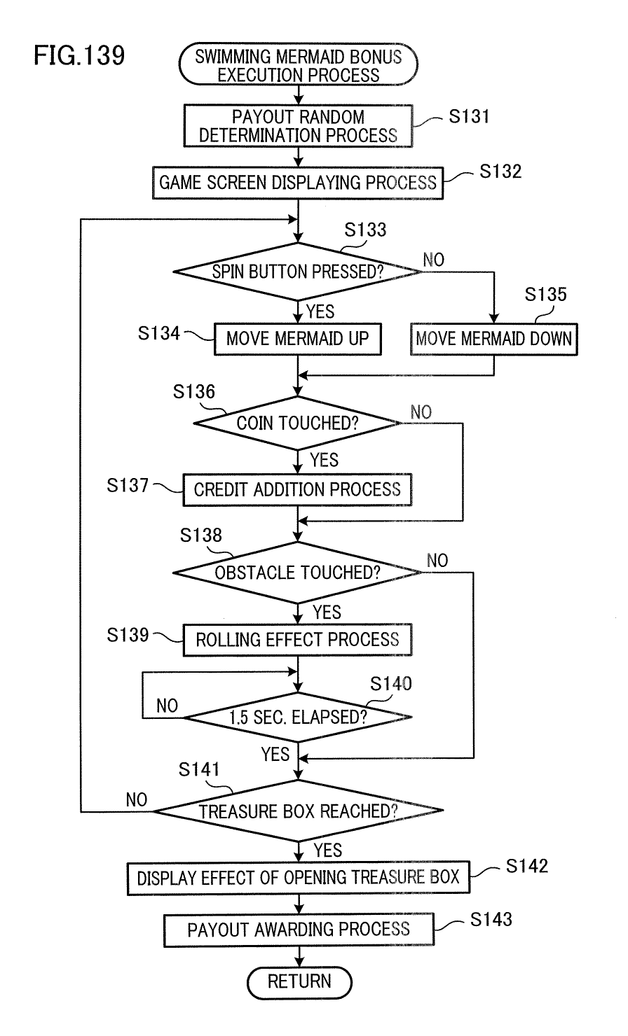

When it is determined in S39 that the big bubble bonus is not selected (S39: NO), whether or not the swimming mermaid bonus is selected as the bonus is determined (S42). When it is determined that the swimming mermaid bonus is selected (S42: YES), the main CPU 71 executes the wheel rotation stop process (S43). In the process, the rotating wheel 131 is stopped so that the pointer 174 points an area on the surface of the wheel 131, which corresponds to the swimming mermaid bonus. The main CPU 71 then executes a swimming mermaid bonus execution process which is described later with reference to FIG. 139 (S44). Then, the present routine is terminated.

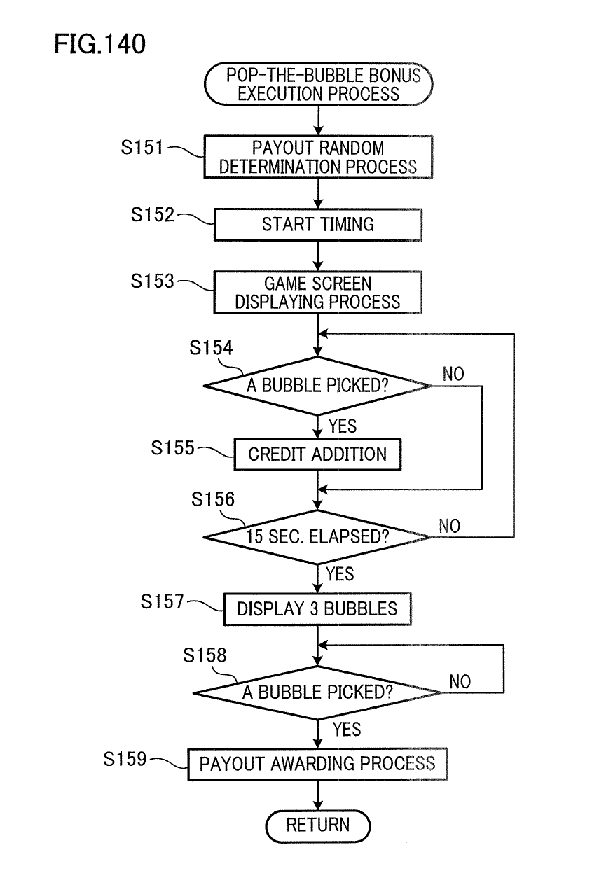

When it is determined in S42 that the swimming mermaid bonus is not selected (S42: NO), whether or not the pop-the-bubble bonus is selected as the bonus is determined (S45). When it is determined that the pop-the-bubble bonus is selected (S45: YES), the main CPU 71 executes the wheel rotation stop process (S46). In the process, the rotating wheel 131 is stopped so that the pointer 174 points an area on the surface of the wheel 131, which corresponds to the pop-the-bubble bonus. The main CPU 71 then executes a pop-the-bubble bonus execution process which is described later with reference to FIG. 140 (S47). Then, the present routine is terminated.

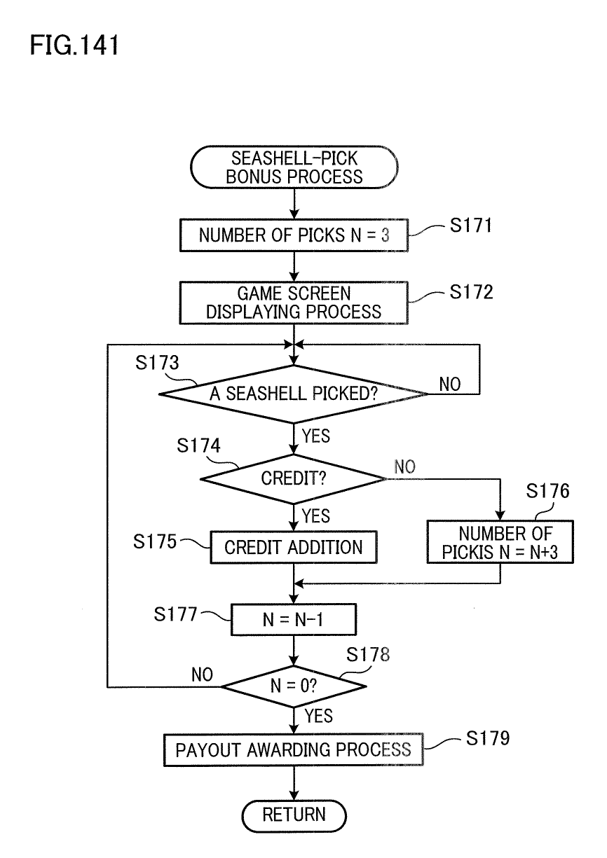

When it is determined in S45 that the pop-the-bubble bonus is not selected (S45: NO), whether or not the seashell-pick bonus is selected as the bonus is determined (S48). When it is determined that the seashell-pick bonus is selected (S48: YES), the main CPU 71 executes the wheel rotation stop process (S49). In the process, the rotating wheel 131 is stopped so that the pointer 174 points an area on the surface of the wheel 131, which corresponds to the seashell-pick bonus. The main CPU 71 then executes a seashell-pick bonus execution process which is described later with reference to FIG. 141 (S50). Then, the present routine is terminated.

When it is determined in S48 that the seashell-pick bonus is not selected (S48: NO), whether or not the fixed payout bonus is selected as the bonus is determined. The fixed payout awarded as the fixed payout bonus can be any of the following five types of payout: “100”, “150”, “200”, “300”, and “3000”. The main CPU 71 then determines which one of the five types is the fixed payout (S51). Then, the wheel rotation stop process is executed (S52). In the process, the rotating wheel 131 is stopped so that the pointer 174 points an area on the surface of the wheel 131, which corresponds to the fixed payout. The main CPU 71 then awards the amount of fixed payout selected (S53). Then, the present routine is terminated.

(Mermaid Dream Bonus Execution Process) Next, the following describes the mermaid dream bonus execution process, with reference to FIG. 136.

When the mermaid dream bonus execution process is executed, the main CPU 71 first starts the free game (S61), as shown in FIG. 88. The free game involves the symbol table shown in FIG. 8.

The main CPU 71 executes a free game symbol determination process (S62). In the free game symbol determination process, code numbers when the symbols are stopped are determined. More specifically, a random number is sampled, and the code number when each symbol array of the display block 28 stops is determined based on the sampled random number and a free game symbol table shown in FIG. 8.

Next, the main CPU 71 executes the scroll display control process (S63). In this process, the display control is conducted so that, after the start of the scroll of the symbols, the symbols are rearranged in accordance with S62.

Based on the symbols rearranged, the main CPU 71 determines the prize established as the payout (S64). It should be noted that, in the free game, there will be no cases of having no prize being established (so-called lose). Then, as shown in FIG. 89, the payout is displayed on the lower image display panel 141 (S65).

Next, the main CPU 71 sets the number of picks (n) to 1 (S66). Then, as shown in FIG. 92, two treasure boxes are displayed in the screen of the lower image display panel 141 (S67). Then, the main CPU 71 determines whether or not one of the two treasure boxes is picked (selected) (S68). When it is determined that neither of the two treasure boxes is picked (S68: NO), the process returns to S68.

When it is determined that one of the two treasure boxes is picked (S68: YES), the main CPU 71 determines whether the selected treasure box corresponds to success or fail (S69). When the treasure box corresponds to success (S69: YES), the payout indicated in the screen is doubled and indicated as shown in FIG. 93 (S70). Then, the number of picks (n) is incremented by 1 (S71). The main CPU 71 then determines whether or not the number of picks (n) is 6 (S72). When it is determined that the number of picks is not 6 (S72: NO), the process returns to S67. That is, selection of one of another two treasure boxes is enabled.

When it is determined in S69 that the selected treasure box does not correspond to success (S69: NO), or when it is determined in S72 that the number of picks (n) is 6 (S72: YES), the current payout is awarded as shown in FIG. 95 (S73). Then the present routine is terminated.

(Mystery Mermaid Free Game Running Process)

Next, the mystery mermaid free game running process is described with reference to FIG. 137.

When the mystery mermaid free game running process is executed, the main CPU 71 first sets the game count (T) to 7 (S81). It should be noted that the free game run here involves the symbol tables shown in FIG. 9A and FIG. 9B.

Then the main CPU 71 determines whether the spin button 46 is pressed (S82). In this step, the main CPU 71 determines whether an input signal output from the start switch 46S when the spin button 46 is pressed is received. When it is determined that the spin button 46 is not pressed (S82: NO), the process goes back to S82.

In the meanwhile, if it is determined in S82 that the spin button 46 is pressed (S82: YES), the main CPU 71 executes a generated bonus selection process (S83). Specifically, the main CPU 71 first extracts a random number. Then, one generated bonus is randomly determined out of the seven types of generated bonuses, based on the extracted random number, with reference to generated bonus random determination table shown in FIG. 13.

The main CPU 71 executes a free game symbol determination process (S84). In the free game symbol determination process, code numbers when the symbols are stopped are determined. More specifically, a random number is extracted, and based on the random number obtained and the free game symbol table, the code number for each display block 28 at the time of stopping each symbol array is determined.

Next, the main CPU 71 executes a scroll process (S85). In this process, scroll of symbols is started.

Next, the main CPU 71 determines whether or not the generated bonus includes the wild reel (S86). That is, the main CPU 71 determines whether or not the generated bonus is any of the wild reel, the wild reel & payout rate, and the wild reel & scattering wild. When it is determined that the generated bonus includes the wild reel (S86: YES), the main CPU 71 executes the wild reel selection process (S87). Specifically, when the generated bonus is the wild reel or the wild reel & payout rate, the reel to be changed to the wild reel is determined by using the wild reel random determination table shown in FIG. 15. Further, when the generated bonus is the wild reel & scattering wild, the reel to be changed to the wild reel is determined by using the wild reel random determination table shown in FIG. 18. Then, as shown in FIG. 100, there is provided the effect that the wild reel is displayed by the action of the green mermaid (S88).

When it is determined in S86 that the generated bonus does not include the wild reel (S86: NO), or after S88, the main CPU 71 determines whether or not the generated bonus include the scattering wild (S89). That is, the main CPU 71 determines whether or not the generated bonus is any of the scattering wild, the scattering wild & payout rate, and the wild reel & scattering wild. When it is determined that the generated bonus includes the scattering wild (S89: YES), the main CPU 71 executes the scattering wild selection process (S90). Specifically, when the generated bonus is the scattering wild or the scattering wild & payout rate, the number of wild symbols to be scattered is determined by using the scattering wild random determination table shown in FIG. 16. Specifically, when the generated bonus is the scattering wild & wild reel, the number of wild symbols to be scattered is determined by using the scattering wild random determination table shown in FIG. 19. Then, as shown in FIG. 101, there is provided the effect of scattering the wild symbols by the action of the purple mermaid (S91).

When it is determined in S89 that the generated bonus does not include the scattering wild (S89: NO), or after S91, the main CPU 71 determines whether or not the generated bonus include the payout rate (S92). That is, the main CPU 71 determines whether or not the generated bonus is any of the payout rate, the scattering wild & payout rate, and the wild reel & payout rate. When it is determined that the generated bonus includes the payout rate (S92: YES), the main CPU 71 executes the multiplying factor selection process (S93). Specifically, the multiplying factor of the payout is determined by using the multiplying factor random determination table shown in FIG. 14. Then, as shown in FIG. 99, there is provided the effect that the multiplying factor is indicated by the action of the blue mermaid (S88).

When it is determined that the generated bonus does not include the payout rate (S92: NO), or after S94, the main CPU 71 executes the scroll stop process (S95). In this process, the symbols scrolling are stopped so that the symbols determined in S84 are rearranged.

Next, the main CPU 71 determines whether or not the generated bonus includes the additional game count (S96). When it is determined that the generated bonus includes the additional game count (S96: YES), the main CPU 71 executes the additional game count selection process (S97). Specifically, the additional game count is determined by using the additional game count random determination table shown in FIG. 17. Then, as shown in FIG. 102, there is provided the effect that the game count is updated by the action of the red mermaid (S98).

When it is determined that the generated bonus does not include the additional game count (S96: NO), or after S98, the main CPU 71 determines whether or not a prize is established (S99). The main CPU 71 executes this step for each types of symbols rearranged, for all the symbols rearranged in S96.

When it is determined in S99 that a prize is established (S99: YES), the main CPU 71 executes a credit awarding process (S100).

When it is determined in S99 that a prize is not established (S99: NO), the game count (T) is reduced by 1 after S100 (S101). Then, whether or not the game count (T) is 0 is determined (S102). When it is determined that the game count is not 0 (S102: NO), the process returns to S82. When it is determined that the game count is 0 (S102: YES), the present routine is terminated.

(Big Bubble Bonus Execution Process)

Next, the following describes the big bubble bonus execution process, with reference to FIG. 138.

When the big bubble bonus execution process is executed, the main CPU 71 first executes a payout amount selection process (S111). Specifically, the payout amount is determined by using the big bubble bonus payout amount random determination table shown in FIG. 20. Then, as shown in FIG. 105, a bubble is displayed on the lower image display panel 141 (S112). After that, the main CPU 71 executes the repeated stroke count selection process (S113). Specifically, the repeated stroke count is determined by using the repeated stroke count random determination table shown in FIG. 21A.

Next, the main CPU 71 determines whether or not the spin button 46 is pressed (S114). In this step, the main CPU 71 determines whether an input signal output from the start switch 46S when the spin button 46 is pressed is received. When it is determined that the spin button 46 is not pressed, the process goes back to S114.

On the other hand, when it is determined in S114 that the spin button 46 is pressed (S114: YES), the main CPU 71 determines whether or not the spin button 46 is repeatedly stroked by the repeated stroke count randomly determined (S115). When it is determined that the button is not repeatedly stroked by the repeated stroke count randomly determined (S115: NO), the process goes back to S114. When it is determined that the button is repeatedly stroked by the repeated stroke count randomly determined (S115: YES), the credit indicated in the bubble is incremented based on the sorting pattern shown in FIG. 23 (S116).

Then, the main CPU 71 determines whether or not credit has reached a predetermined amount (S117). When it is determined that the credit has reached the predetermined amount (S117: YES), the size of the bubble displayed is changed (S118). That is, if the size of the bubble is a small size, it is changed to a medium size, and if the size of the bubble is a medium size, it is changed to a big size.

When it is determined in S117 that the credit has not yet reached the predetermined amount (S117: NO), or after S118, the main CPU 71 determines whether or not the credit has reached the payout amount determined in S111 (S119). When it is determined that the credit has not yet reached the payout amount determined in S111 (S119: NO), the process goes back to S114.

On the other hand, when it is determined that the credit has reached the payout amount determined in S111 (S119: YES), the main CPU 71 executes the repeated stroke count selection process (S120). Specifically, the repeated stroke count is determined by using the repeated stroke count random determination table shown in FIG. 21B. Then the main CPU 71 determines whether the spin button 46 is pressed (S121). When it is determined that the spin button 46 is not pressed (S121: NO), the process goes back to S121.

On the other hand, when it is determined in S121 that the spin button 46 is pressed (S121: YES), the main CPU 71 determines whether or not the spin button 46 is repeatedly stroked by the repeated stroke count randomly determined (S122). When it is determined that the button is not repeatedly stroked by the repeated stroke count randomly determined (S122: NO), the process goes back to S121. When it is determined that the button is repeatedly stroked by the repeated stroke count randomly determined (S122: YES), there is provided the effect that the bubble cracks as shown in FIG. 106 (S123). Then, the payout awarding process is executed as shown in FIG. 107 (S124). Then, the present routine is terminated.

(Swimming Mermaid Bonus Execution Process)

Next, the following describes the swimming mermaid bonus execution process, with reference to FIG. 139.

When the swimming mermaid bonus execution process is executed, the main CPU 71 first executes a payout amount selection process (S131). Specifically, the payout amount is determined by using the swimming mermaid bonus payout amount random determination table shown in FIG. 22. Then, after displaying the movie shown in FIG. 109, the game screen is displayed on the lower image display panel 141 as shown in FIG. 111 (S132).

Next, the main CPU 71 determines whether or not the spin button 46 is pressed (S133). When it is determined that the spin button 46 is pressed (S133: YES), the mermaid is moved up (S134). When it is determined that the spin button 46 is not pressed (S133: NO), the mermaid is moved down (S135).

After S134 or S135, the main CPU 71 determines whether or not the mermaid touched a coin (S136). When it is determined that the mermaid touched a coin (S136: YES), the credit is incremented by using the sorting pattern shown in FIG. 23 (S137).

When it is determined that the mermaid did not touch any coin (S136: NO, or after S137, the main CPU 71 determines whether or not the mermaid touched an obstacle such as the ocean floor (S138). When it is determined that the mermaid has touched an obstacle (S138: YES), a rolling effect process shown in FIG. 113 is executed (S139). Specifically, a semitransparent mermaid being in pain is displayed. Then, the main CPU 71 determines whether or not 1.5 second has elapsed from the start of the rolling effect (S140). When it is determined that 1.5 second has not elapsed from the start of the rolling effect (S140: NO), the process goes back to S140.

When it is determined in S138 that the mermaid did not touch an obstacle (S138: NO), or when it is determined that 1.5 second elapsed from the start of the rolling effect (S140: YES), the main CPU 71 determines whether or not the mermaid has reached the treasure box (S141). When it is determined that the mermaid has not yet reached the treasure box (S141: NO), the process goes back to S133.

When it is determined that the mermaid reached the treasure box (S141: YES), the main CPU 71 executes an effect display such that the mermaid opens the treasure box as shown in FIG. 115 (S142). Then, the payout awarding process is executed as shown in FIG. 116 (S143). This payout awarding process awards, to the player, an amount of the determined payout which was not obtained by collecting coins. Then the present routine is terminated.

(Pop-the-Bubble Bonus Execution Process)

Next, the following describes the pop-the-bubble bonus execution process, with reference to FIG. 140.

When the pop-the-bubble bonus execution process is executed, the main CPU 71 first executes a payout amount selection process (S151). Specifically, the payout amount is determined by using the pop-the-bubble bonus payout amount random determination table shown in FIG. 24. Then, as shown in FIG. 118, the game is started, and timing of a game period is started (S152). The period in which countless bubbles can be picked is 15 seconds. The main CPU 71 displays the game screen as shown in FIG. 119 (S153). Namely, countless bubbles moving up from the bottom are displayed.

Next, the main CPU 71 determines whether or not a bubble is picked by operating the touch panel (S154). When it is determined that a bubble is picked (S154: YES), the credit is incremented by using the sorting pattern shown in FIG. 23 (S155).

When it is determined that no bubble is picked (S154: NO), or after S155, the main CPU 71 determines whether or not 15 seconds have elapsed from the start of the game (S156). When it is determined that 15 seconds have not elapsed from the start of the game (S156: NO), the process goes back to S154.

When it is determined that 15 seconds have elapsed from the start of the game (S156: YES), displaying of the countless bubbles is stopped as shown in FIG. 122. Then, as shown in FIG. 123, three bubbles are displayed on the lower image display panel 141 (S157). Next, the main CPU 71 determines whether or not one of the three bubbles is picked by operating the touch panel (S158). When it is determined that none of the three bubbles is picked (S158: NO), the process returns to S158.

When it is determined that any of the three bubbles is picked (S158: YES), the payout awarding process as shown in FIG. 125 is executed (S159). This payout awarding process awards, to the player, a part of the payout amount not obtained by picking the countless bubbles plus the payout obtained by selecting one of the three bubbles. Then the present routine is terminated.

(Seashell-Pick Bonus Execution Process)

Next, the following describes the seashell-pick bonus execution process, with reference to FIG. 141.

When the seashell-pick bonus execution process is executed, the main CPU 71 first sets the number of picks (n) to 3 (S171). Then, as shown in FIG. 127, a game screen is displayed on the lower image display panel 141 (S172). 15 seashells are displayed. The contents of the 15 seashells are determined by using the seashell content table shown in FIG. 26.

Next, the main CPU 71 determines whether or not a seashell is picked by operating the touch panel (S173). When it is determined that no seashell is picked (S173: NO), the process returns to S173. When it is determined that a seashell is picked (S173: YES), the main CPU 71 determines whether the content of the picked seashell is credit (S174). When it is determined that the content of the seashell is credit (S174: YES), the credit is incremented as shown in FIG. 128 (S175). On the other hand, when it is determined that the content of the seashell is not credit (S174: NO), the content of the seashell is “additional 3 picks” and therefore the number of picks (n) is increased by 3 (S176).

After S175 or S176, the main CPU 71 reduces the number of picks by 1 (S177). The main CPU 71 then determines whether or not the number of picks (n) is 0 (S178). When it is determined that the number of picks is not 0 (S178: NO), the process returns to S173. On the other hand, when it is determined that the number of picks (n) is 0 (S178: YES), the payout awarding process as shown in FIG. 130 is executed (S179). Then the present routine is terminated.

(Mystery Feature Execution Process)

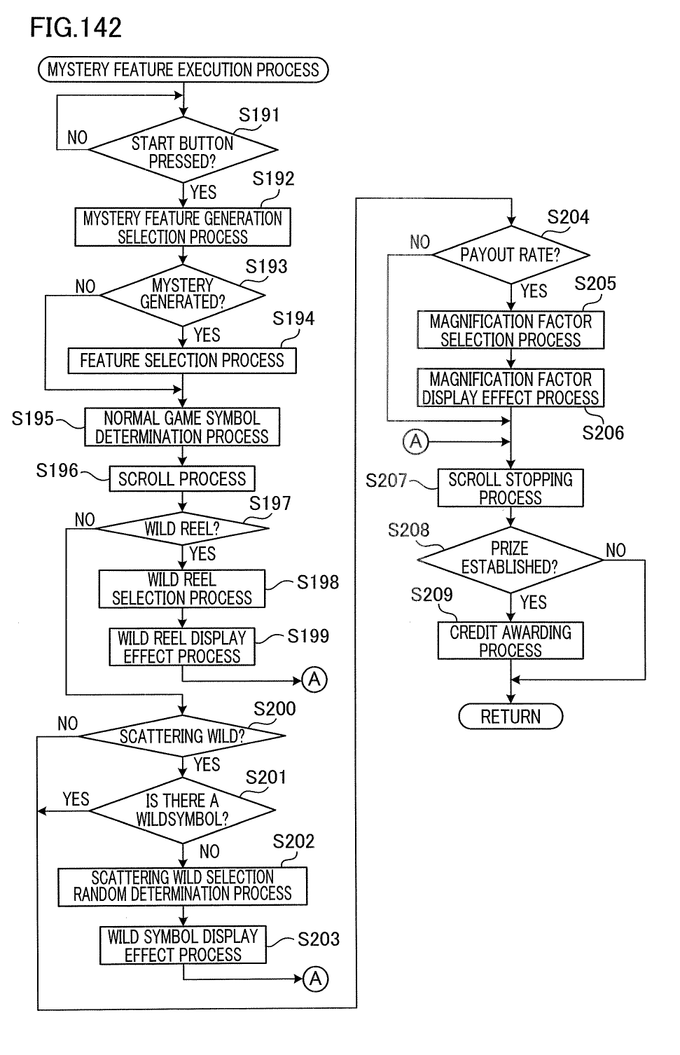

Next, the mystery feature execution process is described with reference to FIG. 142.

When the mystery feature execution process is executed, the main CPU 71 first determines whether or not the spin button 46 is pressed (S191). In this step, the main CPU 71 determines whether an input signal output from the start switch 46S when the spin button 46 is pressed is received. When it is determined that the spin button 46 is not pressed (S191), the process goes back to S191.

On the other hand, when it is determined in S191 that the spin button 46 is pressed (S191: YES), the main CPU 71 executes a mystery feature generation selection process (S192). In the mystery feature generation selection process, the main CPU 71 first extracts a random number. Then, one of “ON” and “OFF” is randomly determined according to the extracted random number, referring to the mystery feature generation random determination table of FIG. 27. The mystery feature is generated in cases of “ON”, and is not generated in cases of “OFF”.

Next, the main CPU 71 determines whether or not the mystery feature is to be generated (S193). When it is determined that the mystery feature is to be generated (S193: YES), a feature selection process is executed (S194). Specifically, the feature is determined by using the feature random determination table shown in FIG. 28.

On the other hand, when it is determined in S193 that the mystery feature is not generated (S193: NO), or after S194, the main CPU 71 executes the normal game symbol determination process (S195). In the normal game symbol determination process, code numbers when the symbols are stopped are determined. More specifically, a random number is sampled, and the code number when each symbol array of the display block 28 stops is determined based on the sampled random number and a normal game symbol table shown in FIG. 7A and FIG. 7B.

Next, the main CPU 71 executes a scroll process (S196). In this process, scroll of symbols is started.

Next, the main CPU 71 determines whether or not the mystery feature is the wild reel (S197). When it is determined that the feature is the wild reel (S197: YES), the main CPU 71 executes the wild reel selection process (S198). Specifically, the reel to be changed to the wild reel is determined by using the wild reel random determination table shown in FIG. 15. Then, as shown in FIG. 100, there is provided the effect that the wild reel is displayed by the action of the green mermaid (S199).

On the other hand, when it is determined that the feature is not wild reel (S197: NO), the main CPU 71 determines whether or not the feature is the scattering wild (S200). When it is determined that the feature is the scattering wild (S200: YES), the main CPU 71 determines whether or not the symbols rearranged in the display blocks 28 include a wild symbol (S201). When it is determined that the symbols rearranged in the display blocks 28 do not include wild symbol (S201: NO), the main CPU 71 executes the scattering wild selection process (S202). Specifically, the number of wild symbols is determined by using the wild random determination table shown in FIG. 16. Then, as shown in FIG. 101, there is provided the effect of scattering the wild symbols by the action of the purple mermaid (S203).

When it is determined that the feature is not the scattering wild (S200: NO), or when the symbols rearranged in the display blocks 28 include a wild symbol (S201: YES), the main CPU 71 determines whether or not the feature is the payout rate (S204). When it is determined that the feature is the payout rate (S204: YES), the main CPU 71 executes the multiplying factor selection process (S205). The multiplying factor of the payout is determined by using the multiplying factor random determination table shown in FIG. 14. Then, as shown in FIG. 99, there is provided the effect that the multiplying factor is indicated by the action of the blue mermaid (S206).

When it is determined that the feature is not the payout rate (S204: NO), or after S199 or S203, the main CPU 71 executes the scroll stop process (S207). In this process, the symbols scrolling are stopped so that the symbols determined in S195 are rearranged.

Thereafter, the main CPU 71 determines whether a prize is established (S208). The main CPU 71 executes this step of S208 for each types of symbols rearranged, for all the symbols rearranged in S207.

When it is determined in S208 that a prize is established (S208: YES), the main CPU 71 executes a credit awarding process (S209).

When a prize is not established in S208 (S208: NO), or after S209, the present routine is terminated.

(Operations of Slot Machine 1: Gamble Game)

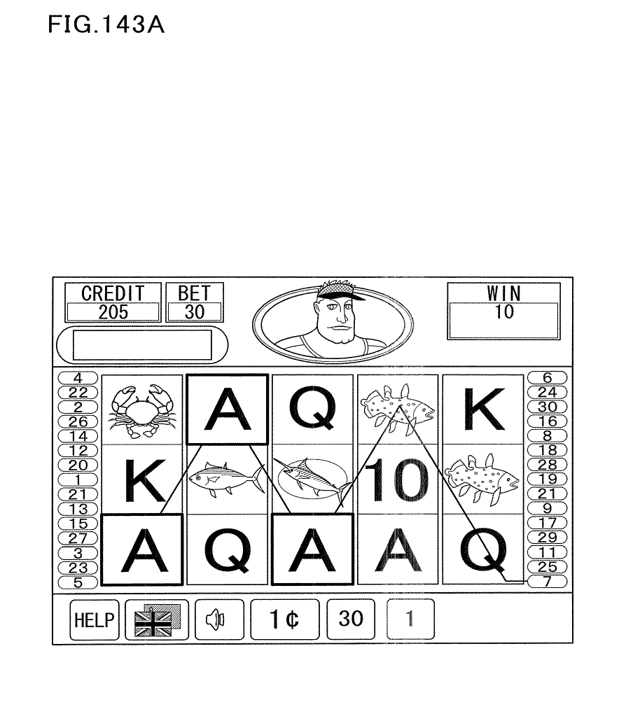

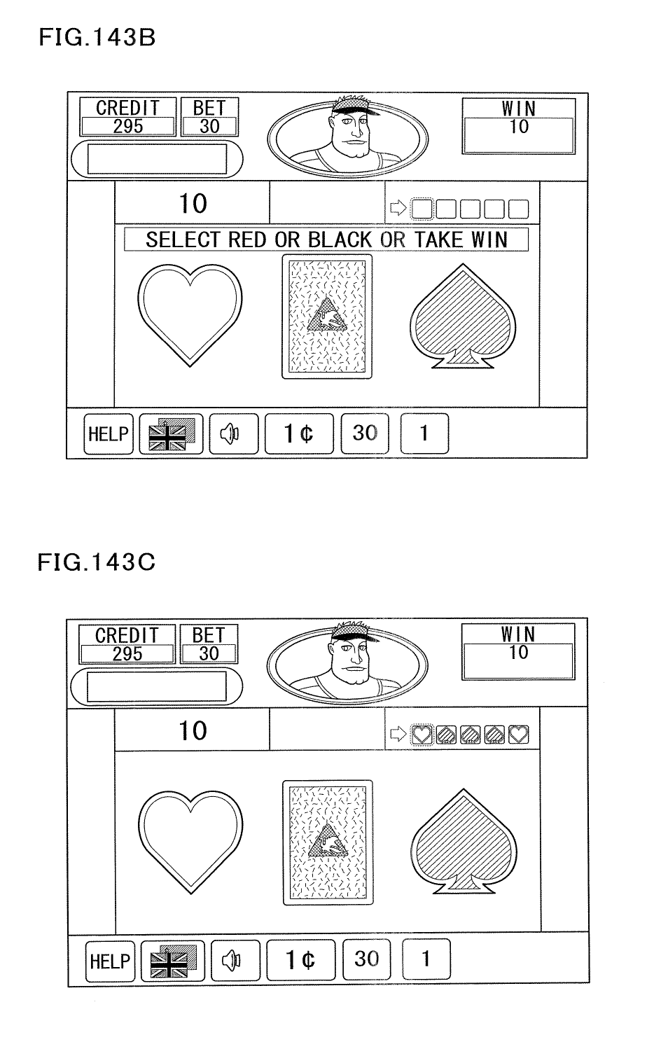

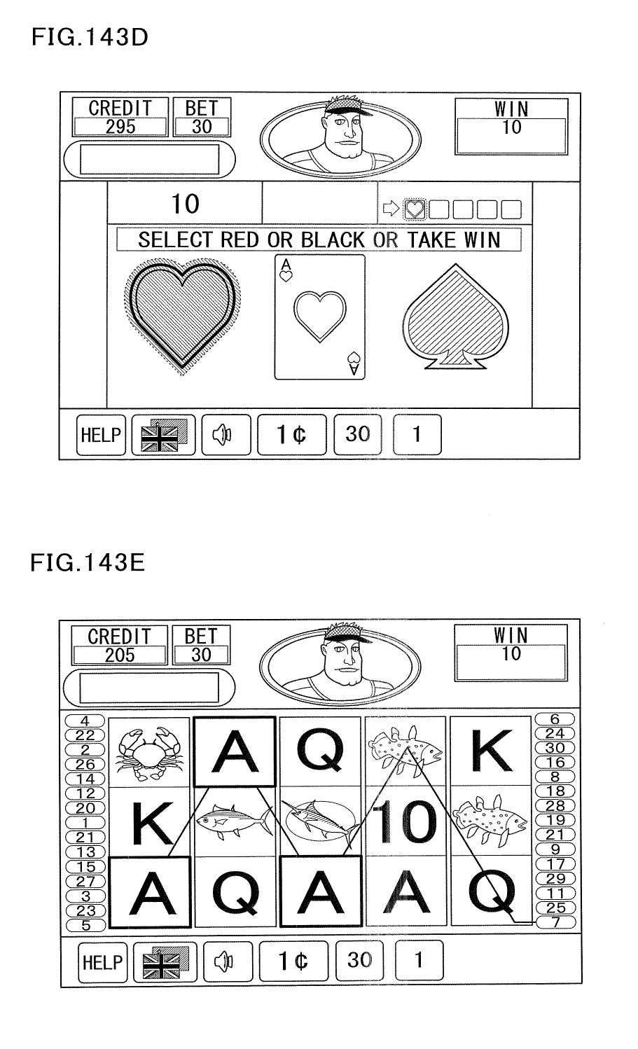

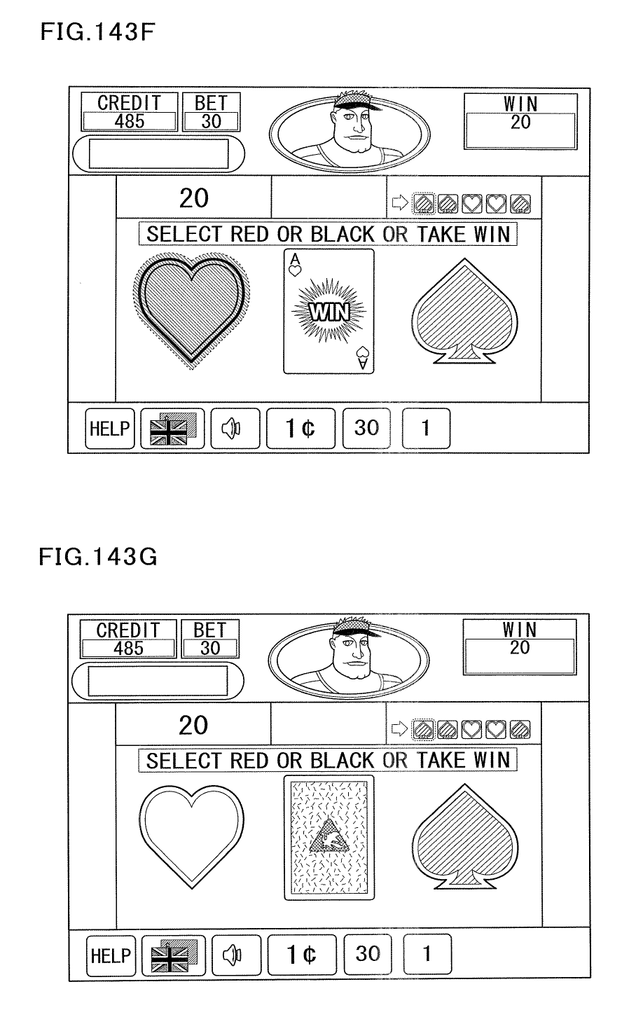

FIG. 143A to FIG. 143G show the operations of the gamble screen. The limit of the value winnable in Gamble is set in the AUDIT. The maximum number of times of Gamble is also set in the AUDIT. For example, the maximum number of times is set at five and the number of times of Gamble is set so as to be five or lower. Whether the touch panel can be used is switchable in some countries.

More specifically, WIN occurs as shown in FIG. 143A. As shown in FIG. 143B, when the shifting to the gamble screen occurs, the message “PLAY ON, GAMBLE or TAKE WIN” disappears. Immediately after the clearance of the RAM, the card history is empty until the gamble game is played. At this stage, the red button is turned on, the black button is turned on, and TAKE WIN button is turned on. The other buttons are turned off except the change button.

As shown in FIG. 143C, the amount bet on “GAMBLE AMOUNT” is displayed. For the selection of “Red” or “Black”, the operation proceeds to the process shown in FIG. 143D in case of failure, or proceeds to the process shown in FIG. 143F in case of success. When TAKE WIN is selected, the amount of WIN is added to the credit at once and the idle state returns. In this regard, when “Red” or “Black” is selected, the red button, the black button, and the TAKE WIN button are turned off. If TAKE WIN is selected, the button LED returns to the idle state.

In case of failure in Gamble, as shown in FIG. 143D, non-selected options are darkened. At the left edge of the gamble history field, the card history is displayed at once. The preceding card history moves right. The trace of the movement is not illustrated in animation, and hence the history is rewritten at once. The central card result is displayed at once. At this stage, there are no changes in the win meter and the gamble amount meter. Failure sound is reproduced and the shifting to the main game screen is performed after 1.2 second elapses. At the same time, the red button, the black button, and the TAKE WIN button are turned off.

As shown in FIG. 143E, at the same time as the switching to the main game screen, the WIN meter becomes 0. The button LED returns to the idle state. In case of Success in Gamble, as shown in FIG. 143F, non-selected options are darkened. At the left edge of the gamble history field, the card history is displayed at once. The preceding card history moves right. The trace of the movement is not illustrated in animation, and hence the history is rewritten at once. Thereafter, the normal card and the card with the WIN text are alternated on the central card in each frame, and success sound is reproduced (for 1.2 second). Then the amount increased as a result of the Gamble is added to the WIN meter at once. The gamble amount is unchanged at this stage.

When Gamble is played until reaching the upper limit number of times, the amount of WIN is added to the credit at once and the idle state returns. When the number of times of playing of Gamble has not reached to the upper limit number of times, the operation shifts to the process shown in FIG. 143G. At the same time, the red button, the black button, and the TAKE WIN button are turned off.

As shown in FIG. 143G, the card is overturned. Then the operation goes back to the process shown in FIG. 143D. In this regard, when “Red” or “Black” is selected, the red button, the black button, and the TAKE WIN button are turned off. If TAKE WIN is selected, the button LED returns to the idle state.

(Operations of Slot Machine 1: Residual Gamble Game)

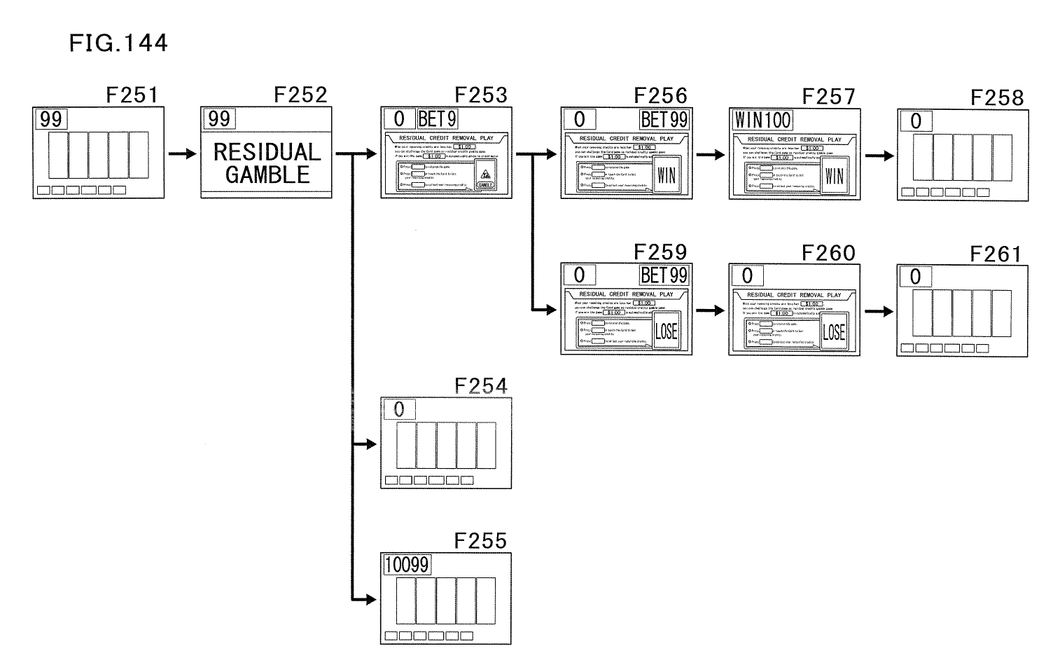

As shown in FIG. 144, when the money is lower than the processable value such as one dollar, a “RESIDUAL GAMBLE” screen is displayed if a gamble start condition such as the pressing of a collect button is satisfied (F253). When the gamble button is pressed, Gamble starts. On the other hand, when the collect button is pressed, Call Attendant is displayed (F254). When the spin button 46 is pressed, the screen of the normal game comes back (F255).

When “WIN” is achieved in Gamble (F256), a predetermined amount of money such as one cent is awarded and a token is paid out through the hopper. In addition to the above, the addition to the credit meter is executed (F257). Thereafter, after a predetermined time such as two seconds elapses, the screen of the normal game comes back (F258). On the other hand, when “LOSE” appears in Gamble (F259), a LOSE screen is displayed (F260). Thereafter, after a predetermined time such as two seconds elapses, the screen of the normal game comes back (F261).

The roles of the buttons in the progress of the gamble game will be described. In the cash-out button 32, GAMBLE ON corresponds to “TAKE WIN” and GAMBLE OFF corresponds to “TAKE WIN”. In the gamble button 44, GAMBLE ON corresponds to “Gamble Start” and GAMBLE OFF corresponds to “-”. In the maximum BET button 45, GAMBLE ON corresponds to “Inactive” and GAMBLE OFF corresponds to “Gamble Start”. In the spin button 46, GAMBLE ON corresponds to “To Normal Game” and GAMBLE OFF corresponds to “To Normal Game”.

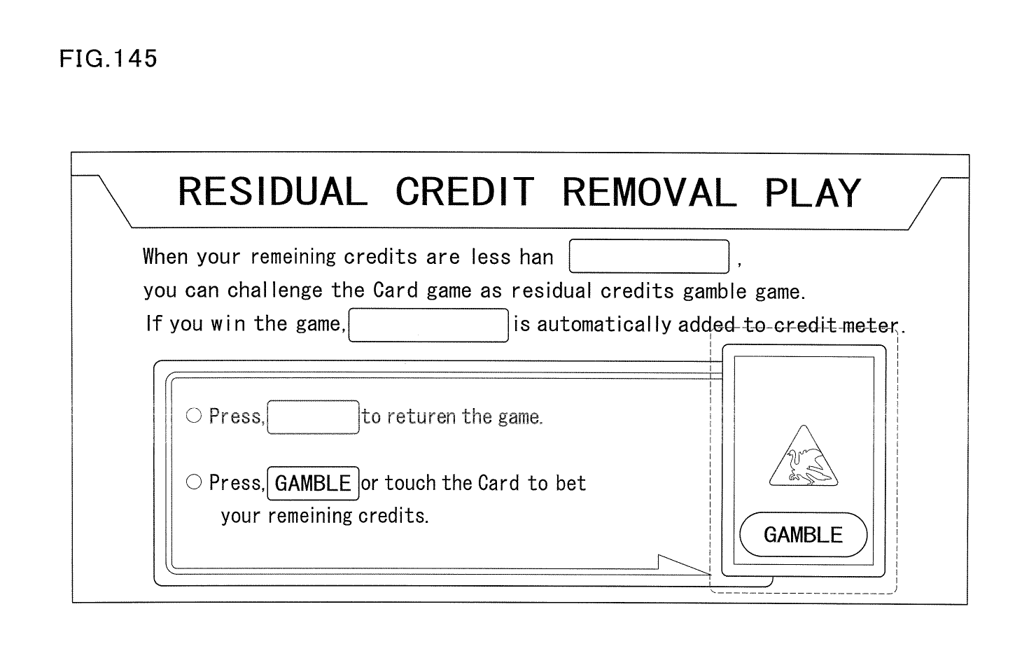

As shown in FIG. 145, the “RESIDUAL GAMBLE” screen has a card display area, a navigation area, and a meter area. In the card area is displayed a card image. The entirety of the card area has a touch sensor function. On the navigation area, various navigation texts are displayed. The card is a card image included in the common images. The system font is identical with the font used in the denomination. The blank is as long as seven characters. The numbers may include a dot.

The limit of the value winnable in Gamble is set in the AUDIT. The maximum number of times of Gamble is also set in the AUDIT. For example, the maximum number of times is set at five and the number of times of Gamble is set so as to be five or lower. Whether the touch panel can be used is switchable in some countries.

In regard to the game progress, the buttons function as follows: when Gamble is on, the cash-out button functions as “Take Win”, the gamble button functions as “GAMBLE Start”, the maximum BET button functions as “Inactive”, the spin button functions as “Shift to Normal Game”. The other buttons are not used.

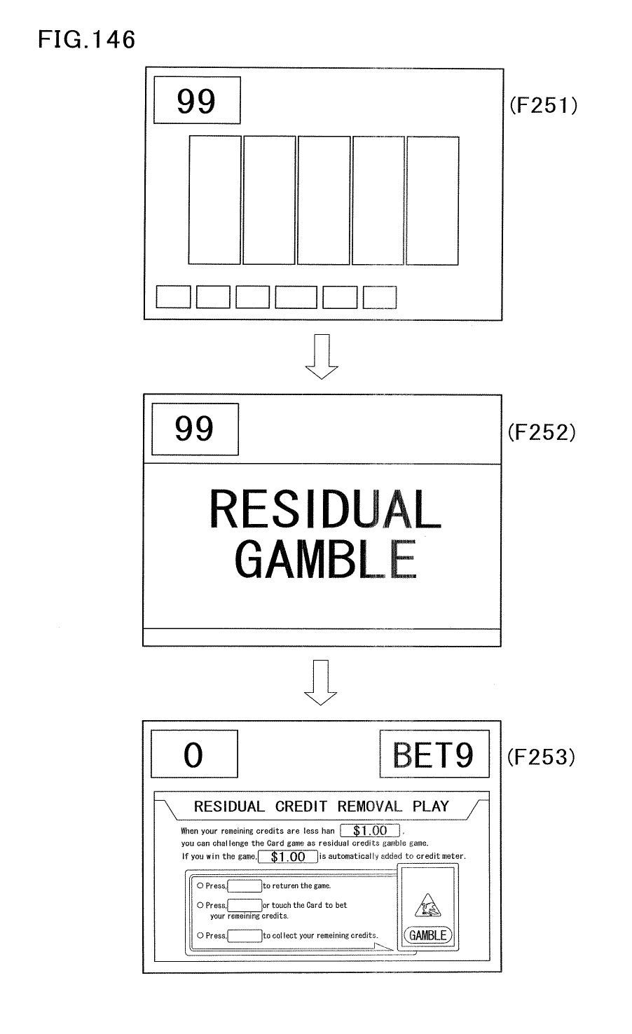

As shown in FIG. 146, when the shifting to the gamble game occurs, the message “PLAY ON, GAMBLE or TAKE WIN RED” disappears. Immediately after the clearance of the RAM, the card history is empty until the gamble game is played. A message “SELECT RED OR BLACK OR TAKE WIN” is displayed. In the gamble screen, a heart-shaped red button and a spade-shaped black button are turned on and a TAKE WIN button at the center is turned on. The other buttons are turned off.

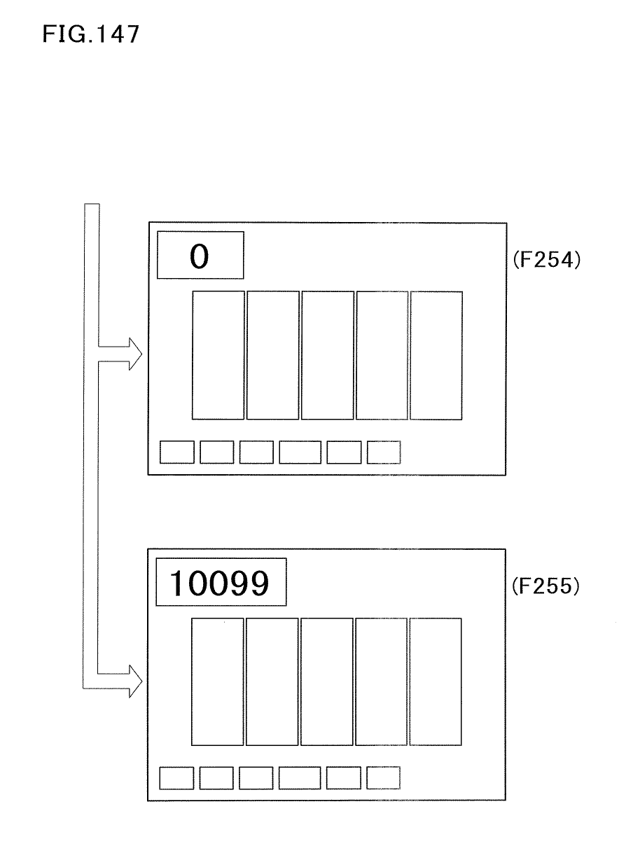

Subsequently, as shown in FIG. 147, the amount bet on “GAMBLE AMOUNT” is displayed. Then one of the heart-shaped red button, the spade-shaped black button, and the TAKE WIN button at the center on the gamble screen is selected. When the TAKE WIN button is selected, the amount of WIN is added to the credits at once and the idle state comes back.

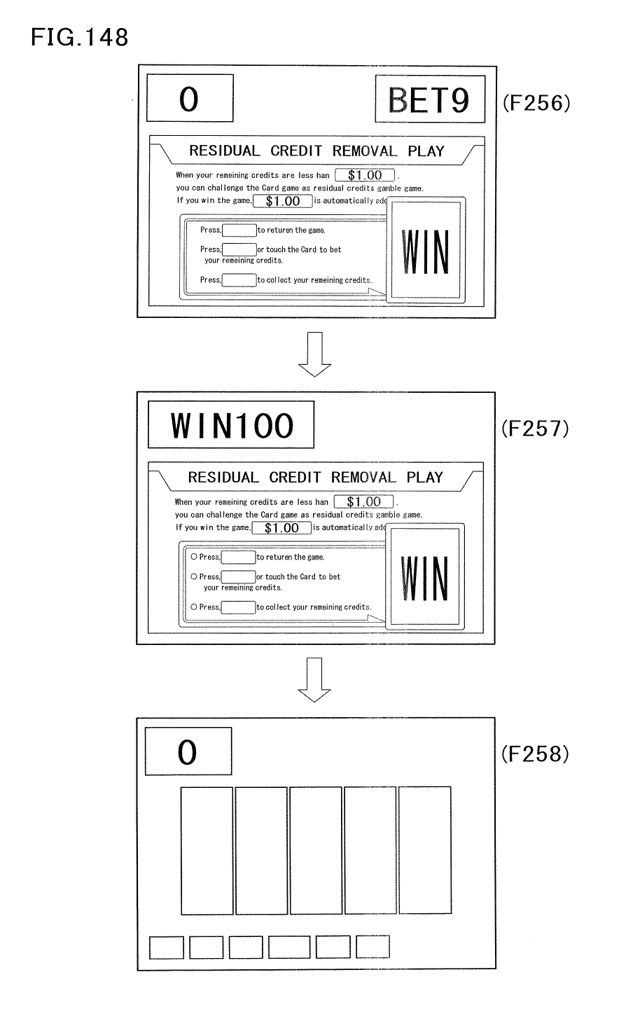

In case of failure in Gamble, as shown in FIG. 148, non-selected options are darkened. At the left end of the gamble history field, the card history is displayed at once. The preceding card history moves right. The trace of the movement is not illustrated in animation, and hence the history is rewritten at once. The central card result is displayed at once. At this stage, there are no changes in the win meter and the gamble meter. Sound indicating hard luck is output and the shifting to the normal game occurs after several seconds.

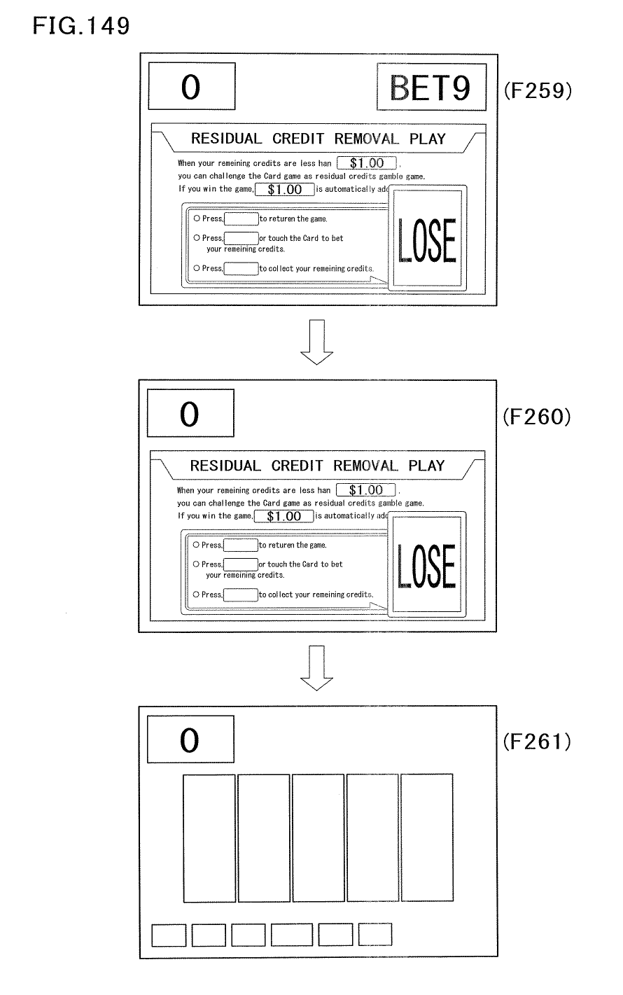

In case of Success in Gamble, as shown in FIG. 149, non-selected options are darkened. At the left end of the gamble history field, the card history is displayed at once. The preceding card history moves right. The trace of the movement is not illustrated in animation, and hence the history is rewritten at once. On the central card, a normal card and a card with a WIN text are alternately displayed at intervals of one frame, and success sound is output for a predetermined time. To the win meter, the value increased as a result of Gamble is added at once. When the player plays the gamble game until reaching the maximum number of times, the value won is added to the credits at once and the idle state comes back. When the player has not played the gamble game up to the maximum number of times, a card is turned inside out and the gamble game is continued.

The above embodiment thus described solely serves as a specific example of the present invention, and the present invention is not limited to such an example. Specific structures and various means may be suitably designed or modified. Further, the effects of the present invention described in the above embodiment are not more than examples of most preferable effects achievable by the present invention. The effects of the present invention are not limited to those described in the embodiments described above.

Further, the detailed description above is mainly focused on characteristics of the present invention to fore the sake of easier understanding. The present invention is not limited to the above embodiments, and is applicable to diversity of other embodiments. Further, the terms and phraseology used in the present specification are adopted solely to provide specific illustration of the present invention, and in no case should the scope of the present invention be limited by such terms and phraseology. Further, it will be obvious for those skilled in the art that the other structures, systems, methods or the like are possible, within the spirit of the present invention described in this specification. The description of claims therefore shall encompass structures equivalent to the present invention, unless otherwise such structures are regarded as to depart from the spirit and scope of the present invention. Further, the abstract is provided to allow, through a simple investigation, quick analysis of the technical features and essences of the present invention by an intellectual property office, a general public institution, or one skilled in the art who is not fully familiarized with patent and legal or professional terminology. It is therefore not an intention of the abstract to limit the scope of the present invention which shall be construed on the basis of the description of the claims. To fully understand the object and effects of the present invention, it is strongly encouraged to sufficiently refer to disclosures of documents already made available.

The detailed description of the present invention provided hereinabove includes a process executed on a computer. The above descriptions and expressions are provided to allow the one skilled in the art to most efficiently understand the present invention. A process performed in or by respective steps yielding one result or blocks with a predetermined processing function described in the present specification shall be understood as a process with no self-contradiction. Further, the electrical or magnetic signal is transmitted/received and written in the respective steps or blocks. It should be noted that such a signal is expressed in the form of bit, value, symbol, text, terms, number, or the like solely for the sake of convenience. Although the present specification occasionally personifies the processes carried out in the steps or blocks, these processes are essentially executed by various devices. Further, the other structures necessary for the steps or blocks are obvious from the above descriptions.

What is claimed is:

1. A gaming machine configured to use a group of reel strips with different symbol arrays, in a base game and a second game triggered by the base game, comprising:
a display device configured to display a plurality of types of symbols arranged on the reel strips;
a storage device configured to store payout data indicative of relation between symbols and payouts, which data is used for determining a payout, based on the symbols rearranged on the reel strips in the display device;
a controller configured to modify a setting of the group of reel strips, at a time of the second game so that the symbol arrays used in the second game leads to a higher expectation value for a payout determined based on a single set of the payout data, as compared with the symbol arrays used in the base game; and
an input device for entering a selection of selectable targets displayed on the display device, the selectable targets including a selectable target corresponding to success and a selectable target corresponding to fail,
wherein, when a payout is determined in the second game and the selectable target corresponding to success is selected through the input device, the controller executes a process of upgrading the payout through a predetermined calculation.

2. The gaming machine according to claim 1, wherein,
the second game may use a group of reel strips including a reel strip on which the same type of symbols are arranged.

3. The gaming machine according to claim 1, wherein,
selection of the selectable targets including the selectable target corresponding to success and the selectable target corresponding to fail is repeated a predetermined number of times, as long as the selectable target selected through the input device is the selectable target corresponding to success.
